(19) United States
(12) Patent Application Publication
(10) Pub. No.: US 2006/0182118 A1
(43) Pub. Date: Aug. 17, 2006

(54) System And Method For Efficient Traffic Processing

(75) Inventors: KENNETH LAM, KWUN TONG (HK); CHUN KIT HUNG, SAN PO KONG (HK); PRAMOD PANCHA, SOMERSET, NJ (US)

Correspondence Address: TROUTMAN SANDERS LLP, 600 PEACHTREE STREET , NE, ATLANTA, GA, 30308, US

(73) Assignee: Hong Kong Applied Science and Technology Research Institute Company Limited, Shatin (HK)

(21) Appl. No.: 11/275,864

(22) Filed: Feb. 1, 2006

Related U.S. Application Data
(60) Provisional application No. 60/649,042, filed on Feb. 1, 2005.

(51) Int. Cl. H04L 12/56; H04L 12/28

(52) U.S. Cl. 370/395.42

(57) ABSTRACT

Disclosed herein is a method for traffic processing to improve the overall performance of data traffic network. The method comprises receiving a traffic having data width narrower than or equal to a predetermined data width; reformatting the received traffic into bus traffic of said predetermined data width; recognizing a specific traffic within the bus traffic; processing the bus traffic; prioritizing the specific traffic, such as voice traffic, over other traffic in said bus traffic; and outputting the bus traffic according to the prioritizing result. Thus, the method secures network resources for voice traffic and avoids frame flooding which may otherwise cause system breakdown. Further disclosed herein is a system for traffic processing. The system comprises a circuit for receiving and reformatting a traffic having data width narrower than or equal to a predetermined data width into bus traffic of said predetermined data width; a circuit for distinguishing a specific traffic within said bus traffic; a processor for processing the reformatted bus traffic; and a circuit for prioritizing the specific traffic over other traffic in said bus traffic. This invention further provides a device for secure frame transfer. The device comprises a receiving circuit for receiving a frame, and an ingress processor for processing the frame to decide whether or not to further process the frame.

### FIELD OF THE INVENTION

The present invention relates to a system and method for efficient traffic processing, specifically to a switching system and a method for reformatting a traffic into a predetermined bus traffic width and prioritizing a selected traffic type.

### BACKGROUND

Voice over IP (VoIP) is well known in the art and has proven itself to be very useful and cost effective for communication. However, some users find that the quality of VoIP does not meet their expectations or requirements. In particular, latency and jittering remain the most prominent problems in VoIP. In addition, the security of VoIP is also a concern. Since there is no authentication for the VoIP users, conversations between the VoIP users can be easily captured and played back using a variety of well-known hacking mechanisms. Further, although some software is developed to reduce latency and jittering, voice quality cannot be guaranteed when the volume of VoIP traffic increases.

Current technology provides certain interfaces for exchanging data packets within a communication system. For example, U.S. Pat. No. 6,668,297 to Karr et al. discloses an interface for interconnecting Physical Layer (PHY) devices to Link Layer devices with a Packet over SONET (POS) implementation. However, such an interface design has a low throughput in a multi-channel system. In addition, such an interface design is typically designed for general data transfer and does not provide an efficient way for transferring voice traffic.

Thus, a need exists to provide a system and method for efficient and secure voice traffic processing and transfer.

### SUMMARY

Disclosed herein is a method for data processing. The method comprises the steps of: receiving traffic of an original data width narrower or equal to a predetermined data width; reformatting the received traffic into bus traffic of the predetermined data width; recognizing a specific traffic within the bus traffic; processing the bus traffic; prioritizing the specific traffic over other traffic in the bus traffic; and outputting the bus traffic according to the prioritizing result.

Also disclosed herein is a system for data processing. The system comprises: a circuit for receiving and reformatting a traffic having an original data width narrower than or equal to a predetermined data width into bus traffic of said predetermined data width; a circuit for distinguishing a specific traffic within the bus traffic; a processor for processing the reformatted bus traffic; and a circuit for prioritizing the specific traffic over other traffic in the bus traffic.

Further disclosed herein is a device for secure frame transfer. The device comprises: a receiving circuit for receiving a frame; and an ingress processor for processing the frame to decide whether or not to further process the frame.

An embodiment in accordance with the present disclosure reformats traffic into a predetermined bus traffic data width to ensure a high throughput in a multi-channel system. In addition, an embodiment in accordance with the present disclosure distinguishes a specific type of traffic (e.g., voice) from other general data traffic and further provides priority to transfer the specific traffic. Further, since the VoIP users are authenticated and authorized by the network, security of the VoIP conversations is guaranteed and conversations are not flooded or broadcast to any other users. Therefore, the present disclosure provides a system and method for efficient and secure voice traffic processing and transfer.

### BRIEF DESCRIPTION OF THE DRAWINGS

FIG. 1 is a schematic block diagram illustrating an overall configuration of one embodiment of the present invention.

FIG. 2 is a flow diagram illustrating the overall process of the same embodiment of the present invention as shown in FIG. 1.

FIG. 3 is a schematic block diagram of a general purpose computer upon which arrangements described can be practised.

FIG. 4 is a schematic block diagram illustrating the modules of the Forwarding chip as illustrated in FIG. 1.

FIG. 5 is a block diagram illustrating the modules of the Queuing chip as illustrated in FIG. 1.

FIG. 6 is a schematic block diagram representation of a Memory Controller.

FIG. 7 is a schematic block diagram of architecture of the MUX chip 140 of FIG. 1.

FIG. 8 is a schematic block diagram of architecture of the DEMUX chip 190 of FIG. 1.

FIG. 9 shows the format of Ethernet and IP frames processed by the Forwarding Chip 150 of FIG. 1.

FIG. 10 is a flow diagram of processing performed on each segment of an Ethernet frame on a specified port.

FIG. 11 is a flow diagram of the functionality of the ingress processing module 420 of FIG. 4.

FIG. 12 shows the organizational structure of a port table memory.

FIG. 13 shows the format of a VLAN attributes table.

FIG. 14 shows the format of a Spanning Tree table.

FIG. 15 is a flow diagram of a Layer-2 forwarding function.

FIG. 16 is a flow diagram for a learning process.

FIG. 17 is a flow diagram of an aging process.

FIG. 18 shows encoding of an aging table.

FIG. 19 shows the format of the Learn FIFO register.

FIG. 20 is a flow diagram of Layer-2 and Layer-3 forwarding techniques.

FIG. 21 is a flow diagram for unicast IP forwarding in hardware from RFC 1812.

FIG. 22 is a flow diagram of an IP header checking process.

FIG. 23 is a flow diagram of an IP header checksum process.

FIG. 24 is a flow diagram of an IP address lookup process.

FIG. 25 is a flow diagram of a Forwarding Updates process.

FIG. 26 is a flow diagram of a Forwarding Output process.

FIG. 27 shows the format of Classification Entry fields.

FIG. 28 is a flow diagram of a process performed by a CAM.

FIG. 29 is a flow diagram of Next Hop function.

FIG. 30 is a flow diagram for the process of the Next Hop module.

FIG. 31 shows the relationship between Layer-2, Layer-3, and Flow Classification entries in the SRAM and the corresponding entries in the Next Hop table in external SRAM.

FIG. 32 shows fields to be replaces in an Ethernet Frame Header.

FIG. 33 shows the format of entries in L2NHInfo and L3NHInfo tables.

FIG. 34 shows the format of entries in an FCNHInfo table.

FIG. 35 is a flow diagram of a multicast processing function.

FIG. 36 is a flow diagram of a multicast data queue processing function.

FIG. 37 shows the format of a control header.

FIG. 38 shows the format of entries in an MHdr FIFO.

FIG. 39 shows the format of entries in a multicast control RAM.

FIG. 40 is a schematic block diagram illustrating a buffering and queuing process.

FIG. 41 is a schematic block diagram representation of an outbound queuing process.

FIG. 42 is a schematic block diagram representation of a buffer ID free list.

FIG. 43 is a schematic block diagram representation of table formats for Input-Output Head and Input-Output Tail tables.

FIG. 44 is a schematic block diagram representation of a Free Head register and Free Tail register.

FIG. 45 is a schematic block diagram representation of a Head and Tail Buffer ID Table for Per-Flow queuing.

FIG. 46 is a schematic block diagram representation of head and tail flow queues using linked lists.

FIG. 47 is a schematic block diagram representation of head and tail flow queues using linked lists.

FIG. 48 is a schematic block diagram representation of the format of a Per-Port-Class-SubClass Queue-Length Count table.

FIG. 49 is a schematic block diagram representation of a data structure for a Backlogged Flow Linked List.

FIG. 50 is a schematic block diagram representation of a Head and Tail FlowID Table for Backlogged Flow Linked Lists.

FIG. 51 is a schematic block diagram representation of a data structure to form rings of backlogged FlowIDs.

FIG. 52 is a schematic block diagram representation of a Backlogged Port-Class Bitmap Table.

FIG. 53 is a schematic block diagram representation of a Backlogged Port-Class Subclass Bitmap Table.

FIG. 54 is a schematic block diagram representation of a Flow-Port-Class-Subclass Table.

FIG. 55 is a schematic block diagram representation of a Queue Length High Threshold Table.

FIG. 56 is a schematic block diagram representation of a Queue Length Low Threshold Table.

FIG. 57 is a schematic block diagram representation of a Queue Manager SRAM Memory Mapping Table.

FIG. 58 is a schematic representation of a hierarchical modified weighted round robin scheduling implementation.

FIG. 59 is a schematic block diagram representation of a Time Slot Configuration Table.

FIG. 60 is a schematic block diagram representation of a Class Weight Table.

FIG. 61 is a schematic block diagram representation of a Class WRR Count Table.

FIG. 62 is a schematic block diagram representation of a WRR Eligible Port Class-Bitmap Table.

FIG. 63 is a schematic block diagram representation of a Pervious Scheduled Class Table.

FIG. 64 is a schematic block diagram representation of a Subclass Weight Table.

FIG. 65 is a schematic block diagram representation of a Subclass WRR Count Table.

FIG. 66 is a schematic block diagram representation of a WRR Eligible Port-Class Subclass-BitMap Table.

FIG. 67 is a schematic block diagram representation of a Previous Scheduled Subclass Table.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

Disclosed herein is a switching system and a method for reformatting a traffic into a predetermined bus traffic width. In one embodiment described herein, the predetermined bus width is 64 bits wide. As described herein, data with width narrower than or equal to 64 bits is defined as any data width between 1 bit and 64 bits, including but not limited to 1, 2, 4, 8, 16, 32 and 64 bit data. However, it will be appreciated by a person skilled in the art that an embodiment of the invention may equally be practised with bus traffic widths of size other than 64 bits, including, but not limited to, 8, 16, 32, or 128 bits, without departing from the spirit and scope of the invention.

Overview

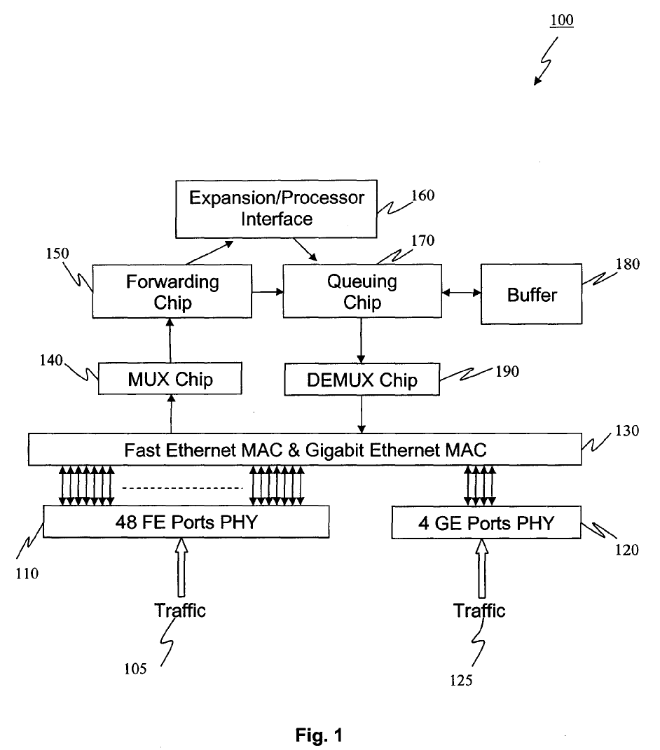

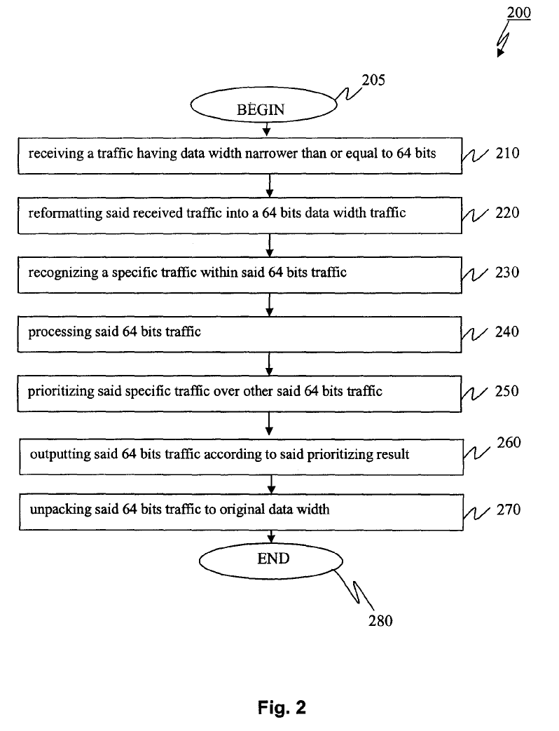

The following is a description of a specific implementation of the method and system according to the present invention. The system and method for traffic processing are respectively described with reference to FIGS. 1 and 2. FIG. 1 shows an overall system configuration 100 of an embodiment in accordance with the present disclosure. The system 100 receives traffic 105, 125. The traffic first passes through a physical layer (PHY) chip 110, 120 and then onwards to a media access control (MAC) chip 130. Typically, the traffic 105, 125 includes voice traffic and other general data traffic. In this particular embodiment, the traffic 105, 125 generally has a data width narrower than or equal to 64 bits. However, the actual bus width will vary depending on specific implementations and applications.

The system 100 shown has 48 fast Ethernet (FE) Ports 110 and 4 Gigabit Ethernet (GE) Ports 120, so that 52 ports in total are available to receive the traffic 105, 125. In the embodiment shown, the FE Ports 110 receive traffic 105 and the GE Ports 120 receive the traffic 125. The FE Ports 110 and GE Ports 120 are connected by duplex links to the MAC chip 130. The MAC 130 is preferably a fast Ethernet MAC and Gigabit Ethernet MAC, correspondingly.

A first circuit 140, typically a MUX chip 140 as shown in FIG. 1, is connected to the MAC chip 130. The MUX chip 140 sends control signals to the MAC chip 130 to control the traffic between the MUX chip 140 and the MAC chip 130. As previously stated, the traffic for this embodiment typically includes voice traffic and other general data traffic having data width narrower than or equal to 64 bits. When the MUX chip 140 receives traffic from the MAC chip 130, the MUX chip 140 reformats the traffic into bus traffic of a predetermined width, which in this example is 64 bits, and identifies a specific type of traffic, such as voice traffic, within said bus traffic. For example, in one embodiment the MUX chip 140 uses a voice device identifier in a virtual LAN (VLAN ID) to form a table inside a memory, so as to identify the source/port of the traffic and to prioritize the data accordingly. More details of how the MUX chip 140 reformats and distinguishes the voice traffic are described below.

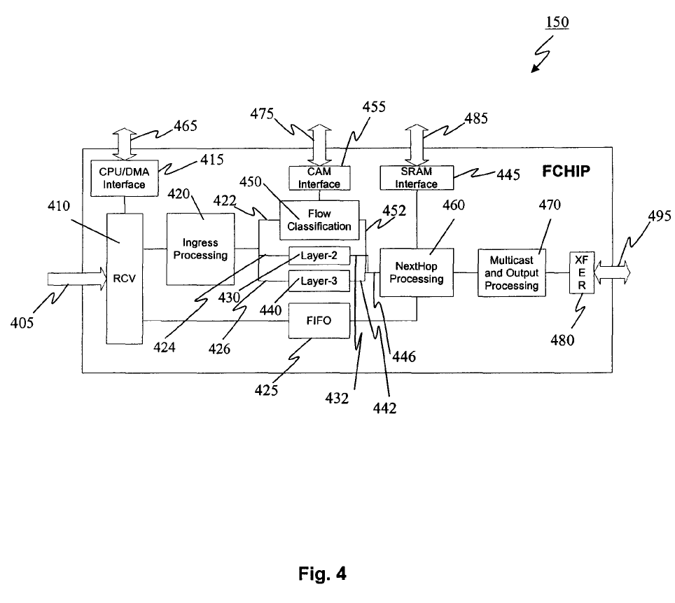

A second circuit 150, typically a Forwarding chip 150 as shown in FIG. 1, is connected to the MUX chip 140 to receive the reformatted bus traffic from the MUX chip 140. The Forwarding chip 150 performs second and third layer ingress processing, details of which are described below, particularly with reference to FIG. 4.

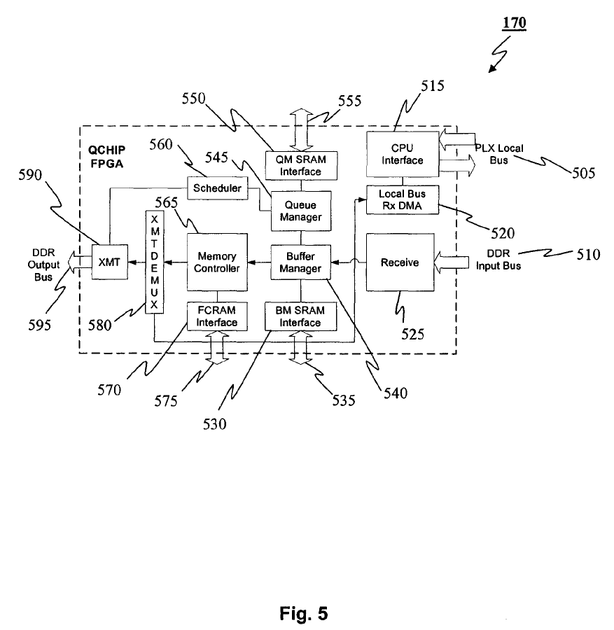

A third circuit 170, typically a Queuing chip 170 as shown in FIG. 1, is connected to the Forwarding chip 150 to receive the processed traffic from the Forwarding chip 150. The Queuing chip 170 identifies a selected traffic type, such as voice, from other general traffic and further prioritizes the selected traffic over other general traffic. In particular, the Queuing chip 170 rearranges the traffic and outputs the selected traffic first, while storing other general data traffic in a buffer 180 connected to the Queuing Chip 170. The details of how the Queuing chip 170 prioritizes the traffic are described below, particularly with reference to FIG. 5.

It is possible to add new features to the traffic, before the Forwarding chip 150 forwards the processed traffic to the Queuing chip 170. Accordingly, the system 100 includes an expansion/processor interface block 160. Selected traffic is presented by the Forwarding Chip 150 to the expansion/processor interface block 160. In one example, the expansion/processor interface block 160 utilises a software program to configure and change a data header of the traffic. In another example, users may find it convenient for a particular application to utilise the expansion/processor interface 160 to perform further processing on the traffic or perform validation checks of certain information of the traffic before the traffic is passed to the Queuing chip 170. The expansion/processor interface block 160 forwards the traffic, after performing any required processing, to the Queuing chip 170.

A fourth circuit 190, typically a DEMUX chip 190 as shown in FIG. 1, is connected to the Queuing chip 170. As previously described, the traffic from the Queuing chip 170 is now bus traffic of a predetermined width, as a result of processing by the MUX chip 140. In this example, the bus traffic is 64 bits and accordingly, the DEMUX chip 190 receives 64 bits traffic from the Queuing chip 170, and unpacks the 64 bits traffic to a data width corresponding to the original traffic 105, 125. The details of how the DEMUX chip 190 unpacks the 64 bits traffic to the original data width are described below. The DEMUX chip 190 passes the unpacked traffic to the MAC chip 130 for transmission to the FE Ports 110 and GE Ports 120.

FIG. 2 is a flow diagram 200 of method steps performed by the system 100 of FIG. 1. Each step 210 to 270 of FIG. 2 corresponds to functions of the circuits described above with reference to FIG. 1. The method starts at a BEGIN step 205 and passes to step 210, which corresponds to the MUX chip 140 receiving traffic having a data width narrower than or equal a predetermined bus traffic data width. As described above with respect to FIG. 1, the predetermined bus traffic data width for this particular example is 64 bits, but other data widths may equally be utilised. Control passes to step 220, in which the MUX chip 140 reformats the received traffic into a 64 bits data width traffic. Control passes to step 230, in which the MUX chip 140 identifies a specific type of traffic within the 64 bits traffic.

Control passes from step 230 to step 240, in which the Forwarding chip 150 processes the 64 bits traffic. In turn, control passes to step 250, in which the Queuing chip 170 and the buffer 180 prioritize the specific traffic over other 64 bits traffic and in step 260 the 64 bits traffic is output according to the prioritizing result. Control passes from step 260 to step 270, in which the DEMUX chip 190 unpacks the 64 bits traffic to an original data width and transfers the traffic back to the MAC chip 130 and then, in turn, to the PHY chips 110, 120. Control passes to an END step 280 and the method terminates.

The present invention has certain advantages. For example, all traffic is reformatted into bus traffic of a predetermined data width so that the traffic process rate is significantly increased to ensure a high throughput in a multi-channel system. In addition, the present invention distinguishes selected traffic from other general data traffic and further provides priority to transfer the selected traffic. In the example in which voice traffic is selected to receive priority, the latency of VoIP is significantly reduced and the quality of voice can be increased. In addition, since the VoIP users are authenticated and authorized by the network, the security of the VoIP conversation is guaranteed and conversations are not flooded or broadcast to any other users. Therefore, the present invention provides a system and method for efficient and secure voice traffic processing and transfer.

The following is an example of the processing performance improvement according to an embodiment of the present invention over the prior art method. The typical VoIP processing delay using software is approximately 200 μsec, and the throughput of VoIP processing using software is up to 500 Mbps. In contrast, the hardware assisted processing of VoIP traffic according to an embodiment of the present invention has processing delays of 1 μsec or even shorter. Specifically, assuming the clock rate is 80 MHz and approximately 10 pipelines are required to process a 64 byte frame, the processing delay in an 8 clock cycles pipeline is only 1 μsec. If the clock rate is 100 MHz, the processing delay is 800 nsec. Further, if the clock rate is 160 MHz, the processing delay is 500 nsec. Thus, the processing delay according to the present invention is much shorter than the prior art method. Further, the throughput of VoIP processing according to an embodiment of the present invention can be as high as 14 Gbps, which is 28 times higher than throughput obtainable from using software.

Additionally, further improvements are achievable due to the Queuing chip 170 and the buffer 180. For example, an embodiment of the present invention provides traffic isolation between sessions, bandwidth allocation for individual sessions, and a fixed low VoIP traffic delay, while the prior art software method cannot provide such performance.

Embodiments of the present invention can be applied in different interfaces for exchanging data packets within a communication system. For example, the interface for interconnecting Physical Layer (PHY) devices to Link Layer devices with a Packet over SONET (POS) implementation disclosed in the U.S. Pat. No. 6,668,297 to Karr et al. has been successfully implemented in the MUX chip 140 and the DEMUX chip 190 to enhance voice quality. After minor changes within the knowledge of one of ordinary skill in the art of the design of the MUX chip 140 and the DEMUX chip 190, the present invention is equally applicable to the PCI interface, PCMCIA interface, USB interface and CARDBUS interface, etc.

The present invention is described in detail herein in accordance with certain preferred embodiments thereof. To describe fully and clearly the details of the invention, certain descriptive names were given to the various components. It should be understood by those skilled in the art that these descriptive terms were given as a way of easily identifying the components in the description, and do not necessarily limit the invention to the particular description. For example, although the above disclosure specifically provides priority to voice traffic, the present invention can provide priority to other types of traffic, such as video traffic for enhancing the quality of video transfer. In addition, although the above disclosure specifically addresses VoIP, the chip and the method of reformatting the traffic into a predetermined bus traffic data width to increase the traffic process rate can be used in other communication systems including controlling and prioritizing data for household appliance. As another example, the 64 bit traffic forwarding and processing described in the above embodiment may be performed via a 64 bit bus or a 32 bit bus with double clock rate. Therefore, many such modifications are possible without departing from the spirit and scope of the present invention.

MUX Chip

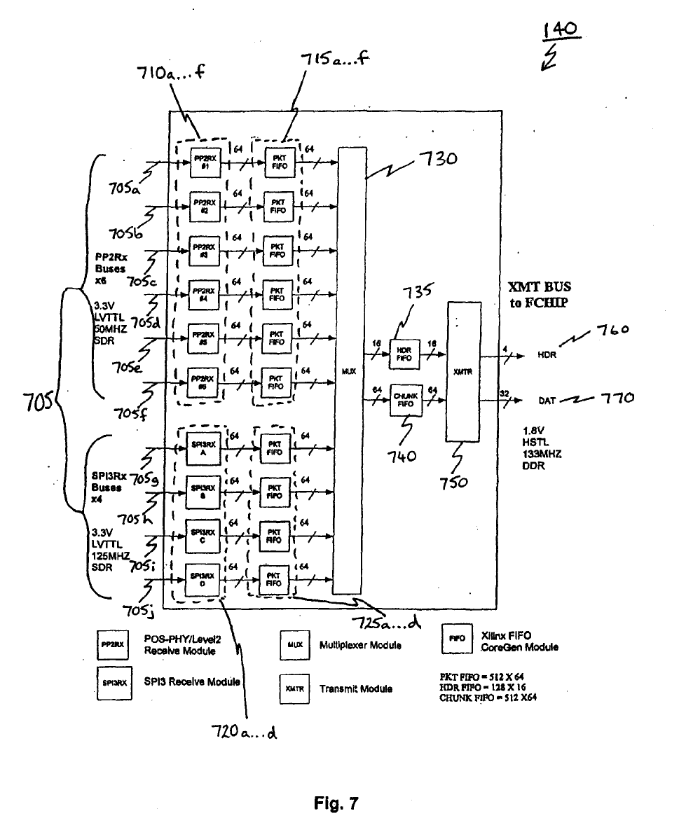

FIG. 7 is a schematic block diagram of architecture of the MUX chip 140 of FIG. 1. As discussed above with reference to FIG. 1, the MUX chip 140 receives traffic from the MAC chip 130, reformats the traffic into bus traffic of a predetermined data width, and identifies a specific type of traffic, such as voice traffic, within said bus traffic. FIG. 7 shows the MUX chip 140 receiving traffic 705 from the MAC chip 130. Traffic 705 is presented in the form of a POS-PHY Level 2 receive (PP2Rx) bus that is, in this example, 16 bits wide and a System Packet Interface Level 3 receive (SPI3Rx) bus that is, in this example, 32 bits wide. In the embodiment shown, the PP2Rx bus is 3.3V, LVTTL, 50 MHz, SDR and the SPI3Rx bus is 3.3V, LVTTL, 125 MHz, SDR. In particular, traffic bits 705a . . . 705f from the PP2Rx bus are presented to an array of corresponding PP2Rx receive modules 710 . . . 710f. Similarly, traffic bits 710a . . . 710d from the SPI3Rx bus are presented to an array of corresponding receive modules 720a . . . 720d. In the embodiment shown, the MUX chip 140 is compatible with both SPI3 and PP2 interface standards. However, it will be readily understood by a person skilled in the art that other communication standard interfaces could equally be used. Further, the embodiment shown in FIG. 7 has 10 bus channels 705a . . . 705f and 705g . . . 705j. Other embodiments may equally utilize more or fewer bus channels, without departing from the spirit and scope of the disclosed invention.

Each of the respective PP2Rx receive modules 710a . . . 710f functions as a bus controller to decode traffic from the external POS-PHY/Level2 (PP2Rx) bus into a data bus of a predetermined data width, which in this example is 64 bits, and presents a 64 bit output to a corresponding one of an array of PKT FIFO modules 715a . . . 715f. The six PP2Rx receive modules 710a . . . 710f each provide 8 channels, summing up to the 48 FE ports 110 of FIG. 1. Each of the PKT FIFO modules 715a . . . 715f functions as a buffer for data packets received from the PP2Rx receive modules 710a . . . 710f and presents a 64 bit output to a multiplexer 730.

Each of the respective SPI3Rx receive modules 720a . . . 720d functions as a bus controller to decode traffic from the external SPI3 (SPI3Rx) bus into bus traffic of a predetermined data width. In this example, the predetermined bus traffic is 64 bits wide, so each of the SPI3Rx receive modules 720a . . . 720d presents a 64 bit output to a corresponding one of an array of PKT FIFO modules 725a . . . 725d. The four SPI3RX receive modules 720a . . . 720d correspond to the 4 GE ports 120 of FIG. 1. Each of the PKT FIFO modules 725a . . . 725d functions as a buffer for data packets received from the SPI3Rx receive modules 720a . . . 720d and presents a 64 bit output to the multiplexer 730.

The multiplexer 730 receives the 64 bit inputs from each of the ten PKT FIFO modules 715a . . . 715f, 725a . . . 725d and multiplexes the 10 channels of data into the correct FIFO channels: HDR FIFO and CHUNK FIFO, to produce: (i) a 16 bit output to a HDR FIFO module 735, and (ii) a 64 bit output to a CHUNK FIFO module 740. The HDR FIFO module 735 buffers header information and presents a 16 bit output to a transmitter (XMTR) module 750. The CHUNK FIFO module 740 buffers data and presents a 64 bit output to the transmitter (XMTR) module 750. The transmitter module 750 produces a header 760 and data (DAT) 770 to be presented to the Forwarding Chip 150. As indicated above, different bus traffic widths may equally be practised without departing from the spirit and scope of the invention.

Thus, the MUX chip 140 utilises the PP2Rx receive modules 710a . . . 710f and SPI3Rx receive modules 720a . . . 720d to decode incoming Ethernet traffic into 64-bit data, which is stored in PKT FIFO modules 715a . . . 715f and 725 a . . . 725d. The MUX chip 140 multiplexes the data channels into a HDR FIFO 735 and Chunk FIFO 740. The transmit module 750 then formats the header and chunk into traffic 760, 770 of an XMT protocol. In the embodiment shown, the output is 1.8V, HSTL, 133 MHz, DDR. The size of PKT FIFO is 512 (addresses)×64 bits, the size of the HDR FIFO is 128 (addresses)×16 bits, and the size of the CHUNK FIFO is 512 (addresses)×64 bits. It will be appreciated by a person skilled in the art that other traffic widths, packet sizes and voltages can equally be used without departing from the spirit and scope of the invention.

Forwarding Chip

Forwarding Chip—Architecture

FIG. 4 is a schematic block diagram representation of the Forwarding chip (FCHIP) 150 of FIG. 1. The Forwarding chip 150 receives a frame 405 from bus traffic of a predetermined data width from the MUX chip 140 at a receive (RCV) module 410. Typically, the RCV module 410 preprocesses the frame to determine the validity of a frame header of the frame, by parsing the frame header. If the frame header fields are erroneous, the frame is dropped. Otherwise, the RCV module 410 passes the frame to an ingress processor 420 to determine whether or not to perform further processing on the frame. The RCV module is also connected to a CPU/DMA interface 415, which provides a duplex link 465 to a central processing unit (CPU) external to the Forwarding Chip 150. The CPU/DMA interface 415 provides a Direct Memory Access (DMA) communication channel between the expansion/processor interface block 160 and the Queuing Chip 170.

Typically, the ingress processor 420 assigns a VLAN ID for a particular frame. The VLAN ID is chosen from a header VLAN tag, the default port ID, or is categorized into a Voice VLAN by an associated source MAC address. More specifically, the ingress processor 420 sets the VLAN ID to be configured for VoiceVID and further sets X2 bit for the VoiceVID to avoid frame flooding. VoiceVID and X2 are described in greater detail later in the specification. Alternatively, the ingress processor 420 records the MAC address of the authorized user into a hardware register. The assigned VLAN ID is used in the whole process. Since the VLAN ID is unique for a particular frame, the ingress processor 420 can use the VLAN ID to identify whether the user is authorized and an unauthorized user within the LAN cannot access this particular VLAN ID. Therefore, only authorized users can access the network and other users cannot listen to a conversation between authorized users.

The ingress processor 420 can also determine whether to forward the frame as a Layer-2 or Layer-3 entity. If the frame is determined to be a Layer-2 entity, the ingress processor 420 outputs an ingress processed frame 424 to a Layer-2 processor 430 to direct the ingress processed frame to a correct port to avoid frame flooding. The Layer-2 processor 430 presents an ingress processed frame 432 to a next hop processor 460. Alternatively, if the frame is determined to be a Layer-3 entity, the ingress processor 420 outputs an ingress processed frame 426 to a Layer-3 processor 440 to direct the ingress processed frame to a correct port. The Layer-3 processor 440 presents an ingress processed frame 442 to the next hop processor 460. For other situations, such as when the header is determined to be Layer-4, Layer-5, Layer-7, etc., the ingress processor 420 outputs an ingress processed frame 422 to a flow classification circuit 450 to classify the frame into a flow by matching header fields of the frame. The flow classification circuit 450 presents an ingress processed frame 452 to a next hop processor 460. The flow classification unit 450 is also connected to a Content Addressable Memory (CAM) interface 455, which provides a duplex connection 475 from the FCHIP 150 to a CAM module, not shown.

The next hop processor 460 determines the frame output and control frame header modification of a received frame 452, 432, or 442. The next hop processor 460 forwards the frame to a multicast processor 470 to output the frame. The multicast processor 470 outputs the frame via a transfer (XFER) block 480. The output from the Forwarding chip 150 is a frame 495. The next hop processor 460 is also connected to a SRAM interface 445, which provides a duplex connection from the FCHIP 150 to a static random access memory (SRAM) module. Further, the RCV module 410 connects to a FFIFO module 425, which in turn connects to the next hop processor 460.

Forwarding Chip Overview

The Forwarding Chip 150 processing core performs Layer-2, Layer-3 and Layer-4 (flow) processing for each frame received from the MUX chip 140. In the implementation described, the frame is an Ethernet frame. The Forwarding Chip 150 performs forwarding functions by examining the frame header and then determining an output decision for the frame. Header fields of frames may also be modified for Layer-3 forwarding, including but not limited to, for example, Time-To-Live (TTL) decrementing, Differentiated Services Code Point (DSCP) marking, and Address and Port replacement for a Network Address Translation (NAT). Once the Forwarding Chip 150 makes an output decision, frames are forwarded to buffering, queuing and scheduling functions performed in the Queuing Chip (QCHIP) 170. The Queuing Chip 170 may be implemented as a field programmable gate array (FPGA).

Frames are transferred in 64 byte segments from the MAC module 130 to the header-processing module, corresponding to the ingress processing module 420 of FIG. 4. Header processing is triggered on the first segment of a frame from an input port, such as, for example, a start of an Ethernet frame. The result of header processing is an output decision consisting of a FlowID. This FlowID value is stored on a per-input-port basis to be added as a header to each 64-byte frame segment from the same input port. The Flow Classification module 450 utilises the FlowID value to map each packet to the correct output port (or ports) and priority. The FlowID value is also used to classify the frame to the correct traffic class and subclass for scheduling purposes. The FlowID value is stored in SRAM via the SRAM Interface 445, 485.

Once header processing is performed, the Multicast and Output Processing module 470 creates an output decision. The output decision is stored in an internal memory, not shown, and is used to tag the headers of all subsequent segments of the frame from the same port (until an end of frame indication). Hence all these segments are forwarded to the same output port.

Forwarding Chip—Processing Overview

The Forwarding Chip 150 performs Layer-2, Layer-3 and Layer-4 (flow) processing for each Ethernet frame. Processing consists of the forwarding functions that examine the frame header and arrive at an output decision for the frame, header modification functions that may change the Layer-2, Layer-3 and Layer-4 headers (for example, TTL decrementing, DSCP marking, Address and Port replacement for NAT) and flow processing functions (for example, policing, RTP monitoring, packet statistics). Once the output decision, header modifications and flow processing functions have been performed, frames are forwarded to the buffering, queuing and scheduling functions that are performed in the QCHIP chip 170.

The header initialisms that are used in the description of frame processing in the remainder of the document are shown in Table 1.

TABLE 1

| Header Field | Initialism | Header Field | Initialism |
|---|---|---|---|
| Destination MAC | DA | Destination IP Address | DIP |
| Address | | | |
| Source MAC Address | SA | Source IP Address | SIP |
| Ethernet Protocol Type | PT | IP Protocol | PROT |
| Ethernet 802.1Q VLAN | VID | Destination TCP/UDP | DPORT |
| ID | | Port | |
| Ethernet 802.1p Priority | PRI | Source TCP/UDP Port | SPORT |
| IP Version | VER | SYN Flag | SYN |
| IP Header Length | HL | ACK Flag | ACK |
| IP Fragmentation Flag | FRAG | IP Type of Service | TOS |

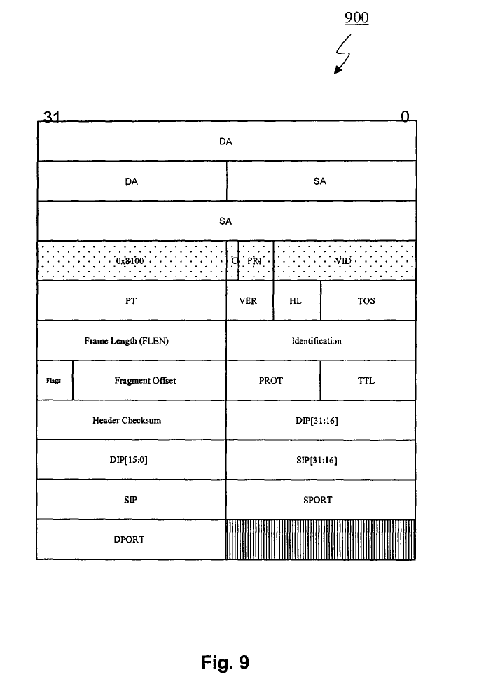

FIG. 9 shows the format 900 of Ethernet and IP frames processed by the Forwarding Chip 150. In one embodiment, the Forwarding Chip 150 is implemented using a field programmable gate array (FPGA).

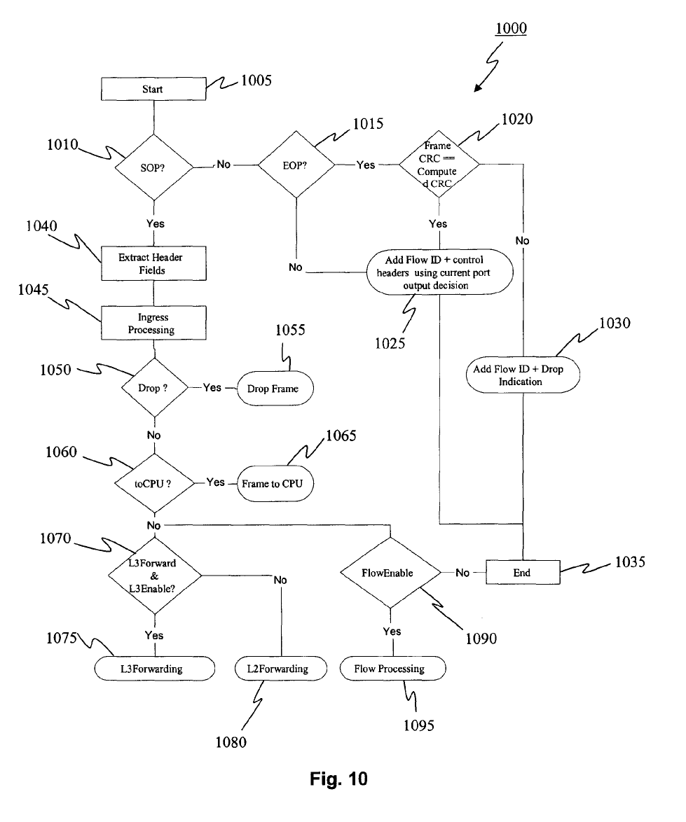

FIG. 10 is a flow diagram 1000 of processing performed for each segment of an Ethernet frame on a specified port. Processing starts at a Start step 1005 and proceeds to a decision step 1010 that determines whether a Start of Packet (SOP) is being processed. If an SOP is being processed, Yes, control flows to step 1040 to extract header fields. Control passes to step 1045 for ingress processing, and then to a decision step 1050 that determines whether to drop the frame being processed. If the frame is to be dropped, Yes, control passes to step 1055, which drops the frame and terminates the processing. However, if at step 1050 the frame is not to be dropped, No, control passes to a further decision step 1060.

The decision step 1060 determines whether the frame is to be sent to a central processing unit (CPU). If the frame is to be sent to the CPU, Yes, control passes to step 1065, which sends the frame to the CPU. If at step 1060 the frame is not to be sent to the CPU, No, control passes in a parallel manner to each of steps 1070 and 1090. Decision step 1070 determines whether Layer-3 Forwarding and Layer-3 Enabling is to be performed. If Layer-3 Forwarding and Layer-3 Enabling is to be performed, Yes, control passes to step 1075 to perform the Layer-3 forwarding and the process terminates. However, if at step 1070 Layer-3 Forwarding and Layer-3 Enabling is not to be performed, No, control passes to step 1080 to perform Layer-2 forwarding. In parallel with decision step 1070, decision step 1090 determines whether to enable flow processing. If flow processing is to be enabled, Yes, control passes to step 1095 to perform the flow processing and the process terminates. However, if at step 1090 flow processing is not to be enabled, control passes to an End step 1035 and the process terminates.

Returning to step 1010, if the Start of Packet (SOP) is not being processed, No, control passes to decision step 1015, which determines whether an End of Packet (EOP) is being processed. If an End of Packet is being processed, Yes, control passes to decision step 1020, which determines whether a frame cyclic redundancy check (CRC) is equal to a computed CRC. If Yes, control passes to step 1025. Returning to step 1015, if an EOP is not being processed, control passes directly to step 1025. Step 1025 adds FlowID and control headers using a current port output decision. Control passes from step 1025 to the End step 1035.

Returning to step 1020, if the frame CRC is not equal to the computed CRC, No, control passes from step 1020 to step 1030, which adds FlowID and a drop indication, before passing control to the End step 1035.

The forwarding process consists of the ingress processing functions, followed by Layer-2 or Layer-3 forwarding functions, and then the Flow Processing functions. Note that packets can be forwarded with either Layer-2 or Layer-3 processing, but not by both processes. However, the flow processing functions may be applied to all packets (Layer-2 and Layer-3 forwarded). The Flow Processing functions can modify the layer-2 and layer-3 forwarding decisions and can result in a packet being redirected to a different port, priority, and queue or for software processing of packets.

The output of the Layer-2 or Layer-3 forwarding decision consists of a FlowID, control information for processing frame headers, (such as replace Source IP address, Destination IP address etc.) and the information fields required to update them.

Forwarding Chip—Ingress Processing

The Ingress Processing module 420 performs a variety of preprocessing functions, including parsing of the frame header and checking headers to ensure that the packet headers are valid. The ingress processing module 420 interfaces to the RCV module 410 through a 64-bit data bus that transfers the frame segments and control signals, such as, for example, PORTID, SOP, EOP and ERR control signals. In this embodiment, all Ethernet frames are assumed to be in a VLAN-tagged format for the Ingress Processing functions.

On a SOP indication, layer-2 header fields (DA, SA, PT, VID, PRI) and layer-3 header fields (DIP, SIP, HL, FRAG, PROT) are extracted from the frame segment. The Header fields are then used to perform Layer-2 and Layer-3 Header checks to ensure integrity of the frame headers. If the header fields are known to be erroneous, the frame is dropped before header processing begins. If the frame contains Layer-2 or Layer-3 header fields that require forwarding to the processor for further processing, the toCPU field is set for the frame and normal Layer-2 or Layer-3 forwarding is disabled.

In addition to determining the special cases, the ingress processing module 420 assigns the VLAN ID for a particular frame. The VLAN ID is chosen either from a header VLAN tag, the default port ID, or it is categorized into a Voice VLAN by an associated Source MAC address. The assigned VLAN ID is used in the processing and lookups that are performed in the rest of the forwarding process.

The frame ingress processing also determines if the incoming frame is to be forwarded as a Layer-2 or a Layer-3 entity. This is done by first checking to make sure that the frame has an Ethernet protocol type (PT) of 0x800 and then comparing the frame's destination MAC address (DA) with the router MAC address (RMAC). If these MAC addresses (and VLAN ID) match, the frame is forwarded using the IP forwarding algorithm. If the MAC addresses do not match, Layer-2 (802.1D/Q) bridging-based forwarding is utilized for the frame.

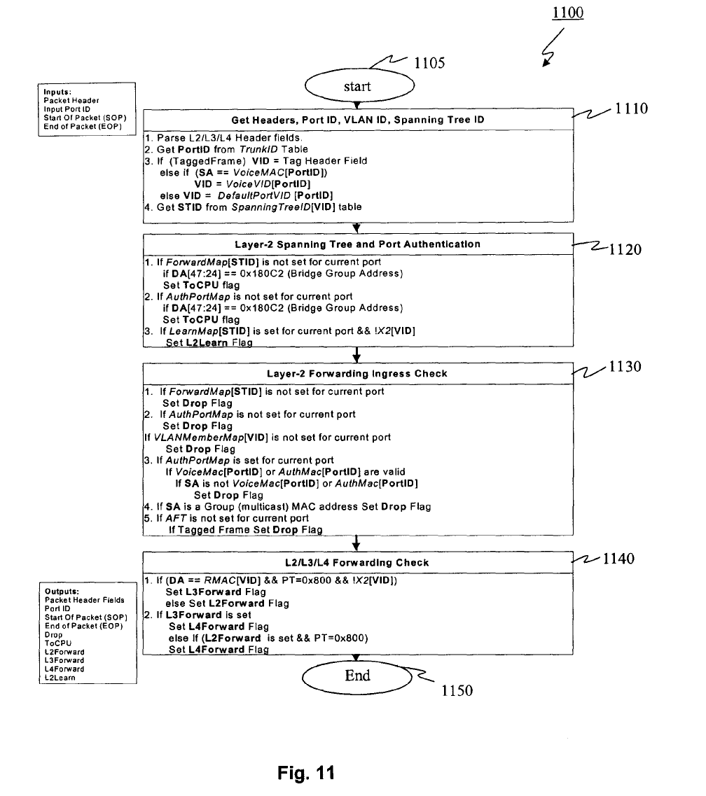

FIG. 11 is a flow diagram of a method 1100 performed by the ingress processing module 420. The method 1100 begins at a Start step 1105 by receiving a packet header, an input port identifier, a SOP and an EOP. Control passes from the Start step 1105 to step 1110, which obtains headers, Port ID, VLAN ID, and Spanning Tree ID from the received parameters. Control passes from step 1110 to step 1120, which performs Layer-2 Spanning Tree and Port Authentication. Control passes to step 1130 to perform Layer-2 Forwarding Ingress Check, and in turn proceeds to step 1140 for Layer-2, Layer-3, Layer-4 Forwarding Check. Control passes to an End step 1150 and outputs packet header fields, a port ID, a SOP, an EOP, a Drop, a toCPU variable, L2Forward, L3Forward, L4Forward, and L2Learn.

Forwarding Chip—Field Descriptions

1. TrunkID
Index: Input Port ID
Data: Trunk Group ID
Size: 64×6 bits
   The TrunkID table contains mappings between the input port and the trunk group. All operations based on the Input Port ID in the forwarding process are preferably performed with respect to the Trunk Group ID. By default, the TrunkID table is preferably populated with a 1-to-1 mapping between the Input Port ID and the Trunk Group ID. When a trunk is configured, the lowest physical port number in the trunk group is used as the Trunk Group ID.

2. VLANMemberMap
Index: VLAN ID
Data: Member Port Map
Size: 256×64 bits
   The VLANMemberMap table maintains the VLAN to Port association for the switching system 100. A VLAN ID indexes this table. The data is stored in this table in a bitmap form. If the bit corresponding to a port is set to 1, the port is registered on the VLAN. This table is used for filtering out invalid incoming frames and to enable multicast flooding of frames.

3. SpanningTreeID
Index: VLAN ID
Data: Spanning Tree (ST)
Size: 256×3 bits
   The SpanningTreeID table stores the VLAN to spanning tree mapping. A table is required for the case of multiple spanning tree support. In the embodiment described herein, the switch supports a maximum of 8 spanning trees. The maximum number of spanning trees may vary, depending on the particular application.

4. ForwardMap
Index: ST ID
Data: Forwarding Port Map
Size: 8×64 bits
   The ForwardMap contains the control bits that indicate whether a port is in the forwarding mode, as determined by spanning tree protocol software. The table is indexed by the Spanning Tree ID and each location contains the bitmap of a forwarding state of each port.

5. LearnMap
Index: ST ID
Data: Learning Port Map
Size: 8×64 bits
   The LearnMap contains the control bits that indicate if a port is in the learning mode, as determined by the spanning tree protocol software. The Spanning Tree ID indexes the table and each location contains the bitmap of the learning state of each port.

6. RMAC
Index: VLAN ID
Data: Router MAC Address
Size: 49 bits
   The RMAC table contains the mapping of VLAN ID to Router MAC address. For each incoming frame, the VLAN ID is determined and the DA is checked against the Router MAC address of the corresponding location in this table. If the addresses match, the packet is destined for the IP routing engine.

7. AuthPortMap
Size: 64 bits
   The AuthPortMap is a bitmap of the authorization state of each port in the system. If 802.1x is active on a port, the state of this bit is determined by this protocol, otherwise a system administrator configures this bit.

8. DefaultPortVID
Index: Port ID
Data: VLAN ID
Size: 64×12 bits
   The DefaultPortVID table contains the default VLAN ID to which untagged packets are assigned. The Port ID is used as an index into this table and the memory location contains the default VID for the port. The default Priority is also specified in this table.

9. AuthMAC
Index: Port ID
Data: MAC Address
Size: 64×49 bits
   The AuthMac table contains the authorized MAC address for a port using 802.1x authentication. When an 802.1x authorized port is configured as a single-host port the MAC address of the authenticated host is written into this table. This locks the port, enabling only the authorized end host to send or receive packets through the port.

10. VoiceMAC
Index: Port ID
Data: MAC Address
Size: 64×49 bits
   The VoiceMac table contains the MAC address for an IP phone that is connected to an input port. When a port receives a packet with the VoiceMac address as its source address, the packet is treated as an authorized MAC address and is forwarded through the port.

11. VoiceVID
Index: Port ID
Data: VLAN ID
Size: 64×16 bits
   The Voice VID table specifies the VLAN ID that is assigned to any frame that contains the VoiceMac as its Source Address. This allows the switch to direct all voice packets in a consistent way through the switch. The table also allows assignment of 802.1p priority for these packets.

12. AFT
Size: 64 bits
   The Acceptable Frame Types (AFT) register is a bitmap that specifies whether tagged VLAN frames should be accepted from the current port. A value of 0 in the bitmap indicates that only untagged frames will be accepted from a port, and a value of 1 indicates that both tagged and untagged frames will be allowed on the port.

13. X2
Index: VLAN ID
Data: X2VLAN
Size: 256×1 bit
   The X2 table is used to implement a private VLAN in which flooding due to unknown or broadcast frames is disabled. The X2VLAN also prohibits routing of frames, and frames are only switched if they are on the same VLAN and an entry exists for the destination MAC address or if the appropriate flow processing entries are set up for Layer-4 forwarding of frames.

14. Multicast Index
Index: VLAN ID
Data: VMIndex
Size: 256×9 bit
   The Multicast Index table is used as a mapping between the incoming VLAN ID and an outgoing multicast table index. This index is used for unknown Layer-2 forwarded frames (i.e., if the frame's destination MAC address is not matched in the CAM). The MSB of this field is set to 1 to indicate that the value has been written by software. If the index is not initialized, the VLAN ID is used as the VMIndex for the Multicast Index table.
   Tables

1. Port Table

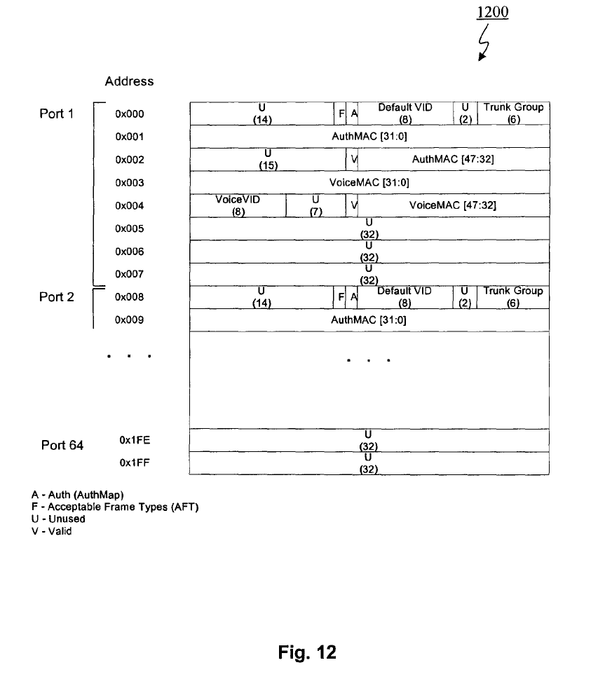

FIG. 12 shows the organisational structure of a port table memory 1200. The port table 1200 contains port attributes required for the ingress processing of the frame header, as discussed above. The port table memory is accessible to the CPU through the port table address and data registers.

2. VLAN Table

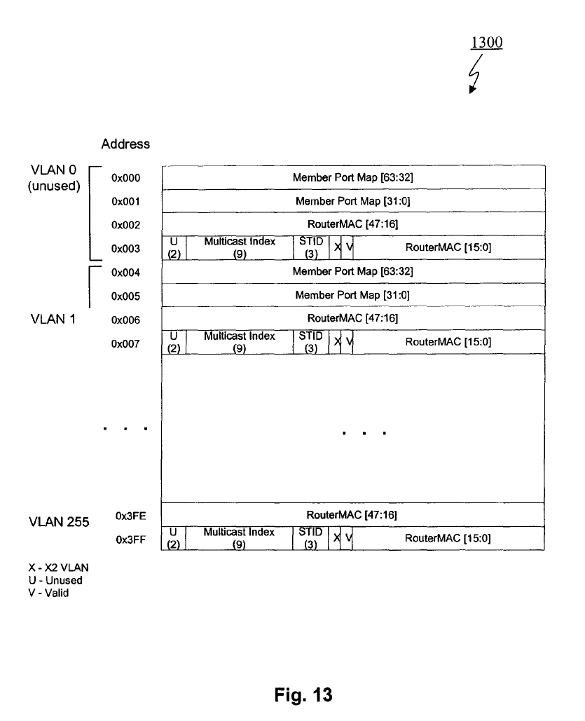

FIG. 13 shows the format of a VLAN attributes table 1300. The VLAN table 1300 is accessible to the CPU through the VLAN Table Address and Data Registers.

3. Spanning Tree Table

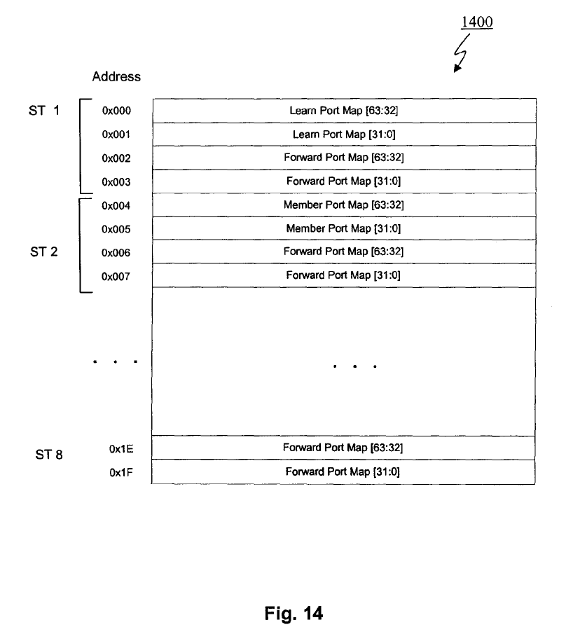

The Spanning Tree Table contains the forwarding and learning information for 8 different Spanning Tree IDs. FIG. 14 shows the format of a Spanning Tree Table 1400.

Forwarding Chip—Layer-2 Processing

Forwarding

The Layer-2 forwarding process performs the processing steps required for 802.1Q-based forwarding of Ethernet packets. The goal of the Layer-2 forwarding function is to direct traffic of a learnt MAC address to the correct output port or ports, thereby avoiding flooding of frames to all ports.

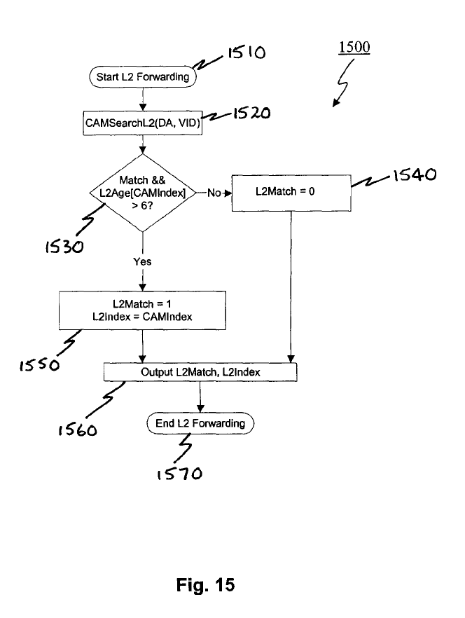

FIG. 15 is a flow diagram of the Layer-2 forwarding function 1500. The Layer-2 forwarding function 1500 begins at step 1510 and proceeds to CAMSearchL2 step 1520. If the L2 Forwarding function is invoked based on the frame headers, the CAMSearchL2 step 1520 performs a search of an external Content Addressable Memory (CAM) for a Layer-2 entry that matches the current frame's Destination MAC Address and VLAN ID.

A match signal indicates that the CAM search was a success. The Match signal returned from step 1520 must be qualified by the state of a L2Age table for the matched index to ensure that the entry is not in the process of being deleted. The L2Age entry is valid, if the L2Match signal and L2Index are valid. The index value returned by the search specifies the location in the Forwarding Information Table that contains the forwarding information for the L2 entry. This index is used to retrieve from external SRAM memory the FlowID that specifies the port or ports to which the frame should be forwarded. Control passes from step 1520 to a decision step 1530.

Decision step 1530 determines whether the match signal is positive and the aging process has reached a predetermined aging threshold, which in this case is shown as L2Age[CAMIndex]>6. If Yes, control passes to step 1550, which sets L2Match equal to 1 and L2Index equal to CAMIndex. Control then passes to an Output step 1560. Returning to step 1530, if No, control passes to step 1540, which sets L2Match equal to 0. Control then passes to the Output step 1560. The Output step 1560 outputs L2Match and L2Index, and then passes control to an End step 1570. It will be appreciated by a person skilled in the art that the predetermined aging threshold is variable, and depnds on the particular application to which an embodiment is applied.

Learning

The Layer-2 processing must also perform learning of the Source MAC address and VLAN. The functionality of the learning process is as follows:
1. On a SOP and L2Learn indication, the Source MAC address and VLAN ID are searched in the CAM. If a match is not found, the Source MAC address (48 bits), VLAN ID (8 bits) and Trunk Group ID (6 bits) are written to a Learn FIFO. If a match is found, the Match Index (12 bits) is used as an index to the Next Hop SRAM, and the Source MAC Address (48 bits), VLAN ID (8 bits) and Trunk Group ID (6 bits) are written to SRAM. The Match Index is also used to update the corresponding entry in the L2Age table with the current value from the Age register and the valid bit is set.
2. On a non-active time slot, the head of the Learn FIFO (if not empty) is read and a Learn CAM Command is issued with the Source MAC address and VLAN ID as the data fields. The Learn Command writes the data at the next free address in the CAM and returns the index value associated with this address. This Learn Index (12-bits) is used as the address to write the Source MAC Address (48 bits), VLAN ID (8 bits) and Trunk Group ID (6 bits) to the Next Hop SRAM. The Learn Index is also used to update the corresponding entry in the L2Age table with the current value from the Age register and the valid bit is set.

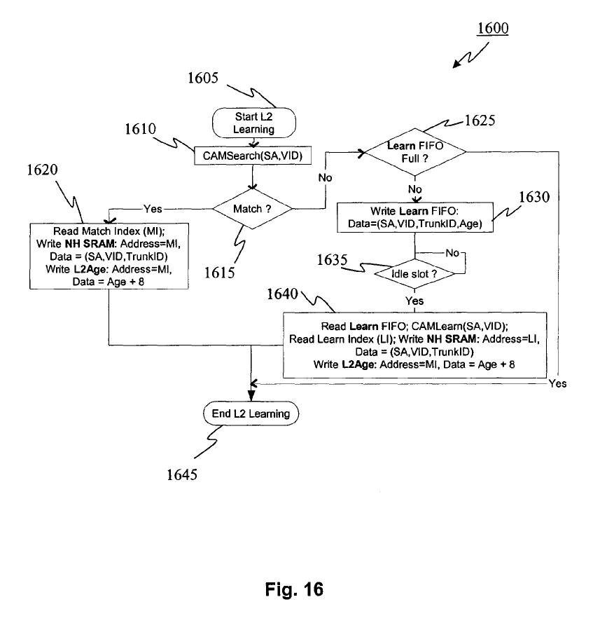

FIG. 16 is a flow diagram for the learning process 1600, when L2Learn is active. The process 1600 begins at a Start L2Learning step 1605 and proceeds to a CAMSearch step 1610, which searches a content addressable memory for a Source MAC address and a VLAN ID. Control passes from step 1610 to a decision step 1615, which determines whether there is a match between the Source MAC address and a VLAN ID. If there is a match, Yes, control passes to step 1620, which processes the data. In particular, step 1620 reads a Match index to be used as an index to the Next Hop SRAM, and writes the Source MAC Address, VLAN ID and Trunk Group ID to SRAM. Further, the Match index is used to update a corresponding entry in the L2Age table with a current value from the Age register (Data=Age+8). Control passes from step 1630 to an End step 1645 and the learning process 1600 terminates.

Returning to step 1615, if there is not a match, No, control passes from step 1615 to step decision 1625, which determines whether the Learn FIFO queue is full. If the FIFO queue is full, Yes, control passes to the End step 1645 and the process 1600 terminates. However, if the FIFO queue is not full at step 1625, No, control passes from step 1625 to 1630. Step 1630 writes to the Learn FIFO queue and sets the Source MAC address, VLAN ID, Trunk ID, and Age as data fields. Control passes from step 1630 to a decision step 1635, which determines whether there is an idle slot. If there is no idle slot, No, control returns recursively to step 1635 until an idle slot is available. If there is an idle slot at step 1635, Yes, control passes to step 1640. Step 1640 reads from the head of the Learn FIFO queue and issues a CAMLearn command using the Source MAC address and VLAN ID as parameters. The CanLearn command writes data at a next available free address in the CAM, and returns an index value associated with that address. The Learn index is then used as an address for writing values of the Source MAC address, VLAN ID, and Trunk ID to the Next Hop SRAM. The Learn index is also utilised to update a corresponding entry in the L2Age table. Control passes from step 1640 to the End step 1645 and the process 1600 terminates.

Aging

The function of the Aging Process is to remove Layer-2 MAC entries from the CAM address table when the age of the entry reaches a value that is one higher than the value in the age register. This implies that Ethernet frames with a source MAC address corresponding to the given entry have not traversed the switch within the aging period for the entries. A software process updates the 3-bit age register at an interval equal to ⅛th of the aging time specified by the configuration of the switch.

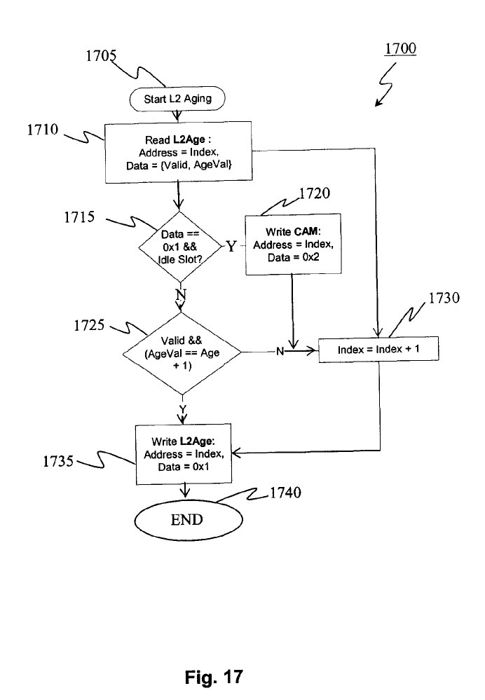

FIG. 17 is a flow diagram of the process of aging 1700. The Aging process consists of two main operations: (i) invalidating L2Age entries based on the current value of the Age Register; and (ii) removing aged entries from the CAM, when there is an idle time slot available. The aging process 1700 begins at a Start step 1705 and proceeds to step 1710, which reads the L2Age table for a current index and obtains data for a Valid value and AgeVal value. Control passes to a decision step 1715, which determines whether the read data is equal to 0x1 and there is an idle slot. The AgeVal value stores the age value. If the AgeVal is equal to 0x1, the age value is at its initial value. If No, control passes to decision step 1725, which determines whether the Valid data value is positive and the AgeVal value is equal to the present Age value+1. If Yes, control passes to step 1735, which writes to the L2Age table using the index and sets the data to 0x1. Control then passes to an End step 1740. Returning to step 1715, if Yes, control passes to step 1720, which writes to the CAM using the present index and sets the data to 0x2. Control passes from step 1720 to step 1730, which increments the present index by 1 and then passes control to step 1735. Returning to step 1725, if No, control passes to step 1730 to increment the index. Returning to step 1710, a parallel path proceeds from step 1710 to the step 1720 to increment the index.

Registers and Tables

1. Age Register

The Age Register is a 3-bit field that specifies the current time that is written to the L2Age table when Layer-2 MAC entries are learned or updated. The Age Register is preferably updated by one at an interval equal to ⅛th of the MAC address Aging time by a software process.

2. L2Age Table

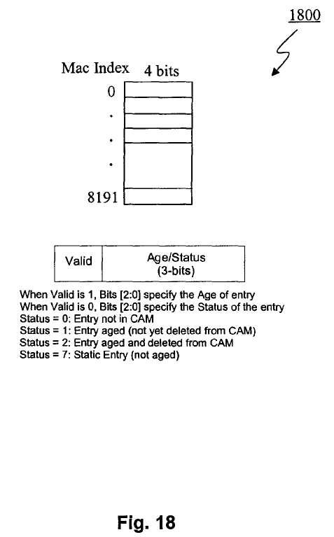

The L2Age Table consists of 8192 entries, each entry corresponding to an index in CAM containing a Layer-2 entry. Each entry in the L2Age table consists of 4-bits. FIG. 18 shows the encoding of the L2Age table 1800. On initialization, all L2 Age entries are set to 0 to indicate that there are no entries in the CAM at these indices. When a MAC address is learned in CAM, the Valid bit is set to 1 and the value of the Age Register is written to the L2Age table entry. When the entry is aged, the Valid bit is set to 0 and the Status word is set to 1 to indicate that the CAM entry can be overwritten. When the CAM entry is cleared, the Status word is set to 2.

3. Learn FIFO

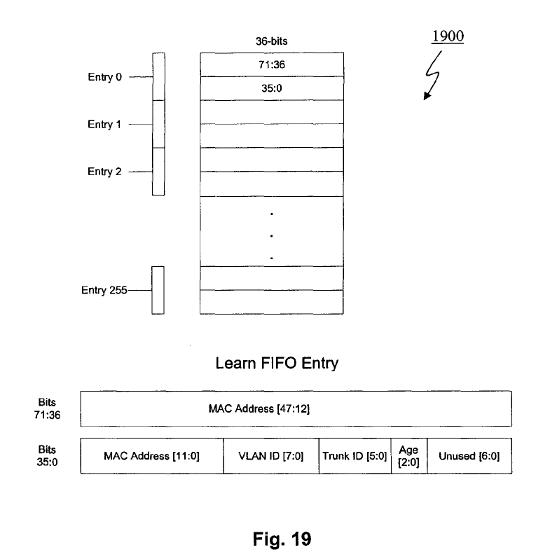

The Learn FIFO contains data to be stored until there are time slots available to be written to the CAM and Next Hop SRAM. The Learn FIFO is a 36-bit FIFO with 512 entries that can store 256 MAC addresses to be learned whenever there is an idle time slot. The Learn FIFO entries consist of the (Source) MAC address and VLAN ID, the input Trunk ID and the current age value. FIG. 19 shows the format of the Learn FIFO register 1900.

Forwarding Chip—Layer-3 (IP) Forwarding

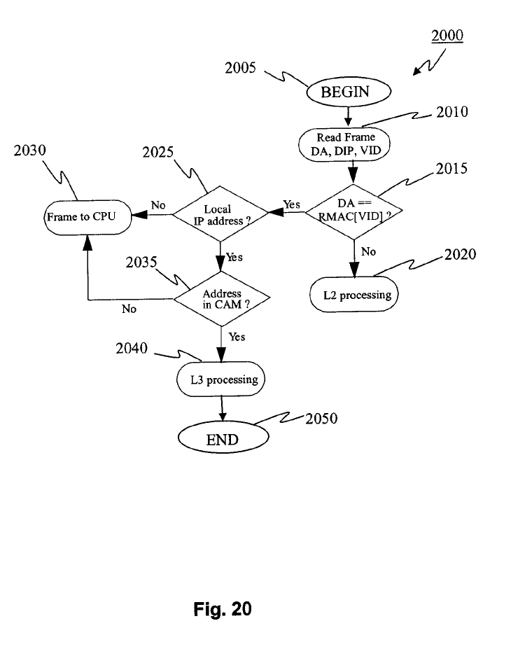

The L3 processing functions consist of the forwarding functions required for an IP router. FIG. 20 is a simplified flow diagram 2000 that combines L2 and L3 forwarding techniques. The flow diagram 2000 starts at a BEGIN step 2005 and proceeds to step 2010, which reads a frame to obtain a destination MAC Address (DA), a destination IP address (DIP) and a VLAN ID (VID). Control passes to decision step 2015, which determines whether the DA is equal to the entry at index VID of the router MAC address (RMAC) table. If No, control passes to a terminating step 2020 for Layer-2 processing. If at step 2015 the DA is equal to the entry at index VID of the RMAC table, Yes, control passes to a decision step 2025 that determines whether an IP address is local. If the IP address is local, Yes, control passes to another decision step 2035. Decision step 2035 determines whether the address is in the CAM. If the address is in the CAM, Yes, control passes to step 2040 for Layer-3 processing. Control then passes to an End step 2050 and the process terminates. Returning to step 2025, if the IP address is not local, No, control passes to terminating step 2030, which sends the frame to a CPU. Returning to step 2035, if the address is not in the CAM, No, control passes to the terminating step 2030 for sending the frame to the CPU.

The approach described above with reference to FIG. 20 assumes that the switch maintains routing tables for IP network addresses. These tables are used to determine the Next Hop IP and MAC addresses for an IP frame destined to the router.

IP Forwarding Algorithm

FIG. 21 is a flow diagram 2100 for unicast IP forwarding in hardware from RFC 1812, which provides Requirements for IP Version 4 Routers. The relevant section from RFC 1812 describing each operation is shown in parentheses in FIG. 21. Since IP options processing and Internet Control Message Protocol (ICMP) generation are typically performed in software, such operations are not shown in the flow diagram, for the sake of clarity.

The flow diagram 2100 begins at a Start step 2105 and proceeds to step 2110, which reads an IP header. Control passes to step 2115 to validate the IP header, and in turn passes to step 2120 to forward a decision. Control passes to step 2125 to verify a next hop and then step 2130 decrements a Time-to-Live (TTL) counter. Control passes to step 2135 to link layer address. A next step 2140 forwards the frame to a port, and the process 2100 terminates at an End step 2145.

For multicast forwarding, additional checks are required. In particular, the source address is checked to ensure that the interface from which the packet is received is the interface that would be used to forward packets to the source. This process is also known as a reverse path forwarding check.

In one embodiment, multicast routing is performed in software, while multicasting is performed in hardware.

Layer-3 Functions

The Layer-3 hardware features:
1. Support for class based routing and support for variable length subnet masks.
2. Support for TTL decrementing and incremental header checksum calculations.
3. Support for DiffServ-based QoS.

The layer-3 functions are divided into the following functions:
IP Header check—verifies that the fields of the IP header are legal and that the header can be handled by hardware forwarding.
IP Checksum—calculates the checksum of the IP header and verifies that the checksum inserted in the frame header matches this value.
IP Address Lookup—the algorithm for IP address lookup is flexible enough to support a limited number of variable length network prefix or can also be used for class based routing.
IP Output—performs calculation of the incremental header checksum and classification of traffic class based on the IP protocol field and then forwards frame to the appropriate output ports.
   Registers and Tables

1. Port IP Forwarding Disable (PortIPFDis1 [31:0], PortIPFDis2 [31:0]) These registers are used to enable or disable the IP forwarding operation for any port. A value of 0 indicates enable, 1 indicates disable.

2. Layer-3 Status and Control Register (L3SCR [31:0])

This register contains the control bits for the Layer-3 forwarding process. Bits in this register turn on or off the forwarding of packets to the CPU. This includes headers that fail the Layer-3 header checks and the frames for which no route exists in the tables.

Functional Flow Diagrams

In the following flow diagrams, it is assumed that a check has been performed to ensure that the frames sent for layer-3 processing contain the router's MAC address (for the VLAN) as the destination MAC address. For all other frames, layer-2 802.1Q processing is performed.

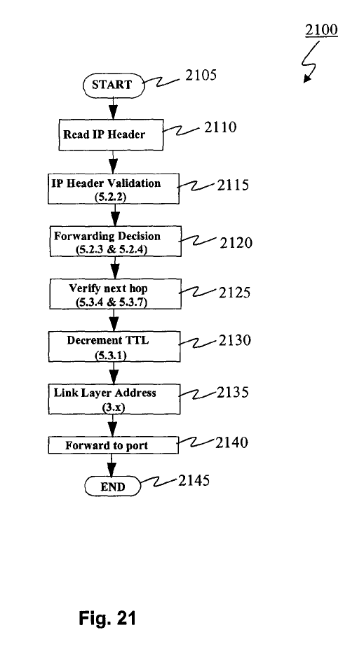

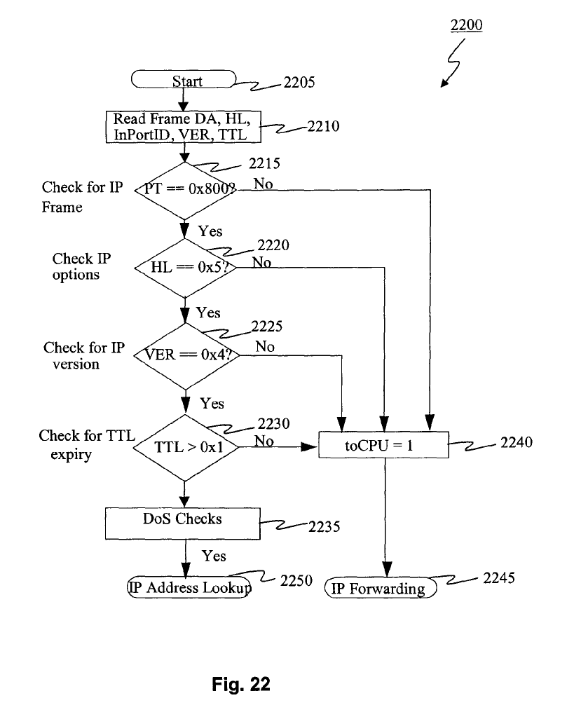

FIG. 22 is a flow diagram of an IP header checking process 2200. The process 2200 begins at a Start step 2205 and proceeds to step 2210, which reads a frame to obtain a destination MAC address (DA), an IP header length (HL), an InPORTID, an IP Version VER, and a TTL. Control then proceeds to a decision step 2215, which determines whether the frame is an IP frame. If at step 2215 an Internet Protocol Type (PT) is equal to 0x800 and thus indicates that the protocol type is Internet Protocol (IP), Yes, control proceeds to a further decision step 2220. The decision step 2220 checks IP options and if the IP header length HL is equal to 0x5, Yes, control proceeds to another decision step 2225. An HL equal to 0x5 indicates that there are no options present. The decision step 2225 checks for an IP Version, and if the VER equals 0x4 and thus indicates that the frame is IPv4, Yes, control passes to decision step 2230, which checks for TTL expiry. If at decision step 2230 the TTL is greater than 0x1, Yes, control proceeds to step 2235 to perform Denial of Service (DoS) checks. Control passes from step 2235 to a terminating step 2250 which performs an IP address look up.

Returning to decision step 2215, if when checking for an IP frame the PT is not equal to 0x800, No, control passes to a step 2240, which sets a variable toCPU equal to 1. Control then proceeds to a terminating step 2245, which performs IP forwarding. Returning to decision step 2220, if the IP options are such that HL is not equal to 0x5, No, control proceeds to step 2240, as described above. Similarly, if at step 2225, when checking for an IP Version, the VER is not equal to 0x4, No, control also passes to step 2240. In a similar manner, if at step 2230 when checking for the TTL expiry the TTL is not greater than 0x1, No, control passes to the step 2240.

IP Header Check

The IP header check performs validation of the IP header fields in order to determine if IP processing in hardware is feasible and to discard illegal IP frames. For IP header validation, the following checks are made:
1. Is the protocol type for the frame 0x800 (IP)?—If the protocol type is not IP, then the frame is forwarded to the CPU port. This allows the same MAC address to be used with other protocols implemented in software.
2. Is the header length equal to 0x05 (32-bit) words?—If the IP header does not contain IP options (such as, for example, source routing), the size of the header should always be 10 16-bit words. If IP options are present, the frame is sent to software for appropriate processing. The frame may also be discarded by software if the header length is less than 0x05.
3. Is the IP version field 0x4? IPv4 has a version number of 4. If version number is 5 (ST-II) or 6 (IPv6), the processing is performed in software, else the packet will be discarded.
4. Is the TTL value of the frame equal to 0x1 or 0x0? Frame with TTL values of 0 or 1 should not be forwarded. However, these frames should also not be discarded, since an ICMP time exceeded message may be sent to the originator of the frame. Hence, these frames are forwarded to the CPU port.
5. Denial of Service Prevention Checks
6. Datagram length is too short
7. Frame is fragmented
8. Source IP address=Destination IP Address (LAND attack)
9. Source IP address is subnet broadcast
10. Source IP address is not unicast
11. Source IP address is a loop-back address
12. Destination IP address is a loop-back address
13. Destination address is not a valid unicast or multicast address (martian address)
   After header fields are checked, routing of the IP frame to the correct output port is performed by IP address lookup and forwarding.

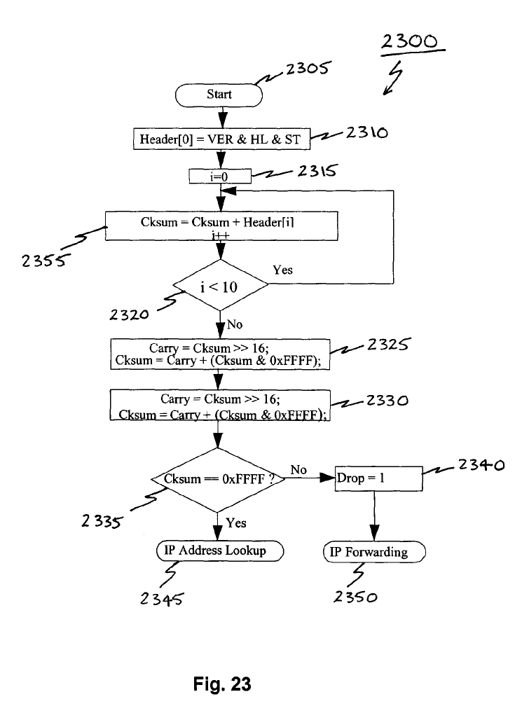

FIG. 23 is a flow diagram of an IP header checksum process 2300. The process 2300 begins at a Start step 2305 and proceeds to step 2310, which sets a first element of a header array, HEADER [0], to incorporate the IP Version, IP Header Link, and Spanning Tree information, (VER & HL & ST). Control proceeds to step 2315 which sets an index i equal to 0. Control then proceeds to step 2355, which sets a checksum equal to the present checksum plus the contents of the header array given by the present value of the index i. The index i is then increased.

Control proceeds from step 2355 to decision step 2320, which determines whether the index i is less than 10. If the index i is less than 10, Yes, control returns to step 2355. However, if at step 2320 the index i is not less than 10, No, control proceeds from step 2320 to step 2325. Step 2325 sets the carry equal to a checksum that is very much greater than 16 and sets the checksum (CKSUM) equal to the carry plus (CKSUM & 0xFFFF). Control proceeds from step 2325 to step 2330, which sets the carry equal to a checksum very much greater than 16 and then assigns the checksum (CKSUM) equal to the carry plus (CKSUM & 0xFFFF). Control proceeds from step 2330 to a decision step 2335, which determines whether the checksum is equal to 0xFFFF. If Yes, control proceeds to a terminating step 2345 to perform an IP address lookup. If at step 2335 the checksum is not equal to 0xFFFF, No, control passes to step 2340, which sets a Drop flag equal to 1. Control proceeds from step 2340 to a terminating step 2350 to perform IP forwarding.

IP Header Checksum

The start of the Header is at the IP version field (VER). The checksum algorithm is as follows:
The sum of the first 10 16-bit words of the IP frame header is obtained using 20-bit addition.
The sum of bits [19:16] (the carry bits) and bits [15:0] is obtained using 17-bit addition.
Bit 16 is added to bits [15:0] to obtain the final checksum.
The checksum is valid if the ones complement of this sum is equal to 0.
   IP Address Lookup

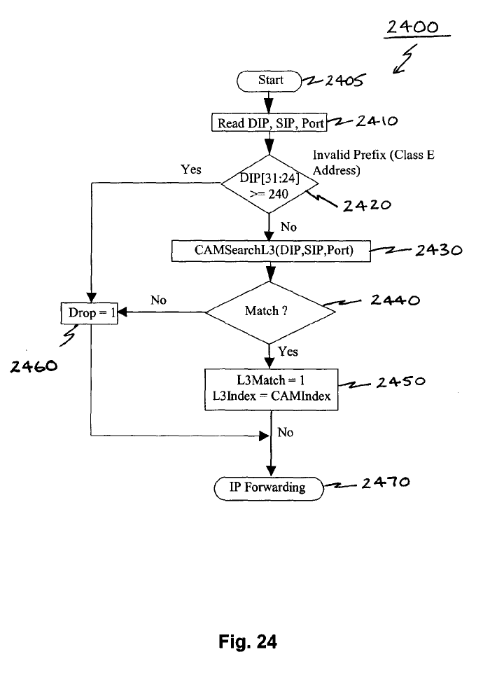

FIG. 24 is a flow diagram of an IP address lookup process 2400, which begins at a Start step 2405. Control proceeds to step 2410, which reads a destination IP address (DIP), a source IP address (SIP), and a port. Control proceeds to step 2420, which determines whether there is an invalid prefix address, DIP (31:24)>=240. If Yes, control proceeds to step 2460 that sets a Drop flag equal to 1. Control proceeds from step 2460 to a terminating IP forwarding step 2470.

Returning to step 2420, if DIP (31:24) is not greater than or equal to 240, No, control proceeds step 2430, which performs a CAMSearchL3 function using the DIP, SIP, and Port. Control proceeds to another decision step 2440, which determines whether there is a match. If there is not a match, No, control proceeds to step 2460 to set the Drop equal to 1. However, if at step 2440 there is a match, Yes, control proceeds to step 2450, which sets a layer-3 match index equal to 1 and sets a layer-3 index equal to CAMIndex. Control then passes from step 2450 to the terminating step 2470 to perform IP forwarding.

The address lookup returns a pointer to Next Hop SRAM that contains the next hop (router or host) MAC address, TrunkID and VID. The CAMSearchL3 Function returns the index to the first match of the Destination IP address in the CAM.

An IP address consists of a network prefix and a host number. The network prefix may be of any length from 1 to 32 bits and the host number is the remaining part of the IP address. For a given IP address, there may be entries in the CAM for multiple network prefixes that match the destination IP address. IPv4 router requirements (RFC 1812) specify that the longest length network prefix match for a given IP address must be used in order to forward the IP frame to the correct next hop.

This classless lookup requirement is in contrast with the class based addressing that has been in widespread use in the Internet. In class-based addressing, the first 4 bits of an IP address determine the mask that is used for an IP address in order to perform the CAM lookup. The concept of subnets extended this to a maximum of two masks that could potentially be used.

The embodiment described herein uses a ternary CAM in order to determine the longest length match. In order to perform this search, entries in the CAM are populated such that a route for a longer prefix is always stored in a lower index memory location than a route for a shorter prefix. Since the CAM will return the first match in memory for a particular IP address, this match will be guaranteed to be the longest prefix route match for the IP address. In order to simplify IP table management, a block of memory locations is preferably reserved for each prefix, so that entries may be inserted without requiring shuffling of the IP route prefix entries in the CAM. The order of entries in the CAM within the same prefix length routes is immaterial. This property can be used to implement a faster reshuffling, if any prefix runs out of memory locations.

When a search of the CAM does not result in any matches, the frame is discarded. If a match is obtained, the CAM search returns the index of the match. This index is used in the Next Hop module to obtain the next hop MAC, Trunk ID and VID. These values are read from the Forwarding Information memory in external SRAM.

Forwarding Updates

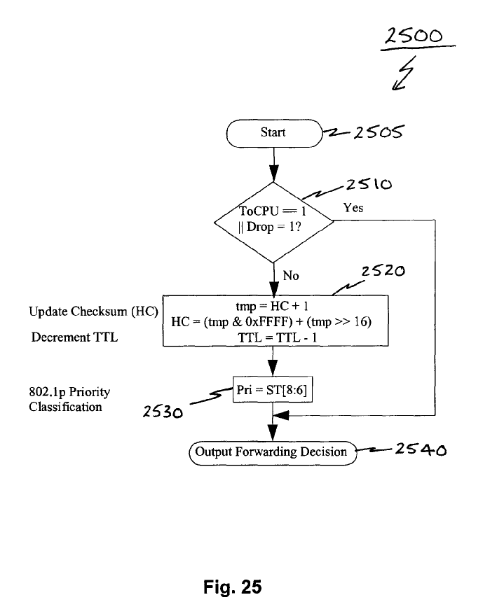

FIG. 25 is a flow diagram of a Forwarding Updates process 2500, which begins at a start step 2505. Control passes to an initial decision step 2510, which determines whether a variable toCPU is equal to 1, or if the Drop flag is equal to 1. If Yes, control passes to an output forwarding decision step 2540 and the process terminates. However, if the answer at step 2510 is No, control passes to step 2520. Step 2520 sets a temp variable equal to Header Checksum (HC) plus 1. The Header Checksum (HC) is then set equal to (temp & 0xFFFF)+(tmp>>16). The TTL counter is decremented. Control passes from step 2520 to step 2530, which sets an Ethernet priority variable to a spanning tree ST[8:6] to set a priority of a port mapping, where ST[8:6] corresponds to one of the addresses of ST1 . . . ST8 of FIG. 14. Control passes from step 2530 to the output forwarding decision step 2540.

The final stage of IP processing requires the TTL to be decremented and the IP header checksum to be updated. When decrementing the TTL by 1, the incremental header checksum operation is an addition of 1 to the original checksum. The carry bit must be examined and added to the checksum if it is set. If the packet is to be discarded or forwarded to the CPU, no TTL decrementing needs to be done.

Forwarding Output

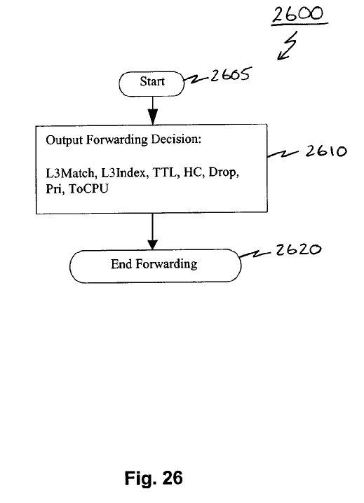

FIG. 26 is a flow diagram of a Forwarding Output process 2600. The process 2600 begins at Start step 2605 and proceeds to a step 2610 for outputting a forwarding decision. In particular, a step 2610 outputs parameters L3Match, L3Index, TTL, HC, drop, PRI, and ToCPU. Control passes from step 2610 to an End step 2620 and the process terminates.

The layer-3 forwarding output generates the L3Index as the output that is used to determine the output FlowID, Next Hop Destination MAC Address and VID. The new TTL and HC are also output and are used to update the header fields of the frame.

Forwarding Chip—Flow Classification and CAM Controller

The Flow Classification block 450 performs the matching operation for the header fields of a Layer-2 or an IP frame, up to and including the transport layer headers. This operation classifies any packets that match these fields into a flow.

The flow classification operation may or may not result in a match. In the case of a match, the index is returned and is forwarded to the Next Hop module 460 for further processing. In the case that there is no match, the classification does not return an index and the packet is not classified into a flow.

The processing steps performed by the Flow Classification block are outlined below:
1. If SOP, is RMAC and is IP (PT==0x800) signals are active, the Destination IP Address, Source IP Address, Source Port, Destination Port, Input Port, TOS, SYN and ACK fields are used to perform a 128-bit search operation against the Flow Classification entries in the CAM. The Index and Match status signals are passed to the Next Hop block.
2. Else if SOP and is IP (PT==0x800) signals are active, the Destination MAC address, the Destination IP Address, Source Port and Destination port are used to perform a 128-bit search of Layer-2 Classification fields in the CAM. The CAM controller returns the Index and Match signals.
3. If the SOP and is IP signals are not active, no flow classification search is performed.

The flow classification block also performs the CAM search operations for the Layer-2 and Layer-3 header lookups and sequences these operations in a pipelined manner.

CAM Controller

The CAM controller performs a pipelining operation for an external CAM. The CAM is used for storage of Ethernet MAC addresses, IP routing prefixes and Flow Classification entries. In this embodiment, a 1 Mb Ternary CAM capable of storing a maximum of 32K 72-bit entries or 16K 144-bit entries or any combination of 72-bit and 144-bit entries in 4 KB increments is utilised. The ternary CAM contains a mask per entry in the CAM and also contains Global Mask Registers that can be used on a global basis for search operations. When a bit in a mask is set to 0 for an entry, a CAM search treats the corresponding bit as a “don't care” and will not compare that bit against the search data in determining if a match has occurred.

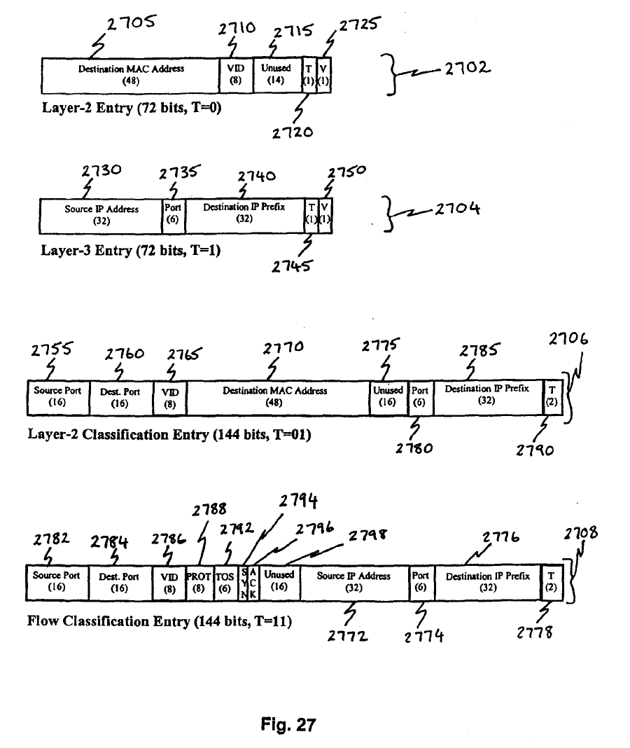

The four types of CAM entries are Layer-2 entry, Layer-3 entry (IP routes), Layer-2 Classification entry and Flow Classification entry. FIG. 27 shows the format of Classification entry fields. The format of each type of entry in the CAM is shown in FIG. 27. Search operations are performed in 72-bit segments (for Layer-2/Layer-3 searches) or 144-bit segments (for Flow/Layer-2 Classification). These segments are preferably configured at system startup, so that a search operation will only match against related CAM entries. A 1-bit type field is used to differentiate between Layer-2 and Layer-3 entries and Layer-2 Classification entries from the Flow Classification entries.

A Layer-2 entry 2702 consists of 72 bits, with T=0. The Layer-2 entry consists of: a Destination MAC Address 2705 (48 bits); a VID 2710 (8 bits); an Unused portion 2715 (14 bits); a T field 2720 (1 bit); and a V field 2725 (1 bit).

A Layer-3 entry 2704 consists of 72 bits, with T=1. The Layer-3 entry consists of: a Source IP Address 2730 (32 bits); and Port identifier 2735 (6 bits); a Destination IP Prefix 2740 (32 bits); a T field 2745 (1 bit); and a V field 2750 (1 bit).

A Layer-2 classification entry 2706 consists of 144 bits, with T=01. The Layer-2 classification entry consists of: a Source Part 2755 (16 bits); a Destination Port 2760 (16 bits); a VID 2765 (8 bits); a Destination MAC Address 2770 (48 bits); an Unused portion 2775 (16 bits); a Port identifier 2780 (6 bits); a Destination IP Prefix 2785 (32 bits); and a T field 2790 (2 bits).

A Flow Classification entry 2708 consists of 144 bits, with T=11. The Flow classification entry consists of: a Source Part 2782 (16 bits); a Destination Port 2784 (16 bits); a VID 2786 (8 bits); a PROT field 2788 (8 bits); a TOS field 2792 (6 bits); a SYN field 2794 (1 bit); an ACK field 2796 (1 bit); an Unused portion 2708 (16 bits); a Source IP Address 2772 (32 bits); a Port identifier 2774 (6 bits); a Destination IP Prefix 2776 (32 bits); and a T field 2790 (2 bits).

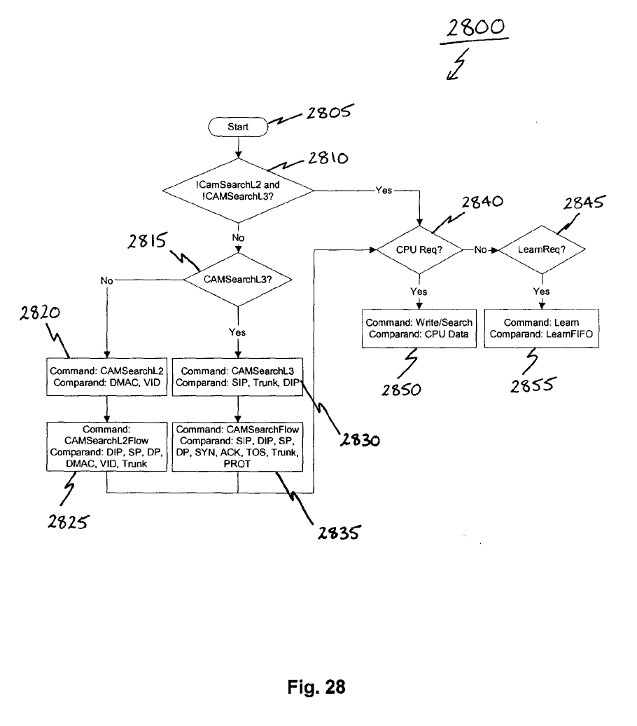

The CAM controller sequences the search- and write-operations to the CAM based on the control signals for each time slot. The process performed by the CAM controller is shown in FIG. 28. The CAM controller performs a Layer-2 or Layer-3 search based on the control signals from the Layer-2 and Layer-3 forwarding modules. These searches are then followed by search for flow classification and finally an optional CPU access (or Source Address Learn access) can also be performed.

FIG. 28 is a flow diagram of the controller operation 2800 of the CAM. The process 2800 begins at start step 2805 and proceeds to an initial decision step 2810, which determines whether a CAMSearchL2 and a CAMSearchL3 are not required. If Yes, control proceeds to another decision step 2840, which determines whether the CPU is required. If the CPU is required, Yes, control proceeds to step 2850, which performs a write/search command and sets a Comparand to CPU data. The Comparand is used to compare CPU data and a learning request. If at decision step 2840 the CPU is not required, No, control passes to another decision step 2845, which determines whether learning is required. If Learning is required, Yes, control passes to a terminating step 2855, which performs a learn command and sets the Comparand to learn FIFO. If Learning is not required, the control flow terminates.

Returning to step 2810, if No, control proceeds to decision step 2815, which determines whether CAMSearchL3 is required. If Yes, control proceeds to step 2830 which executes the CAMSearchL3, and sets the Comparand to SIP, Trunk, and DIP. Control then proceeds to step 2835 which performs the CAMSearchL3Flow command, and sets the Comparand to SIP, DIP, SP, DP, SYN, APK, TOS, TRUNK, and PROT. Control proceeds from step 2835 to the decision step 2840 to determine whether further CPU processing is required. Returning to step 2815, if CAMSearchL3 is not required, No, control passes to step 2820, which performs a CAMSearchL2 command and sets the Comparand to DMAC, VID. Control passes to step 2825 which performs CAMSearchL2Flow command and sets the Comparand to DIP, SP, DP, DMAC, VID and TRUNK.

Registers

1. CAM Command Register

The CAM Command register is used to perform write and search operations to the CAM array. The CAM Command register contains a 13-bit CAM Address that is used to access the ternary CAM array for reading and writing entries and the control bits to specify if special operations are to be performed. Such special operations may include, for example, but are not limited to, writing to a mask word, and deleting a mask entry. Typical instructions that may be used by the CPU are:
Write data at Address Location
Write mask at Address location
Invalidate Entry at Address Location
Compare Ternary CAM to data in comparand registers and return index
   A write into this command register triggers the operation to be performed. Data associated with the instruction is preferably stored in the data registers before issuing a command.

2. CAM Data Register

The CAM Data Registers are used to write data and mask words to the ternary CAM. For a write operation, the data in these registers are used as the data to write into a location and for a read operation, the data in the CAM is returned in these registers.

3. CAM Control and Status Register

The CAM Control and Status register is used to control operation of the CAM by the processor. Status bits indicating the completion of the CAM initialization operation and the CAM status flags (Full Flag, Match Flag, etc.) of the CAM are contained in this register.

Forwarding Chip—Next Hop Processing

Next Hop block functions are performed in a pipelined manner, so that a new frame header decision is processed every 8 clock cycles. This implementation ensures that the processing speed matches the incoming maximum packet arrival rate for 64-byte frames.

The Next Hop Processing module 460 is responsible for determining the final output decision for a frame and controls frame header modification. An overview of the processing steps of the Next Hop are as follows. Forwarding information is read from an external SRAM memory based on the Layer-2, Layer-3 and flow classification match signals. The forwarding information is used to determine the output flow and new headers for the frame. Next, the policing and DiffServ operations are performed for the packet, based on a Policing ID assigned to the current flow. If the packet is not to be dropped, header field replacement, frame segment replication and forwarding of segments to the CPU are performed as required by the output decision. Finally, a multicast control block replicates frame segments as necessary and adds the correct header control bits for the buffering and queuing of frames before forwarding the frame segments to the QCHIP.

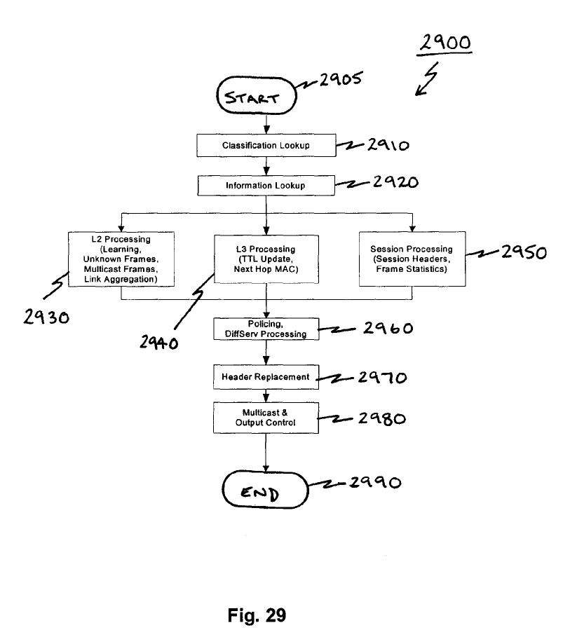

FIG. 29 is a flow diagram of the functionality 2900 of the next hop module. The process 2900 begins at a Start step 2905 and passes to a classification lookup step 2910. Control passes to an information lookup step 2920 and then breaks into three parallel streams. An initial parallel stream proceeds from step 2920 to a Layer-2 processing step 2930. The Layer-2 processing step uses learning, unknown frames, multi-cast frames, and link aggregation. Control passes from step 2930 to step 2960. A second parallel stream from step 2920 passes to a Layer-3 processing step 2940, which uses a TTL update, and a next hop MAC. Control passes from step 2940 to step 2960. The third parallel processing stream from step 2920 proceeds to step 2950, which performs session processing using session headers and frame statistics, before passing control to step 2960. Step 2960 performs policing and DIFFSERV processing, before passing control to step 2970 to perform header replacement. Control passes to step 2980 for multicast and output control, before terminating at an End step 2990.

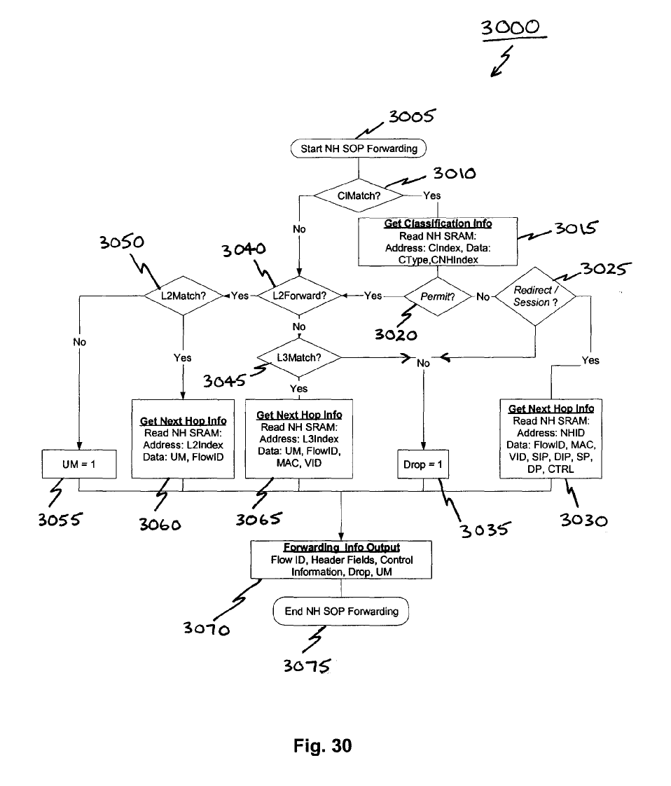

FIG. 30 is a flow diagram of the next hop forwarding process 3000. The process 3000 begins at a Start step 3005 and control proceeds to a decision step 3010, which determines whether there is a Classification Index (CI) match. If there is a CI match, Yes, control proceeds to step 3015 to get classification information by reading the Next Hop SRAM (NH SRAM); address is CIndex, and data is CType, and CNHIndex. Control proceeds from step 3015 to a decision step 3020, which determines whether there is a permit. If there is not a permit, No, control passes to a further decision step 3025, which determines whether to redirect. If Yes, control passes from step 3025 to step 3030 to obtain next hop information. Step 3030 reads the Next Hop SRAM (NH SRAM), address is NHID, and the data read is FlowID, MAC, VID, SIP, DIP, SP, DP, and CTRL. Control proceeds from step 3030 to step 3070, which outputs the forwarding information. The forwarding information includes Flow Id, header fields, control information, Drop, and Unknown/Multicast (UM) bit. Control passes from step 3070 to an End step 3075.

Returning to step 3025, if there is no redirection, No, control passes to a drop step 3035, which sets Drop equal to 1, and then passes control to the forwarding information output step 3070. Returning to step 3020, if there is a permit, Yes, control passes to a decision step 3040. Returning to step 3010, if there is no CI match, No, control passes to the decision step 3040.

The decision step 3040 determines whether there is Layer-2 forwarding. If there is Layer-2 forwarding, Yes, control passes to a decision step 3050, which determines whether there is a Layer-2 match. If there is not a Layer-2 match, No, control passes from step 3050 to step 3055 which sets the Unknown/Multicast (UM) bit equal to 1. Control passes from step 3055 to the forwarding information output step 3070. If at step 3050 there is a Layer-2 match, Yes, control passes to step 3060, which gets the next hop information. Step 3060 reads the NH SRAM, the address is the L2Index, and data is the UM and FlowID. Control passes from step 3060 to the forwarding information output step 3070.

Returning to decision step 3040, if there is no Layer-2 forwarding, No, control passes to the decision step 3045, which determines whether there is a Layer-3 match. If there is no Layer-3 match, control passes to the drop step 3035, which sets Drop equal to 1 and then passes control to the forwarding information output step 3070. However, if at step 3045 there is a Layer-3 match, Yes, control passes to step 3065 to get next hop information. Step 3065 reads the NH SRAM, the address is the L3Index, and data is UM, FlowID, MAC, and VID. Control passes from step 3065 to the forwarding information output step 3070.

The FlowID parameter value is used to determine the ports to which the frame should be forwarded. However, if the Unknown/Multicast (UM) bit is set, the FlowID value is used as an index into a forwarding table in the multicast and output processing module. For the case of Layer-2 forwarding when there is no match in the CAM (Unknown frame), the FlowID is set to 0 and the multicast block determines the forwarding port map by reading the VLANMemberMap table for the VID.

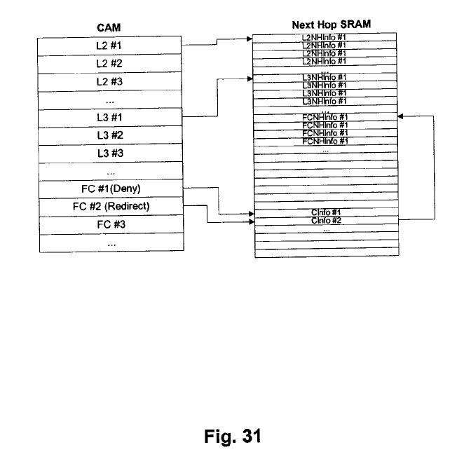

FIG. 31 shows the relationship between Layer-2, Layer-3 and Flow Classification entries in the SRAM and the corresponding entries in the Next Hop Table in an external SRAM. Layer-2 and Layer-3 Entries in the CAM always have a corresponding entry in the NH SRAM table (as shown by L2NHInfo and L3NHInfo in FIG. 31). However, Flow Classification entries in the CAM do not necessarily have corresponding NHInfo entries (as shown in the FC #1 CAM entry), except for the cases of Redirect (as shown in FC #2 CAM entry) and Session Control entries. The Flow Classification entries always have Classification Information Entries (Cinfo) in external SRAM that specify the type of classification entry.

The processing steps of the Next Hop block are as follows:
1. If Flow Classification results in a successful match (CIMatch is valid), the memory location in the Next Hop SRAM of the classification entry (CIndex [14:0]) is read.

This Classification entry can be of 4 types:
a) a permit with CoS entry that specifies the whether a frame should be forwarded and the class on which it should be forwarded;
b) a deny entry that specifies that the frame should be filtered;
c) a redirect entry that contains a pointer to next hop memory specifying the port and parameters to forward a frame; and
d) a session entry that contains a pointer to next hop memory and control bits specifying header fields to be replaced.
2. Based on the classification entry type, the following actions are taken.
   a) For a perm it with CoS entry, the CIFlowID [13:0] field (in the CInfo entry) is used to generate a new FlowID by OR'ing the Next Hop FlowID with this field. This is used to generate a new CoS for a frame.
   b) For a deny entry, a Drop signal is generated.
   c) For a redirect entry, a new Next Hop Index (CINHID [13:0]) is read from the CInfo entry that supersedes the indexes returned by the Layer-2 and Layer-3 match operations.
   d) For a session control entry a new CINHID [13:0] and CTRL [4:0] fields are generated that specify the next hop entry as well as the control fields for replacing the various headers in the frame header.
3. If a match occurs for a Layer-3 forwarded frame (L3Match is valid), a read of the location specified by L3Index is performed. This location contains the next hop entry for a Layer-3 route (consisting of a destination MAC address (DMAC), VLAN ID (VID), UM bit and the FlowID).
4. If L2Match is active, a read of the location specified by L2Index is performed. This location contains the FlowID and UM fields that determine the output port(s) for the frame.
5. A read of Next Hop Information table when specified by a Redirect or Session Control Classification entry (FCNHInfo entry) is the last read operation from external Next Hop SRAM. This read retrieves information session information including the layer-2 headers (DMAC and VID) associated with the next hop and the Unknown/Multicast control bit (UM) and FlowID (FlowID) that specify the output port. The new IP and transport headers (SIPIndex, DIP, SP, DP) are read from NH SRAM and are used for Session Control entries that specify modification of these headers. The SIPIndex is used to look up the Source IP address from the SIPAddr table. For a Layer-3 forwarded frame, the Source MAC address (SMAC) is read from the VLAN Information Table.

Once the headers and control information are obtained from the Next Hop SRAM, the Policing, DiffServ and Statistics processing are performed based on the FlowID information. The final step of Next Hop Processing consists of reading segments from the FIFO 425 to modify frame headers before sending frame segments to the output block 470.

If a frame segment contains a SOP, the parameters read from the Next Hop external memory are used to replace the Layer-2 headers for Layer-3 forwarding. For Layer-4 forwarding, the Source and/or Destination IP addresses and Source and Destination Ports may optionally be replaced. The TTL and Header Checksum fields for the IP frame are also replaced for Layer-3 forwarding and the UDP and TCP checksums are modified for header translation. On a SOP, the control headers are also stored in an internal memory for the port and are used until the next start of packet. For frame segments where the SOP signal is not active, the control headers are added from the data stored in internal memory, but the segment data is left unchanged.

DiffServ Processing and Policing

The Policing function implements a Leaky Bucket algorithm for monitoring flows and restricting their rates. Each of the 1024 policers requires an average bit rate and a burst length as input parameters, and based on these parameters the policer either marks or discards frames that do not conform to a predetermined profile. The Police ID for a frame is obtained either from a DiffServ Table or from the Classification entry table.

The Police ID is obtained from the DiffServ Table if there is no Police ID obtained through a Flow Classification match. The DiffServ-based policing table uses a concatenation of the Trunk Port ID and the DiffServ Code Point in the frame header as an index into this table. The Table contains a Police ID used as the policer for these frames, a probability value that specifies whether the frame should be marked, and a Priority to replace the 802.1p priority field.

Several registers and internal memories control the policing operation. The Police status and control register, Global Scale register, Queue length RAM, Rate RAM, and Threshold RAM control the basic operation of the policer. A Statistics RAM counts the number of marked (or dropped) frames for a given Police ID.

The Global Scale register is a 16-bit register that contains the value for the delay to start a new cycle of the decrement process following the completion of a complete cycle through all the police IDs. Setting the Global Scale register to a value other than 0 increases the maximum rate that can be policed, with a corresponding loss in the granularity of the policed rates.

The Queue Length RAM tracks the Queue Length for each Police ID. The Queue Length for a policer index is decremented based on the corresponding rate values in the Rate RAM.

The Rate RAM table contains a 16-bit rate field. Setting the rate field to 0 prevents the decrementing of the Queue Length counter. The Rate field specifies the value by which the Queue Length counter is decremented on a periodic interval specified by the Global Scale counter. The rate value is given in 32-bit words.

The Threshold RAM table contains the threshold that, when reached by the Queue Length Counter for the same Police ID on a Start of Packet, causes an incoming packet to be marked or dropped and the statistics counter can be incremented. In addition, the Threshold RAM table contains mode bits that specify when marking/dropping is enabled, when statistics counting is enabled and whether the mode is drop or mark.

Session Processing

Session processing consists of features that are required to perform Network Address Translation and Port Address Translation (NAT/PAT), Load Balancing, Session Monitoring and Statistics collection. The 2 primary hardware functions for session monitoring are:
Header Field Replacement; and
RTP monitoring and Statistics.
   Header Field Replacement

Session processing for functions such as NAT, PAT and Server Load Balancing require the replacement of Source and Destination IP address and/or the Source and Destination Ports. The functions to replace the source and destination ports are the same for Transmission Control Protocol (TCP) or User Datagram Protocol (UDP), except for the location of the header checksums. Replacement of the appropriate header fields is based on the type of session processing that is required for a particular flow.

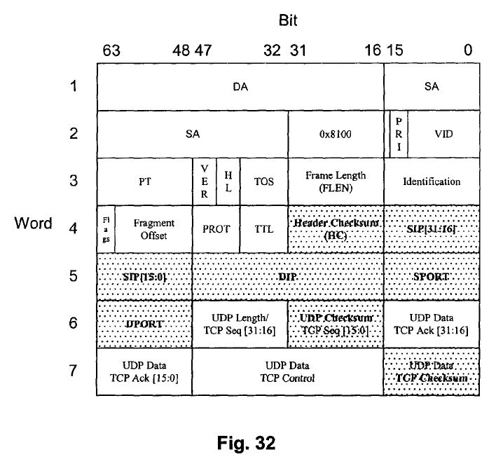

Based on the Control Fields in the Session Control type of Classification entry, the fields to be replaced and their positions in the Ethernet Frame Header are shown in FIG. 32.

The Source IP Address (SIP) is obtained from the Source IP address RAM using the Source IP Index (stored in the Info Table in NH SRAM) as the address into the RAM. The Destination IP (DIP), Source Port (SPORT), Destination Port (DPORT) fields are obtained directly from NH SRAM. The IP, TCP and UDP header checksums are calculated using an incremental header checksum algorithm. TCP and UDP header checksums use a pseudo header that includes the Source and Destination IP addresses. Thus, when replacing only these fields, the UDP and TCP checksum must still be recalculated.

The incremental header checksum recalculation algorithm is shown below. Note that the checksum calculations for the IP, TCP and UDP case use one's complement arithmetic, are performed on 16-bit words, and are identical.

1. IP Checksum

The incremental IP Checksum calculation is performed for a packet that is routed (TTL decremented, DSCP Marking) or when the IP address or transport ports are updated. Given x, the original field value, and x′, the updated field values, the updated checksums are calculated as:
HC′=HC−˜TTL−TTL′−˜TOS−TOS′−˜DIP−DIP′−˜SIP−SIP′ (1)

2. TCP and UDP Checksum
TC′=TC−˜DIP−DIP′−˜SIP−SIP′−˜DPORT−DPORT′−˜SPORT−SPORT′ (2)

Note that the formulae as written above are logical representations with respect to the header fields that may be replaced. However, the calculations are performed on the appropriate 16-bit words in the header that contain the fields to be replaced.

Session Monitoring

The goal of the session monitoring functions is to provide an accurate representation of Voice over IP call quality. Session monitoring typically keeps track of one or more of the following parameters of an RTP session (as defined by a classification match): jitter, number of frames lost, and the number of bytes accumulated for any flow that is to be monitored, as specified in the classification entry. The session monitoring functions are designed such that only RTP over UDP over IP flows are monitored, as flows over TCP can have retransmitted packets which lead to incorrect jitter and lost packet counts.

1. Jitter

The jitter calculation relies on the timestamps in the RTP frames and the expected rate of generation of frames from the RTP source. The rate for the source is given by the RTP profile, either as specified by the appropriate RFC or by mutual agreement. The rate for the source is expressed in the payload profile as the samples per second generated by a source. Since each source sample is normally packetized and transmitted in a separate RTP frame, the arrival time of the frame and the timestamp contained in the frame can be used jointly to determine the jitter caused by network transmission.

Table 2 provides definitions for jitter calculations:

TABLE 2

| | |
|---|---|
| R | Source Rate (in samples per 2¹⁸ Clock ticks) |
| TS(i) | 32-bit Timestamp contained in RTP frame i |
| C(i) | 32-bit Clock value on arrival of RTP frame i |

The transit delay for frame i in timestamp units is computed as:
Transit(i)=R*C(i)−TS(i) (3)
The cumulative jitter computed at the time of arrival of frame i is calculated as:
Jitter(i)+=(|Transit(i)−Transit(i−1)|−Jitter(i−1))/16 (4)
For ease of storage and for greater accuracy, equation (43) is rewritten as:
16*Jitter(i)=16*Jitter(i−1)+(|Transit(i)−Transit(i−1)|16*Jitter(i−1)/16) (5)

The following example highlights the operation of the jitter monitoring function. The parameter R is specified for each payload type (7-bits) in an RTP frame. For the case of a voice coder, a common value of the source rate is 8000 samples per second or, assuming a Clock tick of 4 microseconds, R is 8388 (20C4h). Assume that C(1) is FF000000h, i.e., the clock value at the time of arrival of the first frame in the flow, and that the Timestamp contained in the first frame is 72h. Then following values are computed and stored:
R*C(1)−TS(1)=(20C4h×FF000000h)>>18−72h=828CE8Eh (6)
Jitter=0; (7)

Note that for the first packet, the jitter must be set to 0, as the transit time for the previous frame is not known.

Assume the next packet arrives at a clock value of FF0003E8h and contains a time stamp value of 9Ah. Then the following values are computed and stored:
R*C(2)−TS(2)=(20C4h×FF0003E8h)>>18−9Ah=828CE85h (8)
16*Jitter=1828CE85−828CE8EI=9h (9)

Note that in performing these computations, the effect of clock time rollover and timestamp rollover should be taken into account. The current MSB of the clock can be compared with the MSB from the previous sample to determine if a rollover has taken place and to make the appropriate correction if this has occurred. A similar approach can be used for the timestamp value.

2. Lost Frames

In order to calculate the number of lost RTP frames, the RTP frame format provides a sequence number that can be used to determine whether a frame has been lost. In general, the RTP sequence number should increase by 1 for each frame generated by a source. However, it is possible that for some sources a source frame is split up (fragmented) into several RTP frames. In this case, the sequence numbers will not increase for successive RTP frames.

In order to compute the number of lost frames, the first step is to determine that a sequence of RTP frames has been found. The lost frame count process first checks to ensure that two in-sequence RTP frames are observed. The process then increments the lost count value, if the RTP sequence number of the current frame is not one higher than the stored value of the previous frame, by the difference between the current sequence number and the stored sequence number. If the difference in the number is greater than a predetermined threshold value, the count is not incremented, and it is assumed that the source reset the sequence number to a new value.

The current sequence number (16-bits) and the count of lost frames (24-bits) are stored for each session flow that is monitored. This count, combined with the packet and word statistics, determines a loss rate for the session.

Statistics

When the statistics enable bit is set in the Next Hop block status and control register, packet and byte counters for each FlowID are maintained. For session control classification entries, the statistics are kept on a per entry basis and not on a per-FlowID basis. This enables the determination of a more accurate picture of each session.

Next Hop Memory

The external NH SRAM is separated into multiple logical tables. The layout of this memory is shown in Table 3.

TABLE 3

| Bank Address | Bits | |
|---|---|---|
| 16K locations | 71:36 | 35:0 |
| 000 | NH Layer-2 and Layer-3 Information | |
| | (L2NHInfo, L3NHInfo) | |
| 001 | NH Flow Classification Information MSW | |
| | (FCNHInfo Word 1) | |
| 010 | NH Flow Classification Information LSW | |
| | (FCNHInfo Word 0) | |
| 011 | Total Session Bytes | Classification Info |
| | (SByteCount) | (CInfo) |
| 100 | Transit Time | Cumulative Jitter |
| | (STTime) | (SCJitter) |

| | | | |
|---|---|---|---|
| 101 | Sequence | Lost Packets | Total Packets |
| | Number | (SLostCount) | (SPktCount) |
| | (SSeqNum) | | |

| | | |
|---|---|---|
| 110 | Total Flow Bytes | Total Flow Packets |
| (Stat Bank 0) | (FByteCount) | (FPktCount) |
| 111 | Total Flow Bytes | Total Flow Packets |
| (Stat Bank 1) | (FByteCount) | (FPktCount) |

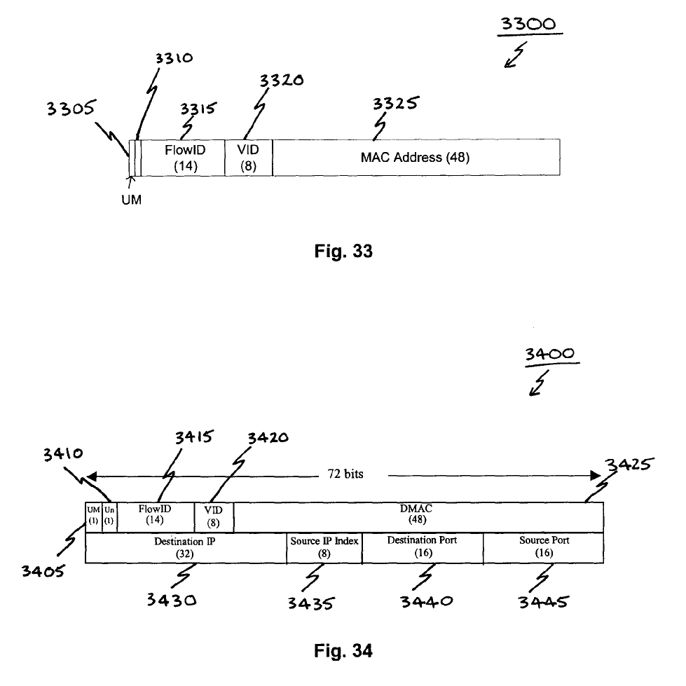

1. L2NHInfo and L3NHInfo Tables
The L2NHInfo and L3NHInfo tables are located in the first 16K locations of the 128K=72 bit Next Hop SRAM. FIG. 33 shows the format of entries in these tables. A sample entry 3300 includes: a UM field 3305 (1 bit), a spare field 3310 (1 bit), a FlowID 3315 (14 bits), q VID 3320 (8 bits), and a MAC Address 3325 (48 bits).

For Layer-2 forwarded frames, the FlowID 3315 and UM 3305 fields are used to determine the port(s) to which a frame should be forwarded. When a MAC address 3325 is learned (by the Learn process), the MAC address and VID are written to the L2Info field along with the FlowID. For Layer-3 forwarded frames, the MAC Address and VID specify the next hop MAC address and VLAN ID that replace the current destination MAC address and VID.

2. FCNHInfo Table

The FCNHInfo table is located in address locations from 16K (0x4000) to 48K-1 (0xBFFF) in the 128K×72 bit Next Hop SRAM. The table consists of 16K Info entries each 144 bits in size. The format of these entries is shown in FIG. 34. A sample entry 3400 includes: a UM field 3405 (1 bit), a Un field 3410 (1 bit), a FlowID 3415 (14 bits), a VID field 3420 (8 bits), a DMAC 3425 (48 bits), a Destination IP 3430 (32 bits), a Source IP Index 3435 (8 bits), a Destination Port 3440 (16 bits), and a Source Port 3445 (16 bits).

The FCNHInfo entries for session-based processing may perform a Layer-3 routing function without header replacement that requires a 48-bit Destination MAC address (DMAC) and an 8-bit VLAN ID (VID) that is also used to determine the Source MAC address for the output frame header. The Source IP (SIP) field is an index into a 256-entry Source IP address table (32-bits wide) that is used when the control bits of a Session Control entry in the Classification table specifies the replacement of the Source IP address in the frame header. Similarly, the Destination IP, Source Port and Destination Port fields are used when the control bits in a Session Control entry specifies a replacement operation for these fields.

3. Cinfo Table

The Classification Information Table (CInfo) occupies 16K locations beginning at address 0x000 (49152) in the NH SRAM. Each entry in the table is a 36-bit word occupying the LSBs of the 72-bit word in NH SRAM with a format as shown in Table 4.

TABLE 4

| | Entry Type | | | | | |
|---|---|---|---|---|---|---|
| | 35:33 | 32:28 | 27 | 26 | 25:16 | 15:0 |
| Permit with | 010 | Unused | ClPoEn | Unused | ClPoID | ClFlowID |
| QoS | | | | | | |
| Deny | 100 | Unused | | | | |
| Redirect | 110 | Unused | ClPoEn | Unused | ClPoID | ClNHID |
| Session Control | 111 | CTRL | ClPoEn | Unused | ClPoID | ClNHID |

The Classification entries can be of 4 types, as shown.

A Permit with QoS type entry is used to identify specific frames that are to be assigned to a given priority queue. For this operation, the CLFLOWID parameter is OR'ed with the FlowID obtained from the next hop entry. This allows the FlowID to be modified without affecting the next hop entry and parameters.

A Deny entry type specifies that the frame should be silently discarded; no parameters are required.

A Redirect entry contains a CLNHID field that specifies a Next Hop to be used that overrides the Next Hop specified by a Layer-2 or Layer-3 entry. The CLNHID specifies the address of the entry in the Next Hop Table that is used for obtaining Forwarding information.

A Session Control entry contains a CLNHID and a CTRL field as parameters. The CLNHID value specifies the address of the entry in the Next Hop Table that is used for obtaining Forwarding information. The CTRL field bits indicate the actions to be performed on the current frame, as defined in Table 5 below:

TABLE 5

| Bit Number | Bit Name | Description |
|---|---|---|
| 4 | MONITOR | Monitor Flow (Statistics and Error Rate) |
| 3 | REP_SP | Replace Source Port Field |
| 2 | REP_DP | Replace Destination Port Field |
| 1 | REP_SIP | Replace Source IP address Field |
| 0 | REP_DIP | Replace Destination IP address Field |

In addition to the operations described above, the Permit, Redirect and Session Control entries also contain an index to a policer associated with each entry. This index specifies the policer index assigned to the classification entry and can be used to restrict the rate of packet flows that are matched by a classification entry. The policer may be assigned on the basis of one of several variables: per FlowID, per Classification match or per DiffServ code point and input port.

4. Statistics Counters

The Statistics Counters for byte-based counts are 32-bit fields and the packet-based counters are 24-bit counters. The counters are stored in Banks 3 (SByteCnt), 5 (SPktCnt) and 6 (FByteCnt and FPktCnt) of the NH SRAM. The Flow-based counters (FByteCnt and FPktCnt) count the number of packets for all non-session based flows. If a monitored session control classification entry exists, the counts are maintained as Session counts (SByteCnt and SPktCnt).

5. Source IPAddress (SIP) Table

The Source IP Address table is a 256×32 bit table that stores the Source IP addresses that may be used to replace the incoming Source IP Address in a frame header. This table is accessed when an 8-bit index from the FCNHInfo field of the Next Hop SRAM is read due to a session control classification entry match. This index specifies the location in the table to be used when the Source IP Address is to be replaced. The format of entries in this table is shown in Table 6:

TABLE 6
31:0
Source IP Address

6. Differentiated Service Table

The DiffServ Table is a 4K×18 table that specifies the policing and flow control behavior for DiffServ flows. The 6 TOS bits from the IP header, priority, delay, throughput, and reliability fields, are concatenated with the 6-bit Input Port ID and are used as the index into the DiffServ table. The data entry in the table consists of four fields, a priority field, Pri, a probability, Prob, or rate field and the DiffServ Police ID (DSPoID) and a Police Enable bit as shown in Table 7. Note that the priority assigned by the table is distinct from the priority in the TOS header bits that are used as the index into the table, although with a suitable initialization, they could be made to match.

TABLE 7

Bits

| | 17 | 16:8 | 7:5 | 4:0 |
|---|---|---|---|---|
| Function | PoEn | DSPoId | Pri | Prob |

The DiffServ function is active only when the input packet is an IP packet and when the FlowID from the NextHop Forwarding is less than 64. The priority field contained in the entry is OR'd with the FlowID bit 8:6. The probability field is used to determine if the DiffServ Drop bit in the outgoing control header is set. If the probability set is 0, the DiffServ Drop bit is never set and if the probability field is 100% or higher, the DiffServ Drop is set all the time. Any number within this range is a percent probability that determines how likely the DiffServ Drop is to be set. The probability field is computed from a counter that increments from 0 to 99 every 8 cycles. Thus, for back-to-back packets, the probability field will actually be deterministic, but should still have the correct ratio of packets with the bit set.

The format of FlowID was selected based on the assumed fields in the FlowID of the default flows (flows that exist at switch initialization), as given in Table 8 below:

TABLE 8

| | Bits | | |
|---|---|---|---|
| | 13:9 | 8:6 | 5:0 |
| Function | 0 | Priority | Output Port |

In this embodiment, Table 8 is based on a software definition and the hardware is not restricted to this meaning, other than as discussed above with the enabling of the function based on bit 13:9 being zero.

When DiffServ is enabled, a Police ID, DSPoId is produced allowing traffic streams with the given TOS bits to be assigned to a policer. The Police Enable bit must be set to 1 to enable the Policer to respond to this PoID. Note that the Classification system can also produce a police ID, ClPoId, and it will take priority over a DSPoId.

The DiffServ table has 4096 entries consisting of 64 banks of 64 entries instead of just 64 entries total. The first bank corresponds to port 0, the second bank port 1, etc. The Police ID is 9 bits so the DiffServ entries can be mapped to any of the first 512 policers.

7. Queue Length RAM

The Queue Length RAM contains the 24-bit Qlen counters (QlenCtr) for each Police ID. A Police ID Address register (QlenPoIDAdr) is provided that controls the address for the next Qlen counter read. While this address register is RW by the CPU, the Qlen data register is RO (i.e. the Qlen counters cannot be set by CPU). The proper way to access a QlenCtr is to set the address of the counter in the QlenPoIDAdr register and wait until the QlenCntGotIt flag in the status register is set. The QlenData register then has the valid count. The QlenCntGotIt flag is cleared automatically by the hardware when the QlenPoIDAdr register is written to or when the QlenData register is read. It could take
Worst case delay=2*(GlblScale+1024+2)/(System Clock Rate) (10)
for the QlenCntGotIt flag to be set. Because of this read delay, QlenCtr access is primarily provided for testing and debugging purposes. The QlenCtr gives the number of words in the virtual “queue” where a word is 4 bytes.

8. Rate RAM

The rate table is a 1K×16 table that contains 16 rate bits for each Police ID. Setting the data to 0 will prevent the decrementing of the Qlen counter given by the current RatePoIdAdr. The Rate field specifies the value by which the QlenCtr is decremented by on a periodic interval specified by the GlblScale counter. The rate value is counted in words. The data format for the Rate RAM is given in Table 9 below.

TABLE 9

| | Bits |
|---|---|
| | 15:0 |
| Function | Rate |

9. Threshold RAM

The Threshold RAM is a 1K×18 table that contains the threshold value for each Police ID. When the QlenCtr reaches this value on a Start of Packet, the packet is marked or dropped and the statistics counter is incremented. In addition, the Threshold RAM table contains mode bits that specify when marking/dropping is enabled, when statistics counting is enabled, and whether the mode is drop or mark. The Threshold RAM format is given in Table 10.

The Drop bit sets the mode to Drop when 1, and sets the mode to Mark when 0. The PoStatEn enables the police statistics counting of the marked/dropped packets when 1, while the PoEn bit enables the marking/dropping of the packet. The “leaky bucket” continues to operate when this bit is set to 0. The threshold is a 15-bit value given in frame segments (16 32-bit words). The Qlen counter keeps track of the word count but the lower 4 bits do not enter into the comparison. A threshold value of 7fff will never mark or drop a packet. A threshold value of 0000 will always mark or drop the packet.

TABLE 10

Bits

| | 17 | 16 | 15 | 14:0 |
|---|---|---|---|---|
| Function | Drop | PoStatEn | PoEn | Threshold |

10. Statistics RAM

The Statistics table is a 1K×18 table that holds the count of the number of packets that were marked or dropped by the forwarding chip for each Police ID. Although the counts can be read at any time, clearing requires special care to avoid race conditions. There are two methods that could be used. In the first, a counter is cleared by writing 0 to that PoID and then reading the counter back to verify that the count was not overwritten by a packet increment function. This may require several tries if there is continuous marking on that particular PoID. In the second method, the PoStatEn bit is turned off for that PoID, the location cleared, and then the PoStatEn bit is set back to 1 again.
1. Set ThresPoIdAdr to the PoID
2. Set StatPoIdAdr to the PoID
3. Read ThresData register
4. Write ThresData register with the read data ANDed with 3ffff to turn off the PoStatEn bit
5. Write the StatData register with 0
6. Write ThresData register with the read data from step 3 to turn status for this PoID back on again

The data format for the Threshold RAM is provided in Table 11.

TABLE 11

| | Bits |
|---|---|
| | 17:0 |
| Function | MarkDropCount |

Next Hop Registers

1. Policing Control and Status Register (POCTLST)

The police block control and status register is split in half, with the upper 16-bit available for status bits while the lower 16 bits are for control bits. The upper bits and any padding bits in the lower half are read only and cannot be set. Table 12 summarizes the meaning of these bits.

TABLE 12

| | Bits | | | | | |
|---|---|---|---|---|---|---|
| | 16 | 4 | 3 | 2 | 1 | 0 |
| Function | QlenCntGotIt | GlblQlenClr | GlblPoCtrRstN | GlblStatWrEn | GlblQlenPktWrEn | GlblQlenDecWrEn |

The Queue Length Counter Got It Flag, QlenCntGotIt, is a read only bit used with reading the queue length counter. The Queue Length Counter Got It Flag is the Least Significant Bit (LSB) of the upper 16-bit status section of the register.

Starting with the LSBs of the control portion of the register, the Global Queue Length counter Decrement Write Enable bit, GlblQlenDecWrEn, controls the decrement rate process. GlblQlenDecWrEn must be set to 1 to “open the hole in the bottom of the leaky bucket”, otherwise the queue length counters will never decrement.

The Global Queue length Packet Write Enable bit, GlblQlenPktWrEn, controls the increment rate processes. GlblQlenPktWrEn should initially be set to 1 to allow arriving packets to increment the queue length counter by the word count. Setting GlblQlenPktWrEn to 0 is useful for testing and for clearing the counters.

The Global Statistics Write Enable bit, GlblStatWrEn, controls the writing of the statistics when a packet has been marked or dropped. GlblStatWrEn is normally 1, but can be set to 0 for testing or to avoid race conditions when clearing the statistics counters from the CPU. Drops or marks are not recorded while GlblStatWrEn is zero. This does not change the marking or dropping of the actual packets.

The Global Police Counter Reset bit, GlblPoCtrRstN, controls the police ID counter of the decrement process. Setting GlblPoCtrRstN to 0 holds the counter at zero, thus preventing the decrement process from operating and prevents the QlenGotIt status bit and the QlenData register from being loaded. This can be used to reset the counter for clearing the queue length counters. GlblPoCtrRstN should be set to 1 when policing traffic in normal operation.

The Global Queue length Clear bit, GlblQlenClr, controls the rate value in the decrement process. By setting GlblQlenClr to one, it is possible to force the rate to the maximum value. Clearing GlblQlenClr restores the rate stored in the rate table. Setting GlblQlenClr helps speed the clearing of the queue length counters.

2. Global Scale Register

The Global Scale register is a 16-bit register that contains a counter preload value. The counter counts in system clocks and delays the start of a new cycle of the decrement process following the completion of a complete cycle through the all the police IDs. For normal operation, the Global Scale register is set to 0 to obtain rates large enough for Gigabit Ethernet ports. The Global Scale register can be set to larger values to compensate for higher system clock rates or to increase resolution for low decrement rates possibly at the expense of dynamic range.

3. NH_Control_Reg

The NH_SCR register is the Status and Control Register for the Next Hop Processing block.

4. NH_SRAM_AReg

5. NH_SRAM_DReg2

6. NH_SRAM_DReg1

7. NH_SRAM_DReg0

The NH_SRAM_AReg, NH_SRAM_DReg0, NH_SRAM_DReg1 and NH_SRAM_DReg2 registers provide access to the external NH SRAM. The NH_SRAM_AReg register contains the 17-bit value that is used for the SRAM address. The NH_SRAM_AReg register is written first on a read or a write operation to external SRAM.

On a read operation, the NH_SRAM_DReg0 register contains the 32 LSBs of the 36-bit external NH SRAM. The NH_SRAM_DReg0 register should be read first (before reading NH_SRAM_DReg1 and NH_SRAM_DReg2), as this read triggers the action of retrieving data from external SRAM memory pointed to by NH_SRAM_AReg.

Once NH_SRAM_DReg0 is read, the NH_SRAM_DReg1 register contains the bits 63:32 of the NH SRAM and NH_SRAM_DReg2 contains bits 71:64. A write operation to external SRAM first requires a write of the 32 LSBs to NH_SRAM_DReg0, followed by a write of bits 63:32 to NH_SRAM_DReg1, and a write of the 8 MSBs to NH_SRAM_DReg2 that triggers the write to external SRAM.

8. NH_SIP_AdrReg

9. NH_SIP_DataReg

The NH_SIP AdrReg and NH_SIP_DataReg are the address and data registers that control access to the internal SIP Table SRAMs in the NH block. On a read or a write operation from Internal SRAM, the NH_SIP_AdrReg register is first written with the 8-bit address to be read. For a read operation, a read of the NH_SIP_DataReg register retrieves the 32-bit data from the SRAM. For a write operation, a write to the NH_SIP_DataReg register stores the 32-bit value into SRAM at the address of the address register.

Forwarding Chip—CPU Interface

Multicast and Output Processing

The final stage of processing for each segment is multicast processing. In this step, a frame segment is replicated to a set of output ports, if it is a multicast frame, mirrored frame or a Layer-2 unknown frame.

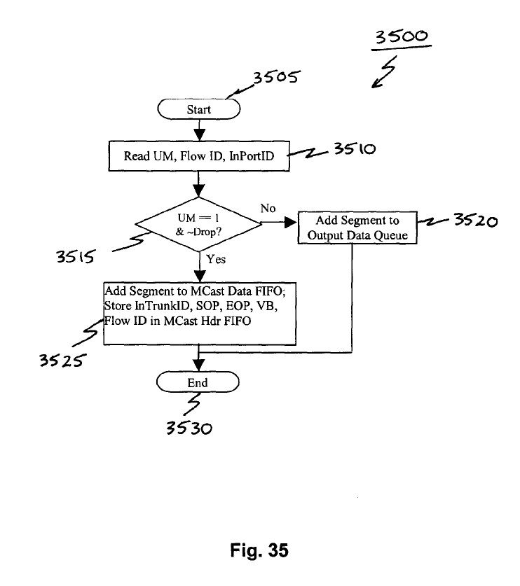

The initial multicast processing function is shown in FIG. 35. This initial processing determines whether an output frame segment is to be copied to the multicast queue. The setting of the UM bit that is output by the Next Hop Block indicates that the current segment is to be multicast.

FIG. 35 is a flow diagram of multicast output processing 3500. The process 3500 begins at a Start step 3505 and control proceeds to step 3510, which reads UM, FlowID, and InPort ID. Control proceeds from step 3510 to a decision step 3515, which determines whether the UM is equal to 1 and that Drop is not set. If Yes, control proceeds to step 3525, which adds a segment to multicast data FIFO queue, stores the InTrunkID, SOP, EOP, VB, FlowID in the multicast header FIFO. Control proceeds from 3525 to an End step 3530. If at decision step 3515 the answer is no, control proceeds to step 3520, which adds a segment to an output data queue. Control passes from step 3520 to the terminating step 3530.

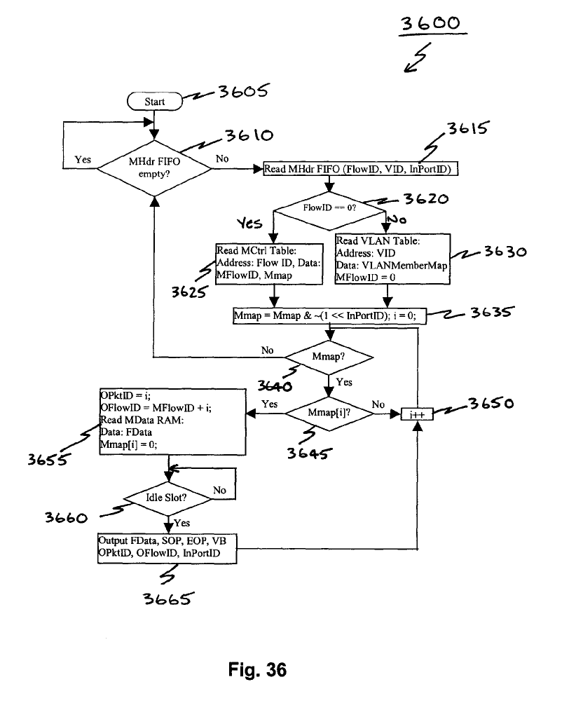

The multicast data queue processing function is shown in FIG. 36. The process examines the multicast header (MHdr) FIFO and when not empty, reads the header and prepares the output headers for the multicast operation by reading a Multicast Control (MCtrl) Table that specifies the mapping between the FlowID from the MHdr FIFO and the output ports for the frame.

The MCtrl table is read using the incoming FlowID as an index and the outputs of the table are the Base Multicast FlowID (MFlowID) and the Multicast Map (Mmap), which contains the ports to which to send the frame. For the case where the FlowID from the MHdr FIFO is 0 (unknown frame), the Mmap is set equal to VLANMemberMap from the VLAN Table and MFlowID is set to 0. The multicast output process then picks the first bit set in Mmap, calculates the output FlowID (OFlowID). On an idle slot, the multicast output process inserts the frame segment from the multicast data RAM and writes out the appropriate header using the values for the current frame segment. The multicast process then zeroes the bit in Mmap corresponding to the current port and calculates the next port to which the frame segment should be sent by looking for the next non-zero bit in Mmap. If Mmap is zero, the multicast output process looks for the next header in the MHdr FIFO.

FIG. 36 is a flow diagram of multicast queue processing 3600. The process 3600 begins at step 3605 and passes to a decision step 3610, which determines whether the Multicast Header FIFO is empty. If the Multicast Header FIFO is empty, Yes, control returns to step 3610. However, if at step 3610 the Multicast Header FIFO is not empty, No, control proceeds to step 3615, which reads the Multicast Header FIFO to obtain FlowID, VID, and InPport ID.

Control passes from step 3615 to step 3620, which determines whether the FlowID is equal to 0. If the FlowId is equal to 0, Yes, control passes to step 3625, which reads the control table, sets the address to the FlowID, and data is MflowID and Mmap. Control passes from step 3625 to step 3635, which sets the Mmap (Mmap=Mmap& ˜(1<<InPortID), and sets the index i equal to 0. Returning to step 3620, if the FlowID is not equal to 0, No, control passes to step 3630, which reads the VLAN table, sets the address to VID, and sets the data to VLANMemberMap and the MFlowID equal to 0. Control passes from step 3630 to step 3635.

From step 3635, control passes to a decision step 3640, which determines whether there is an Mmap. If there is no Mmap, control passes to the decision step 3610. However, if at step 3640 there is an Mmap, Yes, control passes to another decision 3645. Step 3645 determines whether there is an entry in Mmap for the current index i. If there is no entry, No, control passes to step 3650, which increments the index i and passes control to step 3640. However, if at step 3645 there is an entry at Mmap at index i, Yes, control passes to step 3655. Step 3655 passes control to decision step 3660, which determines whether there is an idle slot. If there is no idle slot, control returns to step 3660 until there is an idle slot available. If there is an idle slot available at step 3660, Yes, control passes to step 3665 which outputs FData, SOP, EOP, VB, OPktID, OFLowID, and InPortID. Control passes from step 3665 to step 3650 to increment the counter and continue the process.

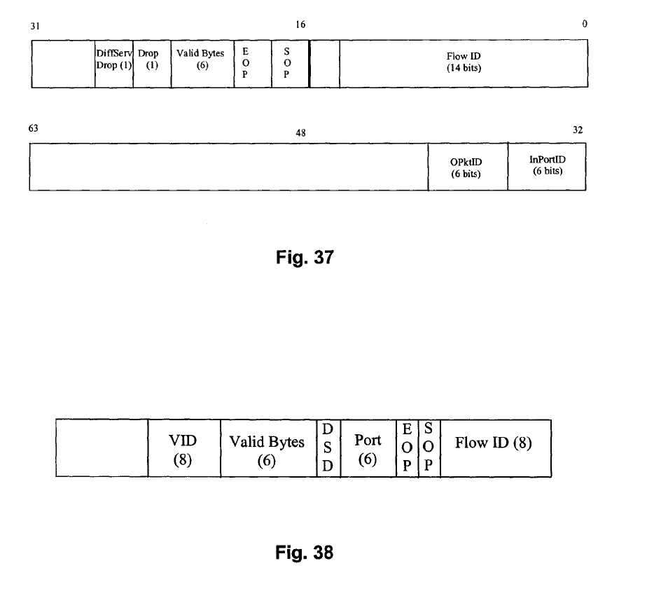

Every 64-byte segment of a frame transferred to the buffering and queuing sections of the device has an associated 64-bit Control header that is transmitted on the Header Bus. This Control header consists of the FlowID, Start of Packet and End of Packet indication, the number of valid bytes in the segment, two drop indications indicating whether an unconditional drop or a drop based on queue lengths that will cause the frame to be discarded, and the Input Port ID and an Output Packet ID for multicast frames. The format of the Control Header is shown in FIG. 37.

Memory

1. Multicast Header FIFO

The Multicast Header (MHdr) FIFO stores control information for frame segments that have the Unknown/Multicast Bit set in the control header from the Next Hop Block. The MHdr FIFO is 512 entries deep and 36 bits wide. The format of entries in the MHdr FIFO is shown in FIG. 38.

2. Multicast Data RAM

The multicast data RAM is a 1024×64 bit memory that stores the multicast frame segment data during the replication process for these segments. The Multicast Data RAM can buffer up to 16 frame segments for processing.

3. Multicast Control RAM

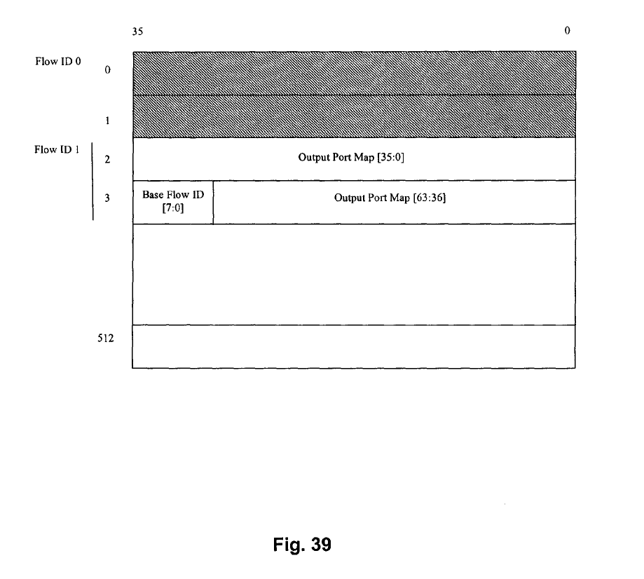

The Multicast control RAM is 512×36 Block RAM that contains the mapping between the 8-bit FlowID and the output Base FlowID and the output ports for the multicast frame segment. The format of entries in the multicast control RAM is shown in FIG. 39.

Queuing Chip

FIG. 5 is a schematic block diagram representation of the Queuing chip 170 of FIG. 1. As described above, the Queuing chip 170 receives processed traffic from the Forwarding chip 150 and the expansion/processor interface 160. In the embodiment described concerning VoIP, the Queuing chip 170 identifies voice traffic from other general traffic and further prioritizes the voice traffic over other general traffic.

The Queuing chip 170 receives processed traffic at a receive module 525 via a DDR input bus 510. The receive module 525 presents the traffic to a buffer manager 540. The buffer manager 540 is connected to a BM SRAM interface 530 and a Queue Manager 545. The buffer manager 540 presents an output to a memory controller 565. The memory controller 565 is connected to a FCRAM interface 575, and presents an output to a transmit demultiplexer (XMTDEMUX) module 580. The output of the demultiplexer 580 is presented to a transmit module 590. The transmit module 590 presents the output to a DDR output bus 595.

The Queue Manager 545 connects to each of a QM SRAM Interface 555 and a Scheduler 560. The Scheduler in turn connects to the transmit module 590. the QM SRAM Interface connects to an external bus 555.

The XMTDEMUX module 580 connected to a Local Bus Rx DMA 520, which in turn connects to a CPU Interface 515. The CPU Interface handles communications between the Queuing Chip 170 and a CPU via a PLX local bus 505.

Queuing Chip—Overview

Buffering, queuing and scheduling functions are performed by the QCHIP 170. The buffering and queuing process uses a 64-bit Q header, which is prepended by the Forwarding Chip 150 to each frame segment, to extract control information for processing the segment. This control information includes the FlowID for the queue, the start of frame and end of frame flags, the number of valid bytes in the segment, a drop flag, a mark flag and the input and output port ID for the segment.

The Buffer Manager 540 implements the reassembly of frames from frame segments received from the Forwarding Chip 150 and implements the logical structures (buffer link lists) associated with frame buffering. The Memory Controller 565 implements the read and writes of the frame segments to FCRAM memory. The Queue Manager 545 implements flow queue creation and management algorithms. The QCHIP 170 is also responsible for interfacing with the local bus for the purpose of transferring Ethernet frames from and to the external interfaces. The Local Bus Interface 520 implements Receive DMA functions for efficient frame transfers from the switching subsystem to the processor subsystem through the PLX PCI device 505.

Each frame segment is copied into FCRAM memory and a logical linked list of frame segments is formed for each packet. If a packet is received in error, the frame is discarded and is not queued. When a packet has been completely received without errors, the Queue Manager adds the packet to the tail of the flow queue. Frames in each Flow queue may be assigned to any output port with a given class and subclass assignment and low and high queue length threshold. When a flow becomes active (i.e., has a queued packet), the flow is added to a list of flows that are to be serviced for the current port. Control of the queuing process is transferred to the Scheduler.

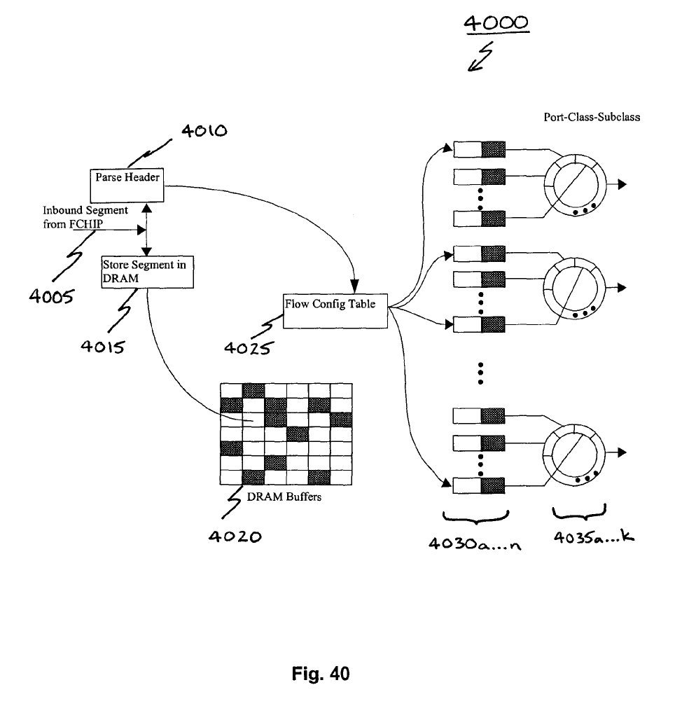

A pictorial description of the buffering and queuing process 4000 for frame segments is shown in FIG. 40. An inbound segment 4005 from the FCHIP 150 is received and presented to each of steps 4010 and 4015. Step 4015 stores the inbound segment 4005 in a DRAM buffer 4020. Step 4010 parses the header and forwards the inbound segment to a Flow Config Table 4025. The Flow Config Table 4025 assigns an output flow to one of an array of ports 4030a . . . n. Each of the ports 4030a . . . n is assigned to one of an array of Port-Class-Subclasses 4035a . . . k.

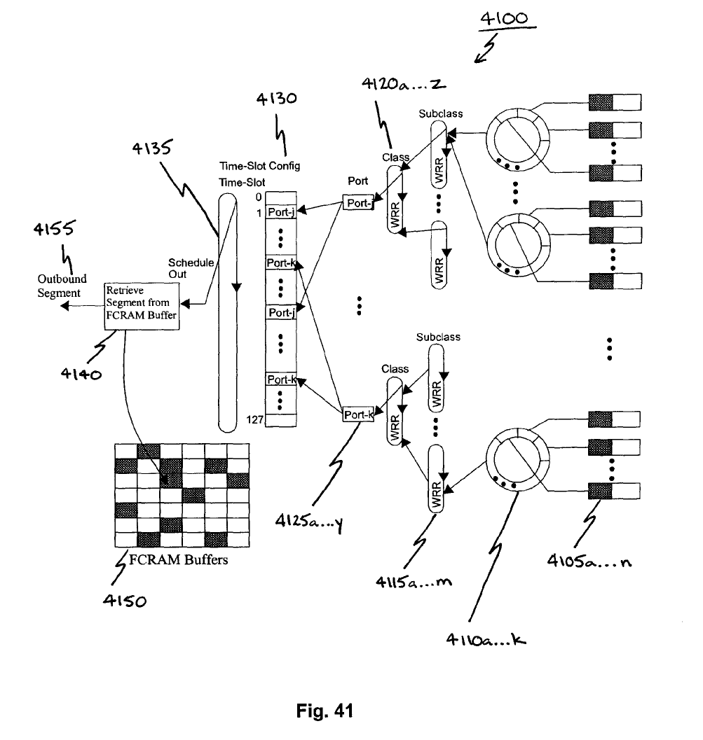

FIG. 41 shows a pictorial depiction of an outbound queuing process 4100 and the role of the scheduler. The Scheduler is instrumental in serving packets in the correct order once a flow becomes active. The scheduler performs a hierarchical weighted round robin function among the flows based on the classes and subclasses on a port. A time slot configuration register performs the assignment of bandwidth to ports and the Scheduler performs the assignment of bandwidth between flows on a port.

A number of packets 4105a . . . n are presented to a number of ring buffers 4110a . . . k. The ring buffers 4110a . . . k present packets after buffering to one of an array of subclasses 4115a . . . m. The subclasses 4115a . . . m are then sorted into one of the classes 4120a . . . z. The classes 4120a . . . z present respective packets to one of a number of ports 4125a . . . y. Packets from the ports 4125a . . . y are then presented to a scheduler 4135, which allocates a timeslot to the packets from the respective ports 4125a . . . y. The output from the scheduler 4135 is presented to a retrieve module 4140 that retrieves a segment from a FCRAM buffer 4150. The retrieve module 4140 then presents an output segment 4155.

Queuing Chip—Interfaces

Buffer Manager

Functional Overview

The Buffer Manager is responsible for: (1) managing the free buffer linked list; (2) allocating buffer IDs (BIDs) for enqueuing operations; (3) dropping frames with the drop flag set in the Q Header; (4) adding BIDs of dequeued frames to the free buffer linked list; and (5) creating a linked list of BIDs to compose an Ethernet frame before forwarding the head and tail pointers of the frame to the Queue Manager on an end of frame (EOF) header flag.

The Buffer Manager interfaces with the: (1) Receive interface, (2) Queue Manager, and (3) FCRAM controller to perform the following functions:
1. At initialization, the Buffer Manager creates a free buffer link list that places all BIDs in free buffer memory.
2. For an Enqueue operation, the Buffer Manager allocates a new BID from the free buffer link list and writes the BID value (with the write operation bit set) into the FCRAM controller command FIFO. The Buffer Manager updates the Input-Output Tail BID (IOH) table (and the Input-Output Head BID (IOT) on a SOP) with the new BID and writes the new BID value to the memory location of the previous tail BID value thereby linking the new BID to any previous frame segments.
3. On an EOP, the Buffer Manager reads the contents of the IOH and IOT tables for the current input-output combination and forwards this information to the Queue Manager.
4. On a Drop operation, the Buffer Manager frees the entire frame by adding the head BID to the tail of the free list
5. On a Dequeue operation, the Buffer Manager writes the BID value with the read operation bit set into the FCRAM command FIFO. The Buffer Manager then adds the dequeued BID to the tail of the free buffer link list.
6. On an Add BID operation, the Buffer Manager writes the NextBID value and the associated flags to the CurrentBID location in external SRAM.

Data Structures

1. Free Buffer Linked List and Per-flow Queuing Linked List

To provide management for per-flow queues and for a free buffer linked list, logical queues are formed in Buffer Manager SRAM where each queue corresponds to a flow queue or to the Free Buffer linked list. Each of the logical queues consists of, in FIFO order, a linked list of the addresses (i.e., BIDs) of the buffers in FCRAM.

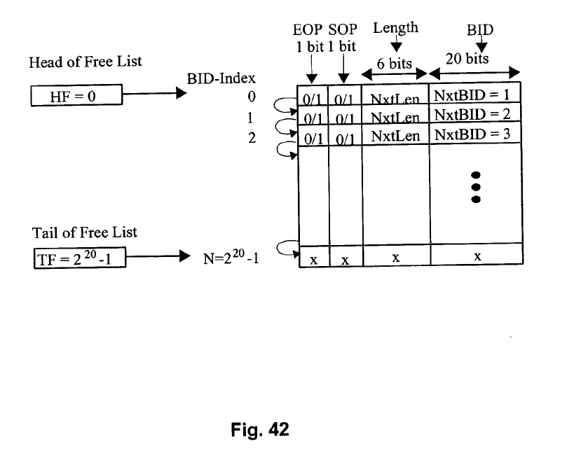

The data structure of the free list for the buffers is used to implement the per-flow queues. Each record of the BID free list consists of a next BID field storing the BID of the next record in the linked list, a 1-bit End of Packet (EOP), a 1-bit Start of Packet (SOP) field to indicate whether the next BID is associated with a start/end of packet and a 6-bit Length field (which specifies the number of valid octets in a 64 byte packet segment). The conceptual layout of the BID free list is shown in FIG. 42.

The BID is removed from the head of the free list and eventually inserted into the corresponding per-flow queue linked list. The implementation of per-flow queuing linked list is denoted as flow_BIDList[BID]={NxtEOP, NxtSOP, NxtLen, NxtBID}. For this reason, the SDRAM address pointing to a cell buffer is referred to as the Buffer Identifier (BID) and the free list of cell buffers is referred to as the cell buffer list. The Queue Manager accesses (i.e., writes or reads) the per-flow linked lists through the Buffer Manager.

Registers and Tables

Input-Output Head (IOH) and Tail (IOT) Tables

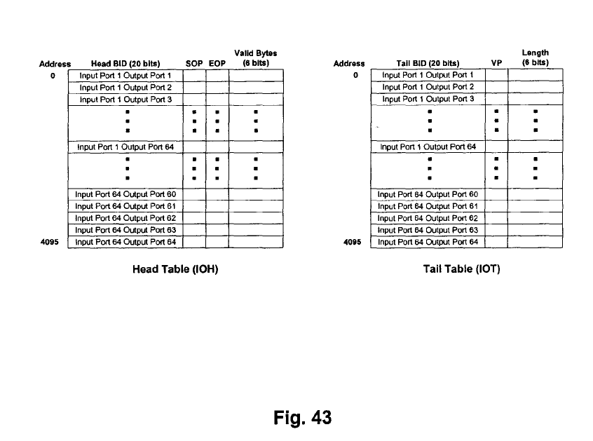

The Input-Output Head and Tail Tables contain the head and tail BID values for frames switched between any input and output port combination. Since at any instant there can be at most 4096 input-output port pairs (64 input ports to 64 output ports), the table depth is 4096. The table formats are shown in FIG. 43.

The Start of Packet (SOP), End of Packet (EOP) and Valid Bytes (VB) values for the first segment in a frame must be kept in the Head BID table, because these values are only written into flow queue memory when an end of frame is received. The Tail BID memory contains the tail pointer table and the segment length count for the frame and the valid packet (VP) control bit that indicates if a packet is currently being processes for a given input-output port combination.

Free Head (FH) Register

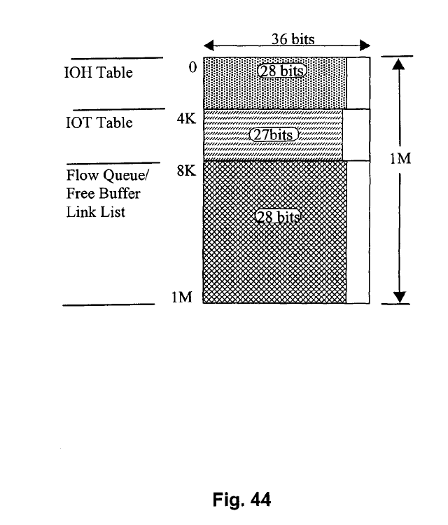

The Free Head Register contains the value of the head pointer to the Free Buffer table in external SRAM memory. The Free Head register value is used to allocate memory for an incoming frame segment and is updated by reading the next element in the Free Buffer link list from external SRAM. The Free Head register is shown in FIG. 44.

Free Tail (FT) Register

The Free Tail Register contains the value of the tail pointer to the Free Buffer table in external SRAM memory. The Free Tail register value is used when adding previously allocated memory locations back to the Free Buffer list (for example, after a dequeue operation or after a drop operation). The Free Tail register is shown in FIG. 44.

Buffer Manager SRAM Memory Mapping

The Buffer Manager (BM) SRAM memory map is based on a 1M×36 SRAM memory. 2 512K×36 SRAM modules may be used to form the 1M×36 memory. The memory map arrangement is shown in FIG. 57.

Functional Specification

The functional design of the Buffer Manager is presented by a set of pseudo codes in Table 13 below. The pseudo codes provide the functional description for enqueuing and dequeuing operations performed by the Buffer Manager.

TABLE 13

| | Enqueue/ | |
|---|---|---|
| Operation | Dequeue | Function |
| Start | Enqueue | Read_RCVMUX(XFP, XDV, XID [11:0], XSOP, XEOP, XVB [5:0], |
| Enqueue | | XDROP, XFID[13:0], XMARK) |
| Read Tail | Enqueue | Read SRAM: Address: XID + 4096, Data: IDT [19:0], IDV, IDCT |
| | | [5:0] |
| Read Head | Enqueue | Read SRAM: Address: XID, Data: IDH [19:0], IDSOP, IDEOP, |
| | | IDVB [5:0] |
| Enqueue | Enqueue | If (XDROP \|\| (IDV == 1 && XSOP) \|\| (IDV == 0 && !XSOP)) |
| Segment | | Then DROP = 1 |
| | | Else If (IDV == 0 && !XEOP) Then { |
| | | Write SRAM: Address: IOID, Data: FH [19:0], XSOP, XEOP, |
| | | XVB[5:0] |
| | | Write SRAM: Address: IOID + 4096, Data: FH [19:0],1, 1 |
| | | Write_MC (FH [19:0], Enqueue) } |
| | | Else If (IDV == 1 && !XEOP) { |
| | | Write SRAM: Address: IDT[19:0], Data: FH [19:0] |
| | | Write SRAM: Address: IOID + 4096, Data: FH [19:0],1, IDCT+1 |
| | | BM_ENQBID = FH [19:0] |
| | | Write_MC (BM_ENQ, BM_ENQBID[19:0]) } |
| EOP | Enqueue | If (XEOP && !DROP) |
| Segment | | Then { BM_HD=IDH, |
| | | BM_TL=FH,BM_SOP=IDSOP,BM_EOP=IDEOP, BM_VB=IDVB, |
| | | BM_CT=IDCT[5.0]+1, BM_MARK=XMARK, BM_FID=XFID |
| | | Write_QM(BM_PKT, BM_HD, BM_TL, BM_SOP, BM_EOP, |
| | | BM_VB, BM_CT, BM_MARK, BM_FID) } |
| | | Else Write SRAM: Address: FT, Data: IDH[19:0], FT = IDT[19:0] |
| Read next | Enqueue | Read SRAM: Address: FH [19:0], Data: NFH [19:0] |
| BID from | | FH = NFH [19:0] |
| Free List | | |
| Update Flow | Enqueue | If (QM_DROP) |
| Queue/Free | | Then Write SRAM: Address: FT, Data: QM_EH[19:0], FT = |
| List (from | | QM_ET[19:0] |
| QM) | | Else Write SRAM: Address: QM_ET, Data: QM_EH[19:0] |
| Get Next | Dequeue | Read SRAM: Address: QM_DH, |
| BID, Free | | Data: BM_NDH [19:0], BM_NDSOP, BM_NDEOP, |
| Current | | BM_NDVB[5:0] |
| (from QM) | | Write SRAM: Address: FT, Data: QM_DH [19:0], FT = QM_DH |
| | | [19:0] |
| | | Write_QM (BM_NDH [19:0], BM_NDSOP, BM_NDEOP, |
| | | BM_NDVB[5:0]) |
| | | BM_DEQBID = QM_DH |
| | | Write_MC (BM_DEQ, BM_DEQBID[19:0]) |

Queue Manager

Functional Overview

The Queue Manager is responsible for: (1) managing the per-flow enqueuing and dequeuing of frames; (2) keeping track of backlogged flow queues (i.e., non-empty flow queues); and (3) forming per port-class-subclass based rings of backlogged flows.

The Queue Manager interfaces with: (1) the Scheduler; (2) the Buffer Manager; and (3) the SRAM Interfaces to perform the following functions:
1. The Queue Manager manages a linked-list data structure of flow queues for per-flow queuing before the flow queues are scheduled and sent to the appropriate ports;
2. On a new frame indication from the Buffer Manager, the Queue Manager checks the queue length of the PCS to determine if the frame can be added to the queue. To add the frame to the queue, the Queue Manager looks up the BID for the previous tail and instructs the Buffer Manager to add the packet Head BID to the tail. The status bits associated with the Head BID record are also stored; if necessary, the ring of backlogged flows (i.e., flows which contain entire packets) is updated for the appropriate port-class-subclass to which the flow has been assigned by the processor.
3. Upon request for dequeuing for a port-class-subclass from the Scheduler, the Queue Manager retrieves the record from the head of the flow queue that is at the head of the port-class-subclass ring of backlogged FlowIDs. A per-flow queue-length count is decremented;
4. The Queue Manager then updates the corresponding flow queue Head BID and the ring of backlogged FlowIDs for the port-class-subclass.

Registers and Tables

Head and Tail BID Table for Per-flow queuing

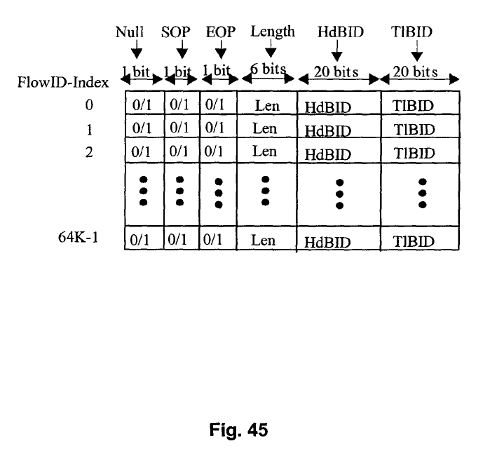

To keep track of the head and tail of each per-flow queue for the purpose of FIFO operation, the per-flow head and tail BID table (FlowHdTl) is implemented in Queue Manager SRAM. A conceptual data structure of such a table is illustrated in FIG. 45.

The Head and Tail BID table has 64K entries that are indexed by FlowIDs. Each entry consists of six fields: a Head BID field contains the BID value of the head of the corresponding flow queue, a Tail BID field contains the BID value of the tail of the corresponding flow queue, a Null field contains the status indicating whether the per-flow queue is empty, a SOP field indicating if the current cell is a Start of Packet, an EOP field indicating if the current cell is an End of Packet and a Length field indicating the valid bytes in the current segment.

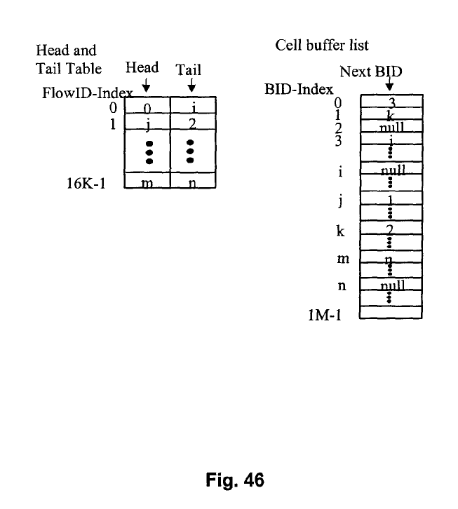

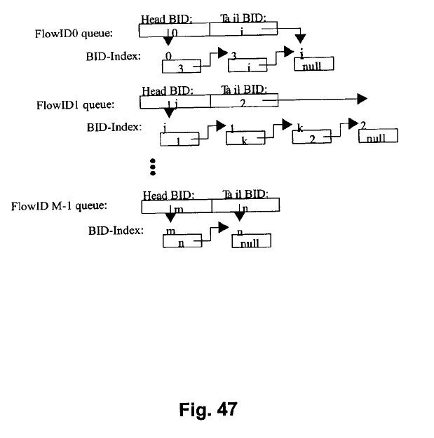

An example of how the head and tail BIDs of flow queues and the cell buffer linked list are used to implement the per-flow queues is shown in FIG. 46 and FIG. 47.

FIG. 46 shows an example set up of the Head and Tail BID Table entries and the corresponding flow queue linked list fields. FIG. 47 illustrates the linked list of the flow queues formed by the example set up shown in FIG. 46.

Per-Port-Class-SubClass Queue-Length Count

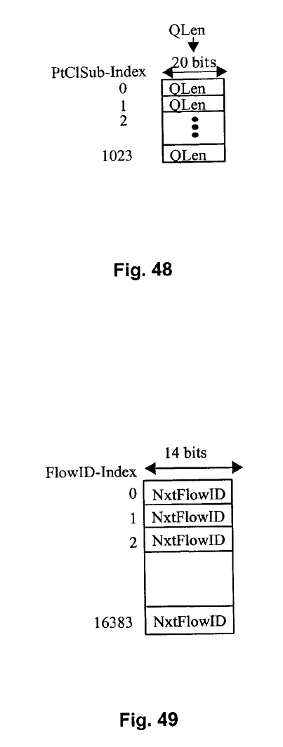

The Per-Port-Class-SubClass Count table (QCt) stores the queue length for each Port, Class, and SubClass. The format of the Per-Port-Class-SubClass Queue-Length table is shown FIG. 48.

Backlogged Flow Linked List

To facilitate scheduling of per-flow queues with packets enqueued (i.e., backlogged flow queues), port-class-subclass based backlogged FlowID linked lists are utilised in this embodiment. Each linked-list corresponds to a port-class-subclass and stores the FlowIDs that are set up to this port-class-subclass and have packets to be scheduled.

The data structure for the backlogged FlowID linked list is shown in FIG. 49. The backlogged FlowID linked list is denoted as BF[FlowID]={NxtFlowID} and is stored in the same 16K memory location address as the Head and Tail Pointer Table for the Flow.

Head and Tail FlowID Table for Backlogged Flow Linked List

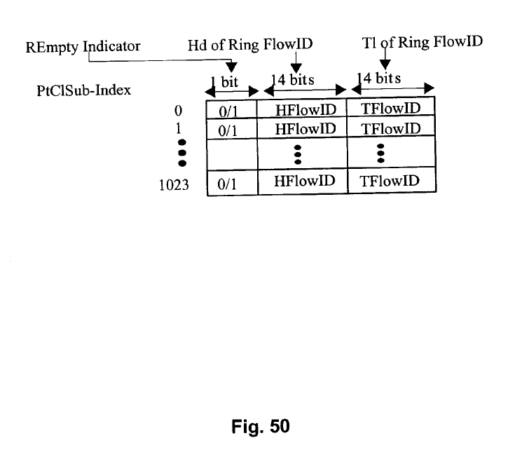

To manage the head and tail FlowID of the port-class-subclass based rings of backlogged FlowIDs, it is necessary to store the head and tail FlowID of the linked lists forming such rings in internal registers. For 64 line-card ports, 8 traffic classes, and 2 subclasses, the Head and Tail FlowID Table of port-class-subclass based rings of backlogged FlowIDs (BFHdTl) consists of 1K entries and is shown in FIG. 50.

The Head and Tail FlowID Table for Backlogged Flow Linked Lists is indexed by the 10-bit PtClSub formed by concatenating 6-bit PortID, 3-bit Class and 1-bit Subclass {PortID(6′b),Cl(3′b),Subcl(1′b)}.

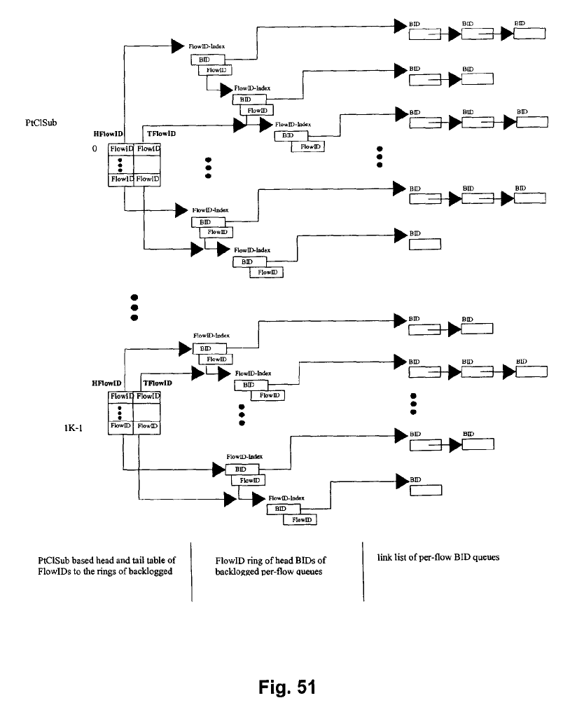

The most significant bit of each entry contains the Null indicator for the entry. An illustration of the data structure used to form the port-class-subclass based rings of backlogged FlowIDs is shown in FIG. 51.

Active Port Bitmap

The Active Port Bitmap (PtMap) is a 64-bit bitmap corresponding to each port. The Active Port Bitmap table is set up by the Queue Manager and is used by the Scheduler. Each bit in the bitmap specifies if the corresponding port is in the idle or active state. For the Queue Manager to schedule a new frame to a port, the port must be in the idle state.

Backlogged Port-Class Bitmap Table

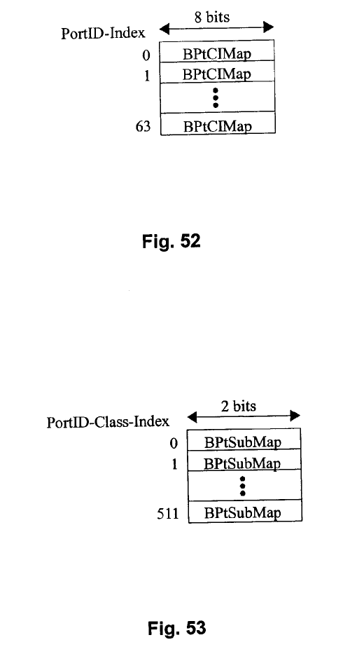

The Backlogged Port Class-BitMap (BPtClMap) table consists of 64 entries, corresponding to each of the 64 possible outbound ports. The Backlogged Port-Class Bitmap table is set up by the Queue Manager and used by the Scheduler. Each entry consists of an 8-bit wide bitmap corresponding to the 8 possible classes. Each control bit in the bitmap indicates whether the corresponding port-class has backlogged flow queues for scheduling. A conceptual illustration of the table is shown in FIG. 52.

The encoding of the BPtClMap is defined as follows:
0: the corresponding port-class does not have backlogged flow queue(s) for scheduling;
1: the corresponding port-class has backlogged flow queue(s) for scheduling.

The Queue Manager sets or resets the corresponding control bit for each port-class, indicating whether there is any backlogged flow queue(s) associated with the port-class. When scheduling a transfer for a port, the Scheduler requests a bitmap for a given PortID and uses the control bits in the table to assist in the scheduling decision for the port. If there is at least one class with the backlogged flow queue control bit set for a given port, the Scheduler uses the WRR algorithm to make a scheduling decision among the classes whose control bits are set.

Backlogged Port-Class Subclass Bitmap Table

The Backlogged Port-Class Subclass Bitmap (BPtSubMap) table consists of 512 entries corresponding to the 512 possible ports and classes. The Backlogged Port-Class Subclass Bitmap table is set up by the Queue Manager and used by the Scheduler. Each entry consists of a 2-bit wide bitmap corresponding to 2 possible subclasses. Each control bit in the bitmap indicates whether the corresponding port-class-subclass has backlogged flow queues for scheduling. A conceptual illustration of the table is shown in FIG. 53.

The encoding of the BPtSubMap is defined as follows:
0: the corresponding port-class-subclass does not have backlogged flow queue(s) for scheduling;
1: the corresponding port-class-subclass has backlogged flow queue(s) for scheduling.

The Queue Manager sets or resets the corresponding control bit for each port-class-subclass, indicating whether there is any backlogged flow queue(s) associated with the port-class-subclass. When scheduling a cell transfer for a port and class, the Scheduler requests a bitmap for a given PortID and Class, and uses the control bits in the table to assist in the scheduling decision for the port. The Scheduler uses the WRR algorithm to make a scheduling decision among the subclasses whose control bits are set.

Flow-Port-Class-Subclass Table

The Flow-Port-Class-Subclass Table is a management table that specifies the mapping between FlowID and Port-Class-Subclass. The Flow-Port-Class-Subclass table consists of 16K entries corresponding to each FlowID and contains the 10-bit Port-Class-Subclass field for the FlowID.

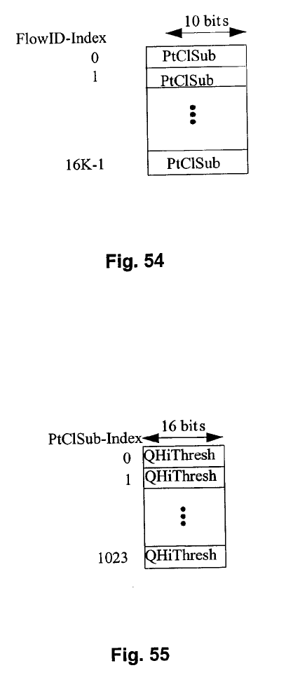

The Flow-Port-Class-Subclass table is shown in FIG. 54. Each entry in the Flow-Port-Class-Subclass table consists of the {Port(6′b), Class (3′b), Subclass (1′b)} for corresponding the FlowID.

Queue Length High Threshold

The Queue Length High Threshold (QHiThresh) Table is a management table, as shown in FIG. 55, that specifies the queue length for each Port-Class-SubClass at which packet dropping begins to occur.

The Queue Length High Threshold is 16 bits in length, hence the minimum allocation unit is 16 frame segments. The Queue Manager compares the Queue Length High Threshold with the current queue length to determine if packets for an incoming flow should be dropped.

Queue Length Low Threshold

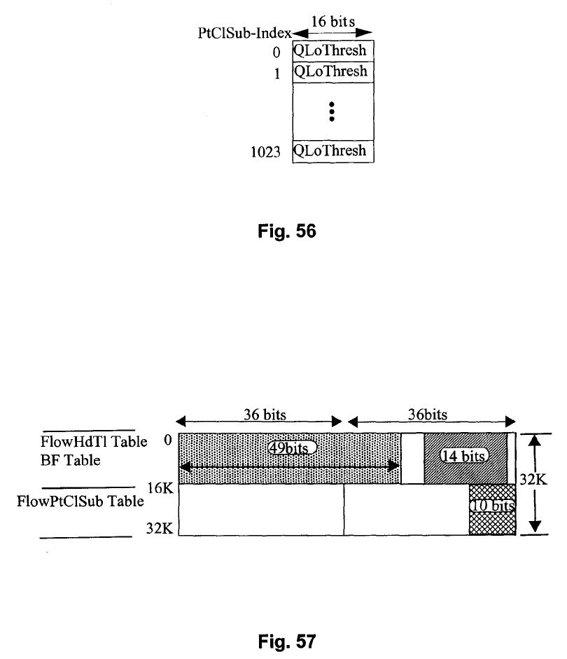

The Queue Length Low Threshold (QLoThresh) Table is a management table, as shown in FIG. 56, that specifies the queue length for each Port-Class-SubClass at which market packets are dropped.

The Queue Length Low Threshold is 16 bits in length, hence the minimum allocation unit is 16 frame segments. The Queue Manager compares the Queue Length Low Threshold value with the current queue length and if the Queue Length Low Threshold is exceeded and the DSD bit in the incoming frame header is set, the packet for the incoming flow is dropped.

Queue Manager SRAM Memory Mapping

The SRAM memory map is based on a 32K×72 SRAM memory. 2 128K×36 SRAM modules are arranged in parallel to form the 72-bit wide memory. The memory map arrangement is shown in FIG. 57.

Scheduler

Functional Overview

The Scheduler is responsible for scheduling an outbound transfer every 8-clock cycle.

1. The Scheduler maintains a Time Slot Configuration table which maps each of 512 time slots in a frame to outbound ports.
2. The Scheduler schedules an outbound frame segment transfer for a port by:
   a. Executing a Priority Queuing or Weighted Round Robin scheduling algorithm to determine a class among up to 8 classes with backlogged Flow queues; for the port and the class:
   b. The Scheduler executes a Priority Queuing or Weighted Round Robin scheduling algorithm to determine a subclass among up to 2 subclasses with backlogged Flow queues; for the port, class, and the subclass:
   c. The Scheduler executes a Round Robin algorithm to determine a Flow queue among all the backlogged Flow queues.
3. The scheduler then requests the frame segment record for the head of the Flow queue scheduled for the time slot from the Queue Manager to be dequeued.

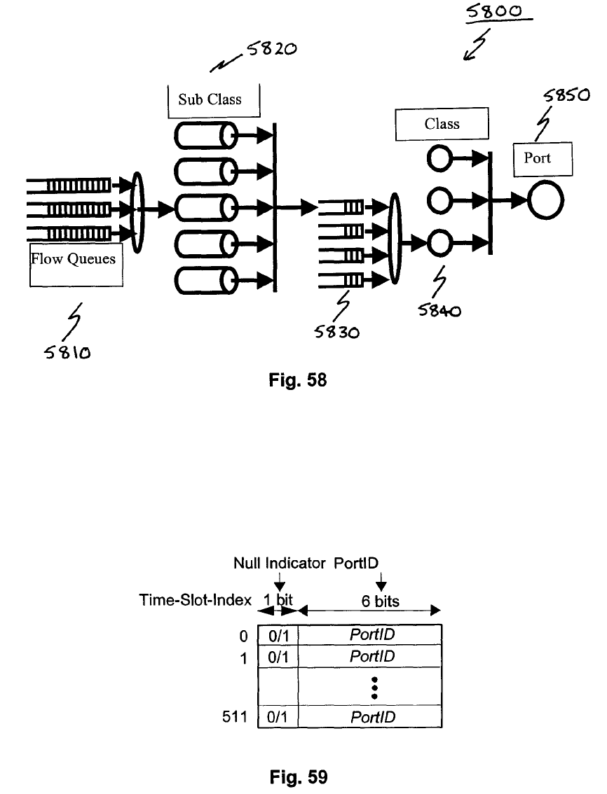

A pictorial view of the hierarchical modified weighted round robin implementation 5800 is shown in FIG. 58. A number of flow queues 5810 are sorted into sub-classes 5820. The sorted flow queues 5830 are then sorted into classes 5840, which are then scheduled for output to a port 5850. Further detail of the weighted round robin process is provided below.

Priority Queuing is implemented for Classes 0 and 1 and their corresponding sub classes with Class 1, Sub-Class 1 having the highest priority and Class 0 Sub-Class 0 having the lowest priority.

Registers and Tables

Time Slot Configuration Table

The Time Slot Configuration (TSConfig) table, shown in FIG. 59, maps a frame of 512 outbound time slots to outbound ports. The corresponding entries are set up when line-card ports are configured. The table consists of 512 entries, each indexed by a time slot in the range of 0˜511. An entry contains a PortID field to which the corresponding time slot is mapped.

The most significant bit of each entry contains a null indicator bit for the PortID. The most significant bit is encoded as:
0: the PortID of the entry is null, there is no port configured for the time slot;
1: the PortID of the entry is not null, there is port configured for the time slot.
   Previous Scheduled Time Slot Register

The Previous Scheduled Time Slot (PreSchTS) register consists of 8 bits and stores the index value of the previously time slot scheduled in the 512 time-slot frame. The Previous Scheduled Time Slot register is incremented by 1 before being used to determine a time slot to schedule.

Class Weight Table

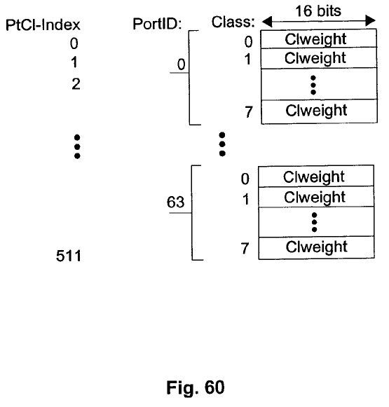

The Class Weight Table (ClWeight) consists of an entry for each port-class and stores the weight value for the Weighted Round Robin (WRR) scheduling algorithm among classes. A conceptual illustration of the table is shown in FIG. 60.

The Class Weight table is set up during switch operation for the Port IDs that have Flow set up or tear down. For a given port, the summation of weights across all the classes provides the size of the WRR scheduling window for the port. The ratio of the weight of a class to this summation provides the percentage of the port bandwidth that is guaranteed to the class.

Class WRR Count Table

The Class Weight Count (ClWeightCT) table consists of an entry for each port-class. The Class Weight Count table stores the WRR count value for the operation of the Weighted Round Robin scheduling algorithm among classes. A conceptual illustration is shown in FIG. 61.

The entries of the active port-classes are updated during the operation of the WRR scheduling algorithm.

WRR Eligible Port Class-BitMap Table

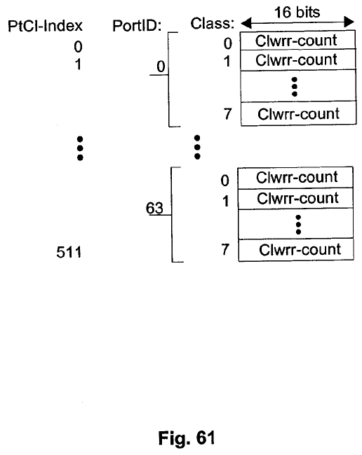

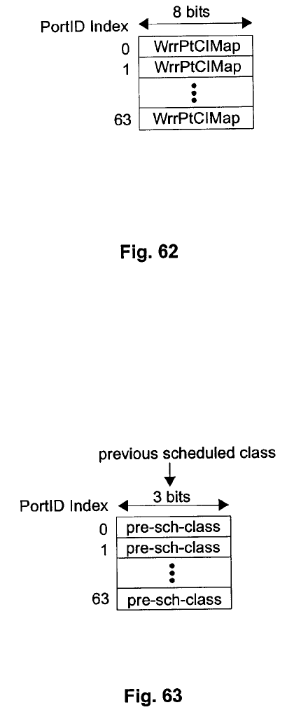

The WRR Eligible Port Class-BitMap (WrrPtClMap) table consists of 64 entries corresponding to 64 possible outbound ports. Each entry consists of an 8-bit wide bitmap corresponding to 8 possible classes. Each control bit in the bitmap indicates whether the corresponding port-class is eligible for being scheduled by the WRR algorithm. A conceptual illustration of the table is shown in FIG. 62.

The encoding of the WrrPtClMap is defined as follows:
0: the corresponding port-class is not eligible for WRR scheduling—the class WRR weight count for the port-class has reached the corresponding port-class weight;
1: the corresponding port-class is eligible for WRR scheduling—the class WRR weight count for the port-class has not reached the corresponding port-class weight.
   Previous Scheduled Class Table

The Previous Scheduled Class (PreSchCl) table consists of 64 entries; each entry corresponds to the class identifier that was previously scheduled by the WRR algorithm for that port. A conceptual illustration of the table is shown in FIG. 63. The WRR scheduling algorithm sets the entry of the corresponding port to the class the scheduling algorithm just scheduled for a transfer.

Subclass Weight Table

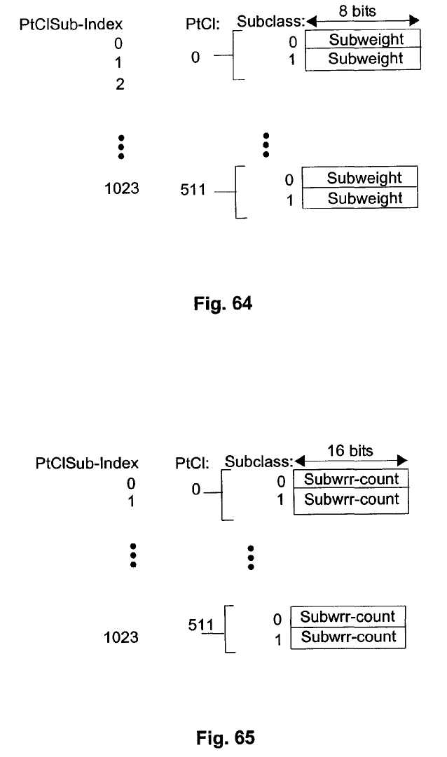

The Subclass Weight Table (SubWeight) consists of an entry for each port-class-subclass and stores the weight value for the Weighted Round Robin (WRR) scheduling algorithm among subclasses. A conceptual illustration of the table is shown in FIG. 64.

The Subclass Weight table is set up during switch operation for the PortID and Class that have Flow set up or tear down. For a given port and class, the summation of weights across all the subclasses provides the size of the WRR scheduling window for the port and class. The ratio of a weight of a subclass to this summation provides the percentage of the bandwidth of the port-class that is guaranteed to the subclass.

Subclass WRR Count Table

The Subclass Weight Count (SubWeightCT) table consists of an entry for each port-class-subclass. The Subclass Weight Count table stores the WRR count value for the operation of the Weighted Round Robin scheduling algorithm among subclasses. A conceptual illustration is shown in FIG. 65.

The entries of the active port-class-subclasses are updated during the operation of the WRR scheduling algorithm among subclasses.

WRR Eligible Port-Class Subclass-BitMap Table

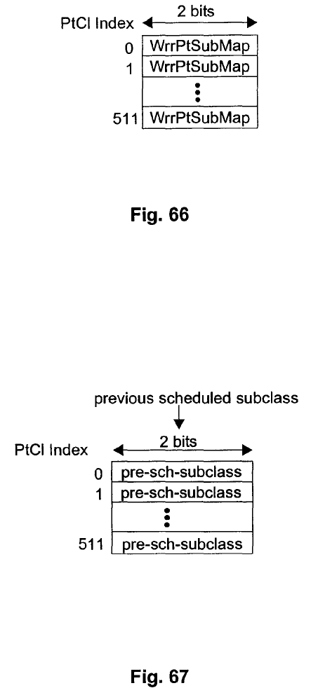

The WRR Eligible Port-Class Subclass-BitMap (WrrPtSubMap) table consists of 512 entries corresponding to 512 possible ports-classes. Each entry consists of a 2-bit wide bitmap corresponding to 2 possible subclasses. Each control bit in the bitmap indicates whether the corresponding port-class-subclass is eligible for being scheduled by the WRR algorithm. A conceptual illustration of the table is shown in FIG. 66.

The encoding of the WrrPtSubMap is defined as follows:
0: the corresponding port-class-subclass is not eligible for WRR scheduling—the subclass WRR weight count for the port-class-subclass has reached the corresponding port-class-subclass weight;
1: the corresponding port-class-subclass is eligible for WRR scheduling—the subclass WRR weight count for the port-class-subclass has not reached the corresponding port-class-subclass weight.
   Previous Scheduled Subclass Table

The Previous Scheduled Subclass (PreSchSub) table consists of 512 entries, each entry corresponds to the subclass identifier that was previously scheduled by the WRR algorithm for that port-class. A conceptual illustration of the table is shown in FIG. 67.

The WRR scheduling algorithm sets the entry of the corresponding port-class to the subclass the WRR scheduling algorithm just scheduled for a segment transfer.

Functions

For a port, a Weighted Round Robin algorithm is used to schedule from classes. For a port and class, a Weighted Round Robin algorithm is used to schedule from subclasses. For a port, class, and subclass, a Round Robin algorithm is used to schedule segment transfer from a Flow queue.

Weighted Round Robin

For the operation of the Weighted Round Robin (WRR) algorithm, three attributes are satisfied:
1. If all of the classes contain non-backlogged Flow(s), WRR waits for the next segment to enter the Flow queue of any class. That class is then processed and given full access to the service;
2. If only one class contains backlogged Flow(s) and all the others contain non-backlogged Flow(s), the class with backlogged Flow(s) is processed and continues to have access to service until Flow becomes backlogged in another class;
3. If two or more classes contain backlogged Flow(s), WRR resorts to using scheduling windows to determine the access of the class to the service:
   a. giving a particular class more slots in the scheduling window allows more guaranteed bandwidth to the class; likewise,
   b. giving a particular class fewer slots in the scheduling window implies smaller bandwidth to the class;
   c. the guaranteed percentage of the port bandwidth afforded to a particular class will be the number of slots allocated to that class divided by the total number of slots in the scheduling window.

For the operation of WRR, the order or arrangement of the slots in the scheduling window does not affect the amount of bandwidth allocated to each class. However, the delay is dependent on the ordering of the slots in the scheduling window. There are two approaches to the window based WRR scheduling algorithm:
1. A block-oriented WRR scheduling algorithm gives a particular class all of its time slots in sequence without moving to another class;
2. A distributed WRR scheduling algorithm attempts to evenly distribute the time slots for a given class throughout the scheduling window.

The embodiment described herein utilizes the second approach. In particular, the embodiment provides a WRR count and a Weight for all the Flow queues associated with each port-class. Each time a segment is scheduled from a Flow queue that is associated with a port-class, the corresponding port-class' WRR count is increased by one and the class is memorized as the previous scheduled class. For all the classes to a port, the algorithm keeps scheduling buffer segments from the head of the Flow queues in turn for each class as long as there is at least one backlogged Flow queue in the class and the associated WRR count has not reached its Weight.

If there is no more backlogged Flow queue in a class or the corresponding WRR count of a class reaches its Weight, the class is left out of the scheduling cycle. For the backlogged Flow queues in a same port-class, a round robin scheme is used for transferring segments from the head of each backlogged Flow queue. For a given port, whenever either all the classes have their WRR counts reach their Weights or none of the classes whose WRR counts have not reached the Weights has backlogged Flow queues, the WRR counts of all the classes are reset and a new scheduling window starts for the port.

For a variable length packet based system, the weighted round robin algorithm must be modified to accommodate the case where a flow reaches its service threshold, but the packet must be serviced until completion as required for packet-by packet transmission. For this case, where a flow is serviced even though the flow has reached an associated threshold, a deficit service counter is introduced. The deficit service counter is incremented for each frame segment that is served over the threshold, indicating the excess bandwidth that the flow has utilized in the current scheduling round. When this packet has been served to completion, if any other flow queues have backlogged packets and have not hit their scheduling threshold, the packet for those flows are served. When all these packets have been served and all backlogged queues have reached their scheduling threshold, instead of resetting the scheduler counts to zero, the counts are reset to the value contained in the deficit counter. This has the effect of reducing the service available to a flow in the current round as compared to the other flows. This preserves the fair bandwidth-sharing algorithm.

Queuing Chip—Memory Controller

Functional Overview

The Memory Controller 565 performs the writing and reading of frame segments from and to the FCRAM buffer memory. The Memory Controller interfaces with: the (1) MUX Module; (2) Buffer Manager; and (3) the DEMUX module to perform the following functions:
The Memory Controller reads a command FIFO that is written with read and write requests (and the segment starting address in memory) from the Buffer Manager.
On a read request, the Memory Controller reads the frame segment from the given memory address and writes the data into a dequeuing FIFO.
On a write request, the Memory Controller reads the enqueuing FIFO and writes the frame segment to the specified memory address.
The Memory controller generates memory refresh cycles as required by the FCRAM-II specifications.

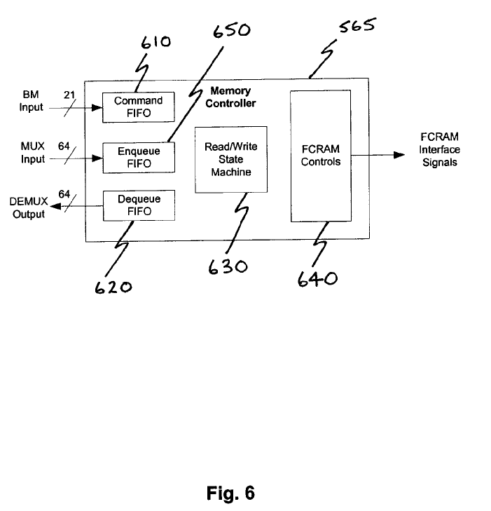

A block diagram of the Memory controller module 565 is shown in FIG. 6. The Memory Controller 565 receives input from the Buffer Manager 540 on a 21 bit bus at a Command FIFO module 610. MUX input is received on a 64 bit bus from the MUX chip 140 at a Enqueue FIFO module 650. The Memory Controller 565 includes a Read/Write State Machine 630. The Memory Controller 565 presents output to the FCRAM Interface module 570 via a FCRAM Control module 640. The Memory Controller 565 presents output to the Demultiplexer 580 of FIG. 5 via a Dequeue FIFO module 620.

FCRAM Memory Mapping

Each of the 4 FCRAM devices contains 4 banks (Banks A, B, C and D) containing 32K row addresses and 128 column addresses. Each FCRAM device stores 16 bytes of each 64-byte frame segment. The 16 bytes are stored as 8 bytes per bank and each read or write operation may transfer 8 bytes (2 bytes, burst length 4) to or from bank A (bank C) and 8 bytes to or from bank B (bank D).

Memory Controller Module Interfaces

Memory Controller Timing—FCRAM Timing

The FCRAM memory is read and written in a 10-cycle period where reads and writes of 64-byte frame segments are interleaved. Each command requires 5 cycles to be completed as shown in the figure. The read and writes may be preempted by FCRAM refresh cycles that consume approximately 2% of the available interface bandwidth.

DEMUX Chip 140

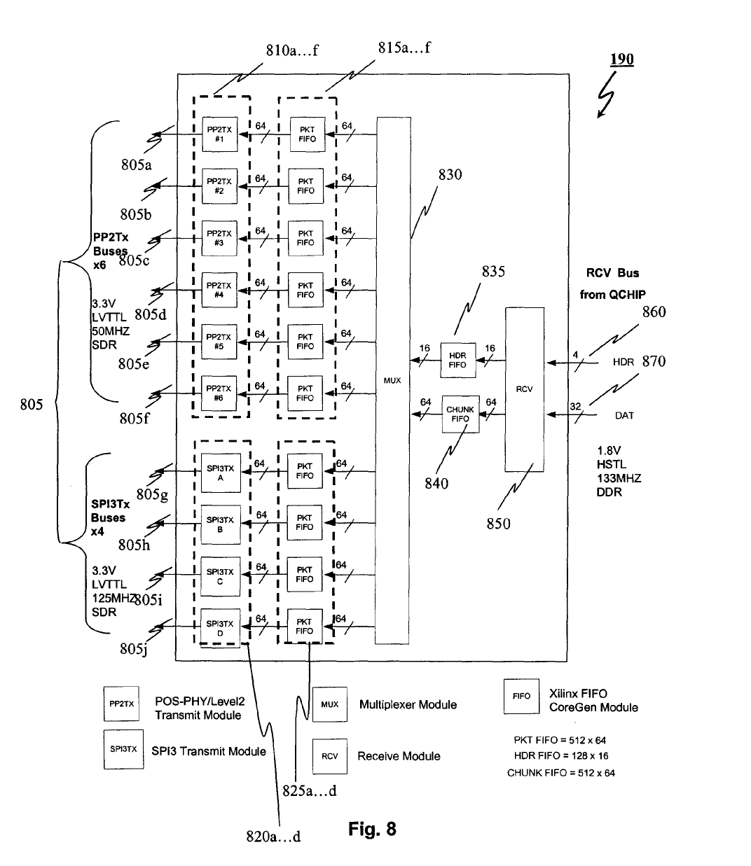

FIG. 8 is a schematic block diagram of architecture of the DEMUX chip 190 of FIG. 1. As discussed above with reference to FIG. 1, the DEMUX chip 190 receives traffic from the Queuing chip 190, and reformats the traffic from the predetermined data width to the original data width received by the system 100. The DEMUX chip 190 presents the output traffic to the MAC chip 130.

FIG. 8 shows the DEMUX chip 190 receives a header (HDR) 860 and data (DAT) 870 at a receive module 850. The receive module 850 buffers the receives header 860 and data 870, and presents the respective information to each of a HDR FIFO module 835 and a CHUNK FIFO module 840. The HDR FIFO module 835 buffers the header information and presents a 16 bit output to a multiplexer 830. Similarly, the CHUNK FIFO module 840 buffers received data and presents a 64 bit output to the multiplexer 830.

The multiplexer 830 multiplexes the received header and data information to one of ten FIFO channels connected to an array of ten PKT FIFO modules 815a . . . f, 825a . . . d, thus restoring the received bus traffic of a predetermined data width to the data width of traffic 705 received by the system 100. The PKT FIFO modules 815a . . . f buffer the received information and present 64 bit outputs to corresponding POS-PHY/Level2 transmit (PP2Tx) modules 810a . . . f. Similarly, the PKT FIFO modules 825a . . . d buffer the received information and present 64 bit outputs to corresponding SPI3Tx modules 820a . . . d. The PP2Tx modules 810a . . . f produce output traffic 805a . . . f and the SPI3Tx modules 820a . . . d produce output traffic 805g . . . j. All of the traffic 805a . . . j is presented to the MAC 130.

The aforementioned preferred method(s) comprise a particular control flow. There are many other variants of the preferred method(s) which use different control flows without departing the spirit or scope of the invention. Furthermore one or more of the steps of the preferred method(s) may be performed in parallel rather sequential.

Computer Implementation

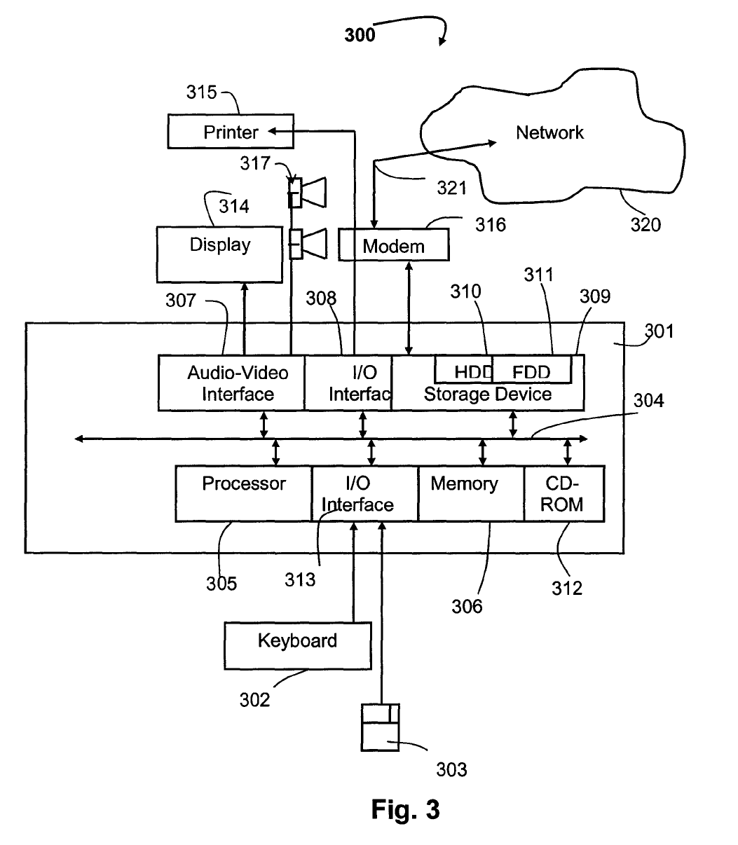

The method of traffic processing is preferably practised using a general-purpose computer system 300, such as that shown in FIG. 3 wherein the processes of FIGS. 1, 2, and 4 to 70 may be implemented as software, such as an application program executing within the computer system 300. In particular, the steps of the method of traffic processing are effected by instructions in the software that are carried out by the computer. The instructions may be formed as one or more code modules, each for performing one or more particular tasks. The software may also be divided into two separate parts, in which a first part performs the traffic processing methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for traffic processing.

The computer system 300 is formed by a computer module 301, input devices such as a keyboard 302 and mouse 303, output devices including a printer 315, a display device 314 and loudspeakers 317. A Modulator-Demodulator (Modem) transceiver device 316 is used by the computer module 301 for communicating to and from a communications network 320, for example connectable via a telephone line 321 or other functional medium. The modem 316 can be used to obtain access to the Internet, and other network systems, such as a Local Area Network (LAN) or a Wide Area Network (WAN), and may be incorporated into the computer module 301 in some implementations.

The computer module 301 typically includes at least one processor unit 305, and a memory unit 306, for example formed from semiconductor random access memory (RAM) and read only memory (ROM). The module 301 also includes an number of input/output (I/O) interfaces including an audio-video interface 307 that couples to the video display 314 and loudspeakers 317, an I/O interface 313 for the keyboard 302 and mouse 303 and optionally a joystick (not illustrated), and an interface 308 for the modem 316 and printer 315. In some implementations, the modem 316 may be incorporated within the computer module 301, for example within the interface 308. A storage device 309 is provided and typically includes a hard disk drive 310 and a floppy disk drive 311. A magnetic tape drive (not illustrated) may also be used. A CD-ROM drive 312 is typically provided as a non-volatile source of data. The components 305 to 313 of the computer module 301, typically communicate via an interconnected bus 304 and in a manner which results in a conventional mode of operation of the computer system 300 known to those in the relevant art. Examples of computers on which the described arrangements can be practised include IBM-PC's and compatibles, Sun Sparcstations or alike computer systems evolved therefrom.

Typically, the application program is resident on the hard disk drive 310 and read and controlled in its execution by the processor 305. Intermediate storage of the program and any data fetched from the network 320 may be accomplished using the semiconductor memory 306, possibly in concert with the hard disk drive 310. In some instances, the application program may be supplied to the user encoded on a CD-ROM or floppy disk and read via the corresponding drive 312 or 311, or alternatively may be read by the user from the network 320 via the modem device 316. Still further, the software can also be loaded into the computer system 300 from other computer readable media. The term “computer readable medium” as used herein refers to any storage or transmission medium that participates in providing instructions and/or data to the computer system 300 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 301. Examples of transmission media include radio or infra-red transmission channels as well as a network connection to another computer or networked device, and the Internet or Intranets including e-mail transmissions and information recorded on Websites and the like.

The method of traffic processing may alternatively be implemented in dedicated hardware such as one or more integrated circuits performing the functions or sub functions of multiplexing, and processing. Such dedicated hardware may include graphic processors, digital signal processors, or one or more microprocessors and associated memories.

In an alternate arrangement, the switching system 100 is embodied as an ethernet switch. In a preferred embodiment, the ethernet switch is incorporated into a standalone IP telephone system. The switch is connected between an IP telephone handset and an ethernet network to improve the voice quality and network performance.

When the IP phone is plugged into the switch, traffic flows through the 48 FE ports 110. The switch distinguishes and classifies the IP telephone device. A voice ID of voice VLAN is then assigned to the IP telephone. Thereafter, the switch also assigns priority to voice traffic of the IP phone device to secure voice quality, as in the case of the computer implementation described above.

### INDUSTRIAL APPLICABILITY

It is apparent from the above that the arrangements described are applicable to the computer, data processing and telecommunication industries.

The foregoing describes only some embodiments of the present invention, and modifications and/or changes can be made thereto without departing from the scope and spirit of the invention, the embodiments being illustrative and not restrictive.

We claim:

1. A method for traffic processing comprising:
receiving a traffic of an original data width narrower than or equal to a predetermined data width;
reformatting said received traffic into bus traffic of said predetermined data width;
recognizing a specific traffic within said bus traffic;
processing said bus traffic;
prioritizing said specific traffic over other traffic in said bus traffic; and
outputting said bus traffic according to said prioritizing result.

2. The method of claim 1, further comprising unpacking said bus traffic to said original data width.

3. The method of claim 1, wherein said recognizing and said prioritizing further comprise recognizing and prioritizing a voice traffic.

4. The method of claim 1, wherein said prioritizing further comprises queuing said bus traffic of said predetermined data width.

5. The method of claim 1, wherein said prioritizing further comprises buffering said bus traffic of said predetermined data width.

6. The method of claim 1, wherein said processing further comprises at least one of Layer-2, Layer-3, and Layer-4 header processing.

7. The method of claim 1, wherein said received traffic is applied to at least one interface selected from the group of interfaces consisting of: POS-PHY interface, SPI interface, PCI interface, PCMCIA interface, USB interface and CARDBUS interface.

8. The method of claim 1, wherein said predetermined data width is 64 bits.

9. A system for traffic processing comprising:
a circuit for receiving and reformatting a traffic having an original data width narrower than or equal to a predetermined data width into bus traffic of said predetermined data width;
a circuit for distinguishing a specific traffic within said bus traffic;
a processor for processing said reformatted bus traffic; and
a circuit for prioritizing said specific traffic over other traffic in said bus traffic.

10. The system of claim 9, further comprising a circuit for unpacking said bus traffic to said original data width.

11. The system of claim 9, wherein said circuit for prioritizing prioritizes a voice traffic over other traffic in said bus traffic.

12. The system of claim 9, wherein said circuit for prioritizing further comprises a queuing chip for queuing said bus traffic and a buffer for buffering said bus traffic.

13. The system of claim 9, wherein said processor comprises a circuit for header processing in accordance with at least one of Layer-2, Layer-3, and Layer-4.

14. The system of claim 9, wherein said system includes at least one interface for receiving and reformatting, said interface being selected from the group of interfaces consisting of: POS-PHY interface, SPI interface, PCI interface, PCMCIA interface, USB interface and CARDBUS interface.

15. The system of claim 9, wherein said circuit for unpacking includes at least one interface selected from the group of interfaces consisting of: POS-PHY interface, PCI interface, PCMCIA interface, USB interface and CARDBUS interface.

16. The system of claim 9, wherein said predetermined data width is 64 bits.

17. A device for secure frame transfer comprising:
a receiving circuit for receiving a frame; and
an ingress processor for processing said frame to decide whether or not to further process said frame.

18. The device of claim 17, further comprising a circuit for preprocessing said frame to examine the validity of a frame header of said frame by parsing said frame header.

19. The device of claim 17, wherein said ingress processor comprises a circuit for assigning an identifier for a selected frame.

20. The device of claim 19, wherein said identifier is a VLAN ID.

21. The device of claim 17, wherein said ingress processor comprises a circuit for setting a VLAN ID configured to VoiceVID and further setting X2 bit for said VoiceVID to avoid frame flooding.

22. The device of claim 17, wherein said ingress processor comprises a circuit for recording a MAC address of an authorized user into a register.

23. The device of claim 22, wherein said register is a hardware register.

24. The device of claim 17, wherein said ingress processor comprises a circuit for determining whether to forward said frame either as a Layer-2 or Layer-3 entity.

25. The device of claim 17, further comprising a Layer-2 processor for directing said ingress processed frame to a correct port.

26. The device of claim 17, further comprising a Layer-3 processor for directing said ingress processed frame to a correct port.

27. The device of claim 17, further comprising circuit for classifying said frame into a flow by matching header fields of said frame.

28. The device of claim 17, further comprising a next hop processor for determining said frame output and control frame header modification of said frame.

29. The device of claim 17, further comprising a multicast processor for outputting said frame.

30. An ethernet switching system for processing traffic, said switching system comprising:
a circuit for receiving and reformatting ethernet traffic having an original data width narrower than or equal to a predetermined data width into bus traffic of said predetermined data width;
a circuit for distinguishing a specific traffic within said bus traffic;
a processor for processing said reformatted bus traffic; and
a circuit for prioritizing said specific traffic over other traffic in said bus traffic.

31. An Internet Protocol telephony system comprising:
a data network;
an Internet Protocol (IP) telephone handset; and
a switch coupling said IP telephone handset to said data network, said switch including:
a first circuit for receiving traffic from at least one of said telephone handset and said data network, said traffic having an original data width narrower than or equal to a predetermined data width;
a second circuit for reformatting said received traffic into bus traffic of said predetermined data width;
a third circuit for distinguishing voice traffic from said IP telephone handset within said bus traffic;
a processor for processing said reformatted bus traffic; and
a fourth circuit for prioritizing voice traffic from said IP telephone handset over other traffic in said bus traffic.
